(19) United States
(12) Patent Application Publication
(10) Pub. No.: US 2023/0149839 A1
(43) Pub. Date: May 18, 2023

(54) FILTER MEDIA INCLUDING FIBERS COMPRISING A MATRIX POLYMER AND IMPACT MODIFIER, AND RELATED METHODS

(71) Applicant: Hollingsworth & Vose Company, East Walpole, MA (US)

(72) Inventors: Praveen Kumar Yegya Raman, Ayer, MA (US); Keith Higginson, Holden, MA (US); Shania Evangelista, Floyd, VA (US); Amsarani Ramamoorthy, Blacksburg, VA (US); Kevin Clark, Nashua, NH (US); Bryan Douglas Dickerson, Christiansburg, VA (US)

(73) Assignee: Hollingsworth & Vose Company, East Walpole, MA (US)

(21) Appl. No.: 17/530,397

(22) Filed: Nov. 18, 2021

(51) Int. Cl. B01D 39/16

(52) U.S. Cl. CPC B01D 39/1623; B01D 2239/02; B01D 2239/04; B01D 2239/065; B01D 2239/10; B01D 2239/1233; B01D 2239/1291; B01D 2201/12

(57) ABSTRACT

Filter media including fibers comprising a matrix polymer and impact modifier, and related methods, are generally described.

### TECHNICAL FIELD

Filter media including fibers comprising a matrix polymer and impact modifier, and related methods, are generally described.

### BACKGROUND

Filter media are articles that can be used to remove contamination in a variety of applications. Some filter media include fine fiber layers comprising fine fibers comprising a polymer. However, these filter media and/or fine fiber layers frequently have low elongation at break, low tensile strength, low puncture strength, and/or low toughness, which may make them unsuitable to withstand mechanical stress during processing, such as pleating or slitting. Accordingly, more robust filter media and/or fine fiber layers and associated methods are needed, and, particularly, more robust filter media and/or fine fiber layers that maintain filtration performance.

### SUMMARY

Filter media including fibers comprising a matrix polymer and impact modifier, and related methods, are generally described.

In one aspect, a filter media is provided. The filter media comprises a fine fiber layer comprising a plurality of fine fibers. The fine fibers comprise an impact modifier dispersed in a matrix polymer. The weight percent of the impact modifier in the fine fibers is greater than or equal to 1 wt. % and less than or equal to 25 wt. % of the combination of the impact modifier and the matrix polymer. The matrix polymer comprises only polymers with a molecular weight of greater than 3 kDa.

In one aspect, a filter media is provided. The filter media comprises a fine fiber layer comprising a plurality of fine fibers. The fine fibers comprise an impact modifier dispersed in a matrix polymer. The weight percent of the impact modifier in the fine fibers is greater than or equal to 1 wt. % and less than or equal to 15 wt. % of the combination of the impact modifier and the matrix polymer.

In one aspect, a filter media is provided. The filter media comprises a fine fiber layer comprising a plurality of fine fibers. The fine fibers comprise an impact modifier dispersed in a matrix polymer. The weight percent of the impact modifier in the fine fibers is greater than or equal to 1 wt. % and less than or equal to 25 wt. % of the combination of the impact modifier and the matrix polymer. The matrix polymer comprises greater than or equal to 50 wt. % and less than or equal to 100 wt. % of a thermoplastic polymer.

In one aspect, a filter media is provided. The filter media comprises a fine fiber layer comprising a plurality of fine fibers. The fine fibers comprise an impact modifier dispersed in a matrix polymer. The weight percent of the impact modifier in the fine fibers is greater than or equal to 1 wt. % and less than or equal to 25 wt. % of the combination of the impact modifier and the matrix polymer. The matrix polymer comprises only polymers with a molecular weight of greater than 3 kDa. The impact modifier comprises a copolymer comprising at least two different monomers, wherein at least one monomer has an affinity to the matrix polymer and wherein at least one monomer does not have affinity to the matrix polymer.

In one aspect, a filter media is provided. The filter media comprises a fine fiber layer comprising a plurality of fine fibers. The fine fibers comprise an impact modifier dispersed in a matrix polymer. The weight percent of the impact modifier in the fine fibers is greater than or equal to 1 wt. % and less than or equal to 15 wt. % of the combination of the impact modifier and the matrix polymer. The impact modifier comprises a copolymer comprising at least two different monomers, wherein at least one monomer has an affinity to the matrix polymer and wherein at least one monomer does not have affinity to the matrix polymer.

In one aspect, a filter media is provided. The filter media comprises a fine fiber layer comprising a plurality of fine fibers. The fine fibers comprise an impact modifier dispersed in a matrix polymer. The weight percent of the impact modifier in the fine fibers is greater than or equal to 1 wt. % and less than or equal to 25 wt. % of the combination of the impact modifier and the matrix polymer. The impact modifier comprises a copolymer comprising at least two different monomers, wherein at least one monomer has an affinity to the matrix polymer and wherein at least one monomer does not have affinity to the matrix polymer. The matrix polymer comprises greater than or equal to 50 wt. % and less than or equal to 100 wt. % of a thermoplastic polymer.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A is, in accordance with certain embodiments, a schematic of a filter media comprising a fine fiber layer comprising fine fibers.

FIG. 1B is, in accordance with certain embodiments, a schematic of a fine fiber comprising a matrix polymer and an impact modifier.

FIG. 2 is, in accordance with certain embodiments, a schematic of a filter media comprising a fine fiber layer and a second layer.

FIG. 3 is, in accordance with certain embodiments, a schematic of a filter media comprising a fine fiber layer, a second layer, and a third layer.

FIG. 4A, FIG. 4B, FIG. 4C, FIG. 4D, and FIG. 4E each show non-limiting examples of designs suitable for fuel filters, in accordance with some embodiments.

FIG. 5A, FIG. 5B, FIG. 5C, and FIG. 5D each show non-limiting examples of designs suitable for hydraulic fluid filters, in accordance with some embodiments.

FIG. 6A, FIG. 6B, and FIG. 6C each show non-limiting examples of designs suitable for HEPA filters, in accordance with some embodiments.

FIG. 7A and FIG. 7B each show non-limiting examples of designs suitable for ULPA filters, in accordance with some embodiments.

FIG. 8A shows the elongation at break for five fine fiber layers.

FIG. 8B shows the tensile strength for five fine fiber layers.

FIG. 9A shows the puncture strength for two fine fiber layers.

FIG. 9B shows the puncture strength for three filter media.

FIG. 10 shows the salt loading for 3 filter media.

FIG. 11A shows the efficiency metric (EM) for two HEPA H14 filter media under different blade pleating conditions.

FIG. 11B shows the efficiency metric (EM) for two ULPA U15 filter media under different blade pleating conditions.

FIG. 12 shows the efficiency metric (EM) for two five-layer filter media under different blade pleating conditions.

FIG. 13A shows a differential scanning calorimetry (DSC) analysis for a fine fiber layer comprising a matrix polymer but no impact modifier.

FIG. 13B shows a DSC analysis for a fine fiber layer comprising a matrix polymer and an impact modifier.

FIG. 14 compares the gamma results for four filter media.

### DETAILED DESCRIPTION

Disclosed herein are filter media including fibers comprising a matrix polymer and impact modifier, and related methods. In some embodiments, the filter media comprises a fine fiber layer comprising fine fibers comprising a matrix polymer and an impact modifier. In certain embodiments, such filter media and/or fine fiber layers have one or more advantages over filter media and/or fine fiber layers without the impact modifier, all other factors being equal. Examples of such advantages include increased elongation at break, increased tensile strength, increased toughness, increased puncture strength, increased DOP oil loading, increased salt loading, increased void volume, and/or increased durability in pleating. In certain cases, one or more of these advantages are achieved without sacrificing filtration properties.

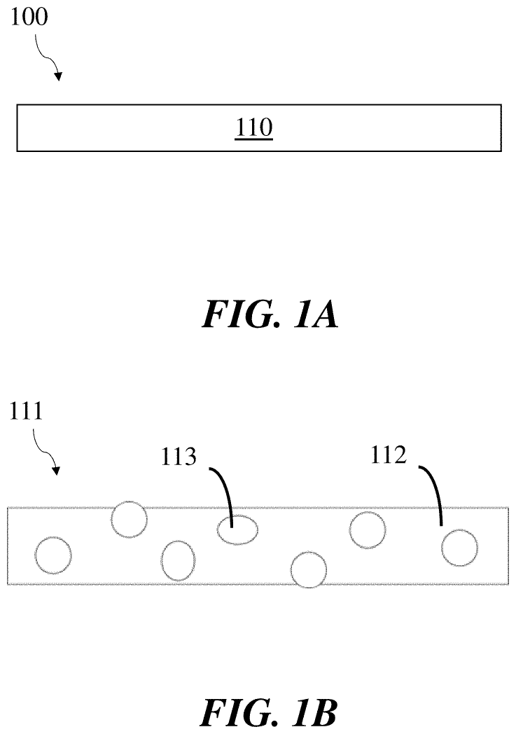

Certain embodiments are related to filter media. Some such filter media are illustrated schematically in FIGS. 1A-3. In some embodiments, the filter media comprises a fine fiber layer. For example, in FIG. 1A, in certain cases, filter media 100 comprises fine fiber layer 110. In certain embodiments, the fine fiber layer comprises fine fibers. For example, in FIG. 1A, in some instances, fine fiber layer 110 comprises fine fibers.

The fine fibers may comprise one or more components. Examples of suitable components may include a matrix polymer, an impact modifier, and/or a salt. For example, in FIG. 1B, in some cases, fine fiber 111 comprises matrix polymer 112 and impact modifier 113. It should be understood that this figure is for illustration purposes only, as the impact modifier microdomains may not be a uniform shape or uniform distribution in all embodiments.

The fine fibers may have any suitable average fiber diameter. In some embodiments, the fine fibers have an average fiber diameter of greater than or equal to 10 nm, greater than or equal to 25 nm, greater than or equal to 50 nm, greater than or equal to 75 nm, greater than or equal to 100 nm, greater than or equal to 150 nm, greater than or equal to 200 nm, greater than or equal to 250 nm, greater than or equal to 300 nm, greater than or equal to 400 nm, greater than or equal to 500 nm, greater than or equal to 750 nm, greater than or equal to 1 micron, greater than or equal to 2 microns, greater than or equal to 3 microns, greater than or equal to 4 microns, or greater than or equal to 5 microns. In certain embodiments, the fine fibers have an average fiber diameter of less than or equal to 6 microns, less than or equal to 5 microns, less than or equal to 4 microns, less than or equal to 3 microns, less than or equal to 2 microns, less than or equal to 1 micron, less than or equal to 750 nm, less than or equal to 500 nm, less than or equal to 400 nm, less than or equal to 300 nm, less than or equal to 250 nm, less than or equal to 200 nm, less than or equal to 200 nm, less than or equal to 150 nm, or less than or equal to 100 nm. Combinations of these ranges are also possible (e.g., greater than or equal to 10 nm and less than or equal to 6 microns, greater than or equal to 10 nm and less than or equal to 1 micron, greater than or equal to 10 nm and less than or equal to 500 nm, greater than or equal to 25 nm and less than or equal to 1 micron, or greater than or equal to 50 nm and less than or equal to 300 nm). Fiber diameter may be measured using scanning electron microscopy. In certain cases, the fine fibers comprise nanofibers. As used herein, nanofibers are fibers having an average diameter of less than or equal to 1 micron (e.g., any of the diameters, or combinations thereof, described above that are less than or equal to 1 micron).

In some instances, the fine fibers may be continuous fibers (e.g., electrospun fibers, meltblown fibers, solvent-spun fibers, and/or centrifugal spun fibers). Continuous fibers are made by a “continuous” fiber-forming process, such as a meltblown, a meltspun, a melt electrospinning, a solvent electrospinning, a centrifugal spinning, or a spunbond process, and typically have longer lengths than non-continuous fibers. Non-continuous fibers may be cut to be (e.g., from a filament), may be formed to be, or may naturally be non-continuous discrete fibers having a particular length or a range of lengths as described in more detail herein. A non-limiting example of a non-continuous fiber is a staple fiber.

The fine fibers may have any suitable length. For instance, in some cases, the fine fibers have an average length of greater than or equal to 100 mm, greater than or equal to 125 mm, greater than or equal to 150 mm, greater than or equal to 200 mm, greater than or equal to 250 mm, greater than or equal to 300 mm, greater than or equal to 400 mm, greater than or equal to 500 mm, greater than or equal to 750 mm, greater than or equal to 1 m, greater than or equal to 1.25 m, greater than or equal to 1.5 m, greater than or equal to 2 m, greater than or equal to 2.5 m, greater than or equal to 3 m, greater than or equal to 4 m, greater than or equal to 5 m, greater than or equal to 7.5 m, greater than or equal to 10 m, greater than or equal to 12.5 m, greater than or equal to 15 m, greater than or equal to 20 m, greater than or equal to 25 m, greater than or equal to 30 m, greater than or equal to 40 m, greater than or equal to 50 m, greater than or equal to 75 m, greater than or equal to 100 m, greater than or equal to 125 m, greater than or equal to 150 m, greater than or equal to 200 m, greater than or equal to 250 m, greater than or equal to 300 m, greater than or equal to 400 m, greater than or equal to 500 m, or greater than or equal to 750 m. In some embodiments, the fine fibers have an average length of less than or equal to 1 km, less than or equal to 750 m, less than or equal to 500 m, less than or equal to 400 m, less than or equal to 300 m, less than or equal to 250 m, less than or equal to 200 m, less than or equal to 150 m, less than or equal to 125 m, less than or equal to 100 m, less than or equal to 75 m, less than or equal to 50 m, less than or equal to 40 m, less than or equal to 30 m, less than or equal to 25 m, less than or equal to 20 m, less than or equal to 15 m, less than or equal to 12.5 m, less than or equal to 10 m, less than or equal to 7.5 m, less than or equal to 5 m, less than or equal to 4 m, less than or equal to 3 m, less than or equal to 2.5 m, less than or equal to 2 m, less than or equal to 1.5 m, less than or equal to 1.25 m, less than or equal to 1 m, less than or equal to 750 mm, less than or equal to 500 mm, less than or equal to 400 mm, less than or equal to 300 mm, less than or equal to 250 mm, less than or equal to 200 mm, less than or equal to 150 mm, or less than or equal to 125 mm. Combinations of the above-referenced ranges are also possible (e.g., greater than or equal to 100 mm and less than or equal to 1 km, greater than or equal to 125 mm and less than or equal to 25 m, greater than or equal to 125 mm and less than or equal to 2 m). Other ranges are also possible.

In embodiments where the fine fibers comprise electrospun fibers, the fine fibers may be electrospun using any suitable solvent (e.g., combined with one or more polymers or copolymers disclosed herein). Suitable solvents may include formic acid (FA), acetic acid, trifluoroacetic acid (TFAA), dichloromethane (DCM), and 1,1,1,3,3,3-Hexafluoro-2-propanol (HFP), pentafluoropentanoic acid (PFPA), tetrahydrofuran (THF), dimethylacetamide, dimethylformamide, dioxolane, acetone, ethyl acetate, water, and/or alcohol (e.g., ethanol, propanol, and/or isopropanol).

When the polymer (and/or copolymer) is added to the solvent for electrospinning, the polymeric solution may have any suitable conductivity. For example, in some cases, the polymeric solution has a conductivity of greater than or equal to 10 μS, greater than or equal to 25 μS, greater than or equal to 50 μS, greater than or equal to 75 μS, greater than or equal to 100 μS, greater than or equal to 120 μS, greater than or equal to 150 μS, greater than or equal to 200 μS, greater than or equal to 250 μS, greater than or equal to 300 μS, greater than or equal to 400 μS, greater than or equal to 500 μS, greater than or equal to 750 μS, greater than or equal to 1,000 μS, greater than or equal to 2,000 μS, greater than or equal to 3,000 μS, greater than or equal to 4,000 μS, or greater than or equal to 5,000 μS. In certain embodiments, the polymeric solution has a conductivity of less than or equal to 15,000 μS, less than or equal to 14,000 μS, less than or equal to 13,000 μS, less than or equal to 12,000 μS, less than or equal to 11,000 μS, less than or equal to 10,000 μS, less than or equal to 9,000 μS, less than or equal to 8,000 μS, less than or equal to 7,000 μS, less than or equal to 6,000 μS, less than or equal to 5,000 μS, less than or equal to 4,000 μS, less than or equal to 3,000 μS, less than or equal to 2,000 μS, less than or equal to 1,000 μS, less than or equal to 750 μS, less than or equal to 500 μS, less than or equal to 400 μS, less than or equal to 300 μS, less than or equal to 250 μS, less than or equal to 200 μS, less than or equal to 150 μS, less than or equal to 120 μS, or less than or equal to 100 μS. Combinations of these ranges are also possible (e.g., greater than or equal to 10 μS and less than or equal to 10,000 μS, greater than or equal to 100 μS and less than or equal to 500 μS, or greater than or equal to 120 μS and less than or equal to 300 μS). The conductivity may be determined using a conductivity meter.

When the polymer (and/or copolymer) is added to the solvent for electrospinning, the polymeric solution may have any suitable viscosity. For example, in some cases, the polymeric solution has a viscosity of greater than or equal to 10 millipascal-seconds, greater than or equal to 25 millipascal-seconds, greater than or equal to 50 millipascal-seconds, greater than or equal to 75 millipascal-seconds, greater than or equal to 100 millipascal-seconds, greater than or equal to 125 millipascal-seconds, greater than or equal to 150 millipascal-seconds, greater than or equal to 200 millipascal-seconds, greater than or equal to 250 millipascal-seconds, greater than or equal to 300 millipascal-seconds, greater than or equal to 400 millipascal-seconds, greater than or equal to 500 millipascal-seconds, greater than or equal to 750 millipascal-seconds, greater than or equal to 1000 millipascal-seconds, greater than or equal to 1250 millipascal-seconds, greater than or equal to 1500 millipascal-seconds, greater than or equal to 1750 millipascal-seconds, or greater than or equal to 2000 millipascal-seconds. In certain instances, the polymeric solution has a viscosity of less than or equal to 2500 millipascal-seconds, less than or equal to 2250 millipascal-seconds, less than or equal to 2000 millipascal-seconds, less than or equal to 1750 millipascal-seconds, less than or equal to 1500 millipascal-seconds, less than or equal to 1250 millipascal-seconds, less than or equal to 1000 millipascal-seconds, less than or equal to 750 millipascal-seconds, less than or equal to 500 millipascal-seconds, less than or equal to 400 millipascal-seconds, less than or equal to 300 millipascal-seconds, less than or equal to 250 millipascal-seconds, less than or equal to 200 millipascal-seconds, less than or equal to 150 millipascal-seconds, less than or equal to 125 millipascal-seconds, or less than or equal to 100 millipascal-seconds. Combinations of these ranges are also possible (e.g., greater than or equal to 10 millipascal-seconds and less than or equal to 2500 millipascal-seconds, greater than or equal to 75 millipascal-seconds and less than or equal to 500 millipascal-seconds, or greater than or equal to 100 millipascal-seconds and less than or equal to 300 millipascal-seconds). The viscosity of the fluid precursor may be determined by use of a rotational viscometer at a shear rate of 1.7 s⁻¹ and a temperature of 20° C. The viscosity may be determined from a rotational viscometer once the value displayed thereon has stabilized. One example of a suitable rotational viscometer is a Brookfield LVT viscometer having a No. 62 spindle.

The fine fibers may have any suitable shape. In some embodiments, the fine fibers are cylindrical. In certain embodiments, the fine fibers are non-cylindrical (e.g., ribbon, flat, and/or fibrils). In some cases, the fine fibers comprise core-sheath fibers (e.g., concentric core/sheath fibers and/or non-concentric core-sheath fibers), segmented pie fibers, side-by-side fibers, tip-trilobal fibers, split fibers, and “island in the sea” fibers.

According to some embodiments, the fine fibers comprise a matrix polymer. For example, in FIG. 1B, in certain cases, fine fiber 111 comprises matrix polymer 112. As used herein, a matrix polymer is a polymer in which a different component (e.g., any component disclosed herein, such as an impact modifier) is dispersed. For example, in FIG. 1B, in some instances, a component (e.g., impact modifier 113) is dispersed in matrix polymer 112. In certain embodiments, the matrix polymer is a continuous phase in which a different component (e.g., any component disclosed herein, such as an impact modifier) is dispersed. For example, in FIG. 1B, according to some embodiments, matrix polymer 112 is a continuous phase in which a component (e.g., impact modifier 113) is dispersed.

In some embodiments, the matrix polymer comprises a homopolymer. For example, in certain cases, the matrix polymer comprises greater than or equal to 50 wt. %, greater than or equal to 55 wt. %, greater than or equal to 60 wt. %, greater than or equal to 65 wt. %, greater than or equal to 70 wt. %, greater than or equal to 75 wt. %, greater than or equal to 80 wt. %, greater than or equal to 85 wt. %, greater than or equal to 90 wt. %, greater than or equal to 95 wt. %, greater than or equal to 97 wt. %, greater than or equal to 98 wt. %, or greater than or equal to 99 wt. % of a homopolymer. In certain embodiments, the matrix polymer comprises less than or equal to 100 wt. %, less than or equal to 99 wt. %, less than or equal to 98 wt. %, less than or equal to 97 wt. %, less than or equal to 95 wt. %, less than or equal to 90 wt. %, less than or equal to 85 wt. %, less than or equal to 80 wt. %, less than or equal to 75 wt. %, less than or equal to 70 wt. %, less than or equal to 65 wt. %, or less than or equal to 60 wt. % of a homopolymer. Combinations of these ranges are also possible (e.g., greater than or equal to 50 wt. % and less than or equal to 100 wt. %, greater than or equal to 80 wt. % and less than or equal to 100 wt. %, or greater than or equal to 90 wt. % and less than or equal to 100 wt. %). In some embodiments, the matrix polymer comprises 100 wt. % of a homopolymer. As used herein, a homopolymer is a polymer wherein at least 90% (e.g., at least 93%, at least 95%, at least 97%, at least 99%, or 100%) of the repeat units (e.g., monomers) are the same. Without wishing to be bound by theory, it is believed that having a matrix polymer that comprises a homopolymer increases the compatibility with the impact modifier, in some embodiments.

In some embodiments, the matrix polymer is not a thermoset. As used herein, a thermoset is a polymer that does not flow when heated, but instead becomes more solid (e.g., due to a crosslinking reaction). A thermoset may include one or more polymers (e.g., a pair of polymers) and/or one or more chemicals (e.g., a pair of chemicals).

In certain embodiments, the matrix polymer comprises a thermoplastic polymer. For example, in certain cases, the matrix polymer comprises greater than or equal to 50 wt. %, greater than or equal to 55 wt. %, greater than or equal to 60 wt. %, greater than or equal to 65 wt. %, greater than or equal to 70 wt. %, greater than or equal to 75 wt. %, greater than or equal to 80 wt. %, greater than or equal to 85 wt. %, greater than or equal to 90 wt. %, greater than or equal to 95 wt. %, greater than or equal to 97 wt. %, greater than or equal to 98 wt. %, or greater than or equal to 99 wt. % of a thermoplastic polymer. In certain embodiments, the matrix polymer comprises less than or equal to 100 wt. %, less than or equal to 99 wt. %, less than or equal to 98 wt. %, less than or equal to 97 wt. %, less than or equal to 95 wt. %, less than or equal to 90 wt. %, less than or equal to 85 wt. %, less than or equal to 80 wt. %, less than or equal to 75 wt. %, less than or equal to 70 wt. %, less than or equal to 65 wt. %, or less than or equal to 60 wt. % of a thermoplastic polymer. Combinations of these ranges are also possible (e.g., greater than or equal to 50 wt. % and less than or equal to 100 wt. %, greater than or equal to 80 wt. % and less than or equal to 100 wt. %, or greater than or equal to 90 wt. % and less than or equal to 100 wt. %). In some embodiments, the matrix polymer comprises 100 wt. % of a thermoplastic polymer. Without wishing to be bound by theory, it is believed that having a matrix polymer that comprises a thermoplastic polymer increases solubility in organic solvents and/or increases viscoelastic behavior, in some embodiments, such that fine fibers may be formed more readily.

In certain embodiments, the matrix polymer comprises a linear polymer. For example, in certain cases, the matrix polymer comprises greater than or equal to 50 wt. %, greater than or equal to 55 wt. %, greater than or equal to 60 wt. %, greater than or equal to 65 wt. %, greater than or equal to 70 wt. %, greater than or equal to 75 wt. %, greater than or equal to 80 wt. %, greater than or equal to 85 wt. %, greater than or equal to 90 wt. %, greater than or equal to 95 wt. %, greater than or equal to 97 wt. %, greater than or equal to 98 wt. %, or greater than or equal to 99 wt. % of a linear polymer. In certain embodiments, the matrix polymer comprises less than or equal to 100 wt. %, less than or equal to 99 wt. %, less than or equal to 98 wt. %, less than or equal to 97 wt. %, less than or equal to 95 wt. %, less than or equal to 90 wt. %, less than or equal to 85 wt. %, less than or equal to 80 wt. %, less than or equal to 75 wt. %, less than or equal to 70 wt. %, less than or equal to 65 wt. %, or less than or equal to 60 wt. % of a linear polymer. Combinations of these ranges are also possible (e.g., greater than or equal to 50 wt. % and less than or equal to 100 wt. %, greater than or equal to 80 wt. % and less than or equal to 100 wt. %, or greater than or equal to 90 wt. % and less than or equal to 100 wt. %). In some embodiments, the matrix polymer comprises 100 wt. % of a linear polymer. Without wishing to be bound by theory, it is believed that having a matrix polymer that comprises a linear polymer increases solubility in organic solvents and/or increases viscoelastic behavior, in some embodiments, such that fine fibers may be formed more readily.

Examples of suitable matrix polymers may include synthetic polymers, such as polyamides (e.g., Nylons, such as Nylon 6 (also known as polyamide 6)), polyesters (e.g., poly(caprolactone), poly(butylene terephthalate)), polyurethanes, polyureas, acrylics, polymers comprising a side chain comprising a carbonyl functional group (e.g., poly(vinyl acetate), cellulose, cellulose ester, poly(acrylamide)), poly(ether sulfone), polyacrylics (e.g., poly(acrylonitrile), poly(acrylic acid)), polystyrene, polycarbonates, polyvinyl chloride, polysulfone, poly(amic acid), fluorinated polymers (e.g., poly(vinylidene difluoride)), polyols (e.g., poly(vinyl alcohol)), polyethers (e.g., poly(ethylene oxide)), poly(vinyl pyrrolidone), poly(allylamine), butyl rubber, polyethylene, polymers comprising a silane functional group, polymers comprising a thiol functional group, polymers comprising a methylol functional group (e.g., phenolic polymers, melamine polymers, melamine-formaldehyde polymers, cross-linkable polymers comprising pendant methylol groups), and/or combinations thereof. In some embodiments, the matrix polymer comprising a copolymer of two or more of the polymers listed above and/or a blend of two or more of the polymers listed above (e.g., a blend of a polyamide and a polyester). In certain embodiments, the matrix polymer is a glassy polymer and/or a semicrystalline polymer.

Examples of suitable homopolymers may include synthetic polymers, such as polyamides (e.g., Nylons, such as Nylon 6 (also known as polyamide 6)), polyesters (e.g., poly(caprolactone), poly(butylene terephthalate)), acrylics, polymers comprising a side chain comprising a carbonyl functional group (e.g., poly(vinyl acetate), cellulose, poly(acrylamide)), poly(ether sulfone), polyacrylics (e.g., poly(acrylonitrile), poly(acrylic acid)), polystyrene, polycarbonates, polyvinyl chloride, polysulfone, poly(amic acid), fluorinated polymers (e.g., poly(vinylidene difluoride)), polyols (e.g., poly(vinyl alcohol)), polyethers (e.g., poly(ethylene oxide)), poly(vinyl pyrrolidone), poly(allylamine), butyl rubber, polyethylene, polymers comprising a silane functional group, polymers comprising a thiol functional group, polymers comprising a methylol functional group (e.g., cross-linkable polymers comprising pendant methylol groups), and/or combinations thereof.

Examples of suitable thermoplastic polymers may include synthetic polymers, such as polyamides (e.g., Nylons, such as Nylon 6 (also known as polyamide 6)), polyesters (e.g., poly(caprolactone), poly(butylene terephthalate)), polyurethanes, polyureas, acrylics, polymers comprising a side chain comprising a carbonyl functional group (e.g., poly(vinyl acetate), cellulose, cellulose ester, poly(acrylamide)), poly(ether sulfone), polyacrylics (e.g., poly(acrylonitrile), poly(acrylic acid)), polystyrene, polycarbonates, polyvinyl chloride, polysulfone, poly(amic acid), fluorinated polymers (e.g., poly(vinylidene difluoride)), polyols (e.g., poly(vinyl alcohol)), polyethers (e.g., poly(ethylene oxide)), poly(vinyl pyrrolidone), poly(allylamine), butyl rubber, polyethylene, polymers comprising a silane functional group, polymers comprising a thiol functional group, and/or combinations thereof.

Examples of linear polymers may include synthetic polymers, such as polyamides (e.g., Nylons, such as Nylon 6 (also known as polyamide 6)), polyesters (e.g., poly(caprolactone), poly(butylene terephthalate)), polyurethanes, polyureas, acrylics, polymers comprising a side chain comprising a carbonyl functional group (e.g., poly(vinyl acetate), cellulose, cellulose ester, poly(acrylamide)), poly(ether sulfone), polyacrylics (e.g., poly(acrylonitrile), poly(acrylic acid)), polystyrene, polycarbonates, polyvinyl chloride, polysulfone, poly(amic acid), fluorinated polymers (e.g., poly(vinylidene difluoride)), polyols (e.g., poly(vinyl alcohol)), polyethers (e.g., poly(ethylene oxide)), poly(vinyl pyrrolidone), poly(allylamine), butyl rubber, polyethylene, polymers comprising a silane functional group, polymers comprising a thiol functional group, and/or combinations thereof.

In embodiments where the fine fibers comprise a matrix polymer, the matrix polymer may have any suitable average molecular weight (e.g., number average molecular weight (Mₙ) and/or mass average molecular weight (M_{w})). In some embodiments, the matrix polymer has an average molecular weight (e.g., Mₙ and/or M_{w}) of greater than 3 kDa, greater than or equal to 5 kDa, greater than or equal to 7 kDa, greater than or equal to 10 kDa, greater than or equal to 15 kDa, greater than or equal to 20 kDa, greater than or equal to 25 kDa, greater than or equal to 30 kDa, greater than or equal to 35 kDa, greater than or equal to 40 kDa, greater than or equal to 45 kDa, or greater than or equal to 50 kDa. In certain embodiments, the matrix polymer has an average molecular weight (e.g., Mₙ and/or M_{w}) of less than or equal to 100 kDa, less than or equal to 90 kDa, less than or equal to 80 kDa, less than or equal to 70 kDa, less than or equal to 60 kDa, less than or equal to 50 kDa, less than or equal to 45 kDa, less than or equal to 40 kDa, less than or equal to 35 kDa, less than or equal to 30 kDa, or less than or equal to 25 kDa. Combinations of these ranges are also possible (e.g., greater than 3 kDa and less than or equal to 100 kDa, greater than or equal to 7 kDa and less than or equal to 100 kDa, or greater than or equal to 15 kDa and less than or equal to 50 kDa). Molecular weight (e.g., average molecular weight) may be determined using gel permeation chromatography (GPC), and may be determined using the equations disclosed elsewhere herein.

In embodiments where the fine fibers comprise a matrix polymer (and/or a matrix polymer and an impact modifier), the matrix polymer may comprise only polymers of a certain molecular weight. That is, in certain embodiments, the matrix polymer comprises only polymers of a certain molecular weight and does not have any other polymers or components. For example, in some embodiments, the matrix polymer comprises only polymers having a molecular weight of greater than 3 kDa, greater than or equal to 5 kDa, greater than or equal to 7 kDa, greater than or equal to 10 kDa, greater than or equal to 15 kDa, greater than or equal to 20 kDa, greater than or equal to 25 kDa, greater than or equal to 30 kDa, greater than or equal to 35 kDa, greater than or equal to 40 kDa, greater than or equal to 45 kDa, or greater than or equal to 50 kDa. In certain embodiments, the matrix polymer comprises only polymers having a molecular weight of less than or equal to 100 kDa, less than or equal to 90 kDa, less than or equal to 80 kDa, less than or equal to 70 kDa, less than or equal to 60 kDa, less than or equal to 50 kDa, less than or equal to 45 kDa, less than or equal to 40 kDa, less than or equal to 35 kDa, less than or equal to 30 kDa, or less than or equal to 25 kDa. Combinations of these ranges are also possible (e.g., greater than 3 kDa and less than or equal to 100 kDa, greater than or equal to 7 kDa and less than or equal to 100 kDa, or greater than or equal to 15 kDa and less than or equal to 50 kDa).

In embodiments where the fine fibers comprise a matrix polymer (and/or a matrix polymer and an impact modifier), the fine fibers (and/or the combination of matrix polymer and impact modifier in the fine fibers) may comprise any suitable amount of matrix polymer. In certain embodiments, the fine fibers (and/or the combination of matrix polymer and impact modifier in the fine fibers) comprises greater than or equal to 75 wt. %, greater than or equal to 80 wt. %, greater than or equal to 85 wt. %, greater than or equal to 90 wt. %, greater than or equal to 95 wt. %, or greater than or equal to 97 wt. % matrix polymer. In some embodiments, the fine fibers (and/or the combination of matrix polymer and impact modifier in the fine fibers) comprises less than or equal to 99 wt. %, less than or equal to 97 wt. %, less than or equal to 95 wt. %, less than or equal to 90 wt. %, less than or equal to 85 wt. %, or less than or equal to 80 wt. % matrix polymer. Combinations of these ranges are also possible (e.g., greater than or equal to 75 wt. % and less than or equal to 99 wt. %, greater than or equal to 80 wt. % and less than or equal to 97 wt. %, or greater than or equal to 85 wt. % and less than or equal to 95 wt. %).

The matrix polymer may have any suitable glass transition temperature relative to the temperature at which the filter media would be used. For example, in some embodiments, the matrix polymer has a glass transition temperature greater than (e.g., at least 1° C., at least 3° C., at least 5° C., at least 10° C., or at least 20° C. greater than) the temperature at which the filter media would be used (e.g., a use temperature of greater than or equal to 20° C., greater than or equal to 40° C., greater than or equal to 60° C., or greater than or equal to 80° C.; less than or equal to 100° C., less than or equal to 80° C., less than or equal to 60° C., or less than or equal to 40° C.; combinations of these ranges are also possible, such as greater than or equal to 20° C. and less than or equal to 100° C. or greater than or equal to 20° C. and less than or equal to 60° C.).

The matrix polymer may have any suitable glass transition temperature. For example, in some embodiments, the matrix polymer has a glass transition temperature of greater than or equal to 20° C., greater than or equal to room temperature, greater than or equal to 25° C., greater than or equal to 30° C., greater than or equal to 40° C., greater than or equal to 45° C., greater than or equal to 50° C., greater than or equal to 60° C., greater than or equal to 70° C., greater than or equal to 80° C., greater than or equal to 90° C., greater than or equal to 100° C., greater than or equal to 125° C., greater than or equal to 150° C., greater than or equal to 175° C., or greater than or equal to 200° C. In certain embodiments, the matrix polymer has a glass transition temperature of less than or equal to 250° C., less than or equal to 225° C., less than or equal to 200° C., less than or equal to 175° C., less than or equal to 150° C., less than or equal to 125° C., less than or equal to 100° C., less than or equal to 90° C., less than or equal to 80° C., less than or equal to 70° C., less than or equal to 60° C., less than or equal to 50° C., less than or equal to 40° C., less than or equal to 30° C., or less than or equal to 25° C. Combinations of these ranges are possible (e.g., greater than or equal to 20° C. and less than or equal to 250° C. or greater than or equal to 45° C. and less than or equal to 225° C.). The value of the glass transition temperature may be measured by differential scanning calorimetry.

According to some embodiments, the fine fibers comprise an impact modifier. For example, in FIG. 1B, in certain embodiments, fine fiber 111 comprises impact modifier 113.

In some embodiments, an impact modifier may make brittle materials (e.g., matrix polymers) more impact resistant. Without wishing to be bound by any theory, it is believed that, in some cases, the impact modifier makes brittle materials more impact resistant by either (1) stopping a crack from spreading in the brittle material by widening the crack tip, such that mechanical energy is distributed across a larger radius of curvature, and/or (2) creating zones where strain can occur without creating cracks, as the impact modifier expands and/or cavitates.

In certain embodiments, the impact modifier comprises a copolymer comprising at least two different monomers, wherein at least one monomer has affinity to the matrix polymer and wherein at least one monomer does not have affinity to the matrix polymer. As used herein, a copolymer is a polymer derived from at least two different species of monomers.

In certain embodiments, the copolymer comprises greater than or equal to 2, greater than or equal to 3, greater than or equal to 4, or greater than or equal to 5 different monomers. According to some embodiments, the copolymer comprises less than or equal to 6, less than or equal to 5, less than or equal to 4, less than or equal to 3, or less than or equal to 2 different monomers. Combinations of these ranges are also possible (e.g., greater than or equal to 2 and less than or equal to 6, greater than or equal to 2 and less than or equal to 5, or greater than or equal to 2 and less than or equal to 4). In some instances, the copolymer comprises a terpolymer. In certain cases, the copolymer comprises a random copolymer, a block copolymer, and/or a graft copolymer.

In some embodiments, a monomer has affinity to the matrix polymer when it is the same as a monomer of the matrix polymer, when it is miscible with the matrix polymer, when it comprises reactive sites that will covalently bond with the matrix polymer, when it is subject to ionic interactions with the matrix polymer, and/or when the total solubility parameter of the monomer is similar to that of a monomer of the matrix polymer. Whether covalent bonds are formed and whether ionic interactions are present may be determined by spectroscopy techniques, such as FTIR.

As used herein, two monomers have similar total solubility parameters when the Flory-Huggins parameter (χ) is less than or equal to 0.75 (e.g., less than or equal to 0.6, less than or equal to 0.5, less than or equal to 0.4, less than or equal to 0.3, less than or equal to 0.2, or less than or equal to 0.1). The total solubility parameter of each monomer may be known or may be determined using the Hansen solubility parameters, which will generally be known in the art. For example, the Hansen solubility parameters for dipole-dipole interactions, dispersion forces, and hydrogen bonding for exemplary monomers (i.e., the monomer portions of the polymers recited in Table 1) are shown in Table 1 below. These may be converted to the total solubility parameter by the following equation:

δ_{T}=\sqrt{δ_{dispersion}²+δ_{dipole-dipole}²+δ_{H bond}²}

The Flory-Huggins parameter (x) may be determined from the total solubility parameters using the following equation:

$$X = \frac{{V}_{2}}{RT} {( {δ}_{2} - {δ}_{1} )}^{2}$$

Wherein δ2 is the total solubility parameter of the monomer of the matrix polymer, δ1 is the total solubility parameter of the monomer of the impact modifier, V₂ is the molar volume of the monomer of the matrix polymer (which may be determined by dividing the density of the monomer by the molecular weight of the monomer), R is the gas constant—8.31 J/mol/K, and T is the absolute temperature.

TABLE 1
Examples of solubility parameters for exemplary monomers

| Monomers of the | | δ_{dipole-dipole} | | |
|---|---|---|---|---|
| Polymers | δ_{dispersion (J/cm}³₎ | _{(J/cm}³₎ | δ_{H bond (J/cm}³₎ | δ_{T (√(J/cm}³₎ |
| Polyamide | 17.4 | 9.6 | 12 | 29.7 |
| polystyrene | 21.8 | 5.75 | 4.3 | 20.3 |
| polypropylene | 17.9 | 0 | 0 | 23.2 |
| polycarbonate | 19.35 | 6.43 | 5.8 | 23.0 |
| polyethylene | 14.48 | −3.88 | 2.76 | 17.9 |
| polyethylene | 16.5 | 5.9 | 4.1 | 21.2 |
| (LDPE) | | | | |
| poly(maleic | 20.6 | 28.5 | 0 | 15.2 |
| anhydride) | | | | |
| poly(butyl | 17.1175 | 12.3205 | 0 | 18.0 |
| acrylate) | | | | |
| PET | 19.44 | 3.48 | 8.59 | 27.8 |

For example, the Flory-Huggins parameter using the total solubility parameter (δ_{T}) for combinations of various monomers above are shown in Table 2 below, where the X (along the diagonal) indicates that the Flory-Huggins parameter is 0.

TABLE 2
Examples of Flory-Huggins parameters for various combinations of monomers

| | 2. | | | | | 2. poly- | | 2. | |
|---|---|---|---|---|---|---|---|---|---|
| | Polyamide | 2. poly- | 2. poly- | 2. poly- | 2. poly- | ethylene | 2. maleic | poly(butyl | |
| χ12 | (Nylon 6) | styrene | propylene | carbonate | ethylene | (LDPE) | anhydride | acrylate) | 2. PET |
| 1. Polyamide | X | 0.003 | 0.553 | 0.342 | 0.839 | 0.359 | 0.557 | 0.215 | 0.163 |
| (Nylon 6) | | | | | | | | | |
| 1. polystyrene | 0.003 | X | 0.500 | 0.259 | 0.784 | 0.324 | 0.622 | 0.165 | 0.116 |
| 1. polypropylene | 0.553 | 0.500 | X | 0.917 | 0.093 | 0.000 | 2.595 | 0.485 | 0.764 |
| 1. polycarbonate | 0.342 | 0.259 | 0.917 | X | 0.468 | 0.135 | 1.153 | 0.001 | 0.007 |
| 1. polyethylene | 0.839 | 0.784 | 0.093 | 0.468 | X | 0.100 | 4.175 | 1.628 | 2.288 |
| 1. polyethylene | 0.359 | 0.324 | 0.000 | 0.135 | 0.100 | X | 2.544 | 0.456 | 0.724 |
| (LDPE) | | | | | | | | | |
| 1. maleic | 0.557 | 0.622 | 2.595 | 1.153 | 4.175 | 2.544 | X | 2.144 | 2.266 |
| anhydride | | | | | | | | | |
| 1. poly | 0.215 | 0.165 | 0.485 | 0.001 | 1.628 | 0.456 | 2.144 | X | 0.011 |
| (butylacrylate) | | | | | | | | | |
| 1. PET | 0.163 | 0.116 | 0.764 | 0.007 | 2.288 | 0.724 | 2.266 | 0.011 | X |

As an example of a monomer that has affinity to a matrix polymer, a polyamide 6 monomer would have affinity to a matrix polymer comprising a polyamide 6 monomer, as the polyamide 6 monomer is the same as a monomer of the matrix polymer.

As another example, a monomer is considered miscible with the matrix polymer when the equivalent homopolymer forms a homogeneous solution with the matrix polymer in the solid, glassy phase. This can be confirmed, for example, by DSC (Differential Scanning Chemistry) where the homogeneous solution would show a single glass transition.

In certain embodiments, a monomer does not have affinity to the matrix polymer when it is not the same as any monomer of the matrix polymer, it is not miscible with the matrix polymer, it does not comprise reactive sites that will covalently bond with the matrix polymer, it does not have ionic interactions with the matrix polymer, and/or it does not have a similar total solubility parameter to that of any monomer of the matrix polymer (i.e., the Flory-Huggins parameter is greater than 0.75).

According to some embodiments, the impact modifier and/or a monomer thereof comprises a polyamide (e.g., polyamide 6, polyamide 11, and/or polyamide 6,6), a polystyrene, a polyether, a polypropylene, a polycarbonate, a polyethylene, a polyester, ABS (acrylonitrile butadiene styrene), and/or PVC (polyvinyl chloride). Examples of suitable impact modifiers include the impact modifiers in Table 3.

TABLE 3
Non-limiting examples of suitable impact modifiers,
matrix polymers, and combinations thereof

| Type of | | | | |
|---|---|---|---|---|
| impact | Type of | | Suitable matrix | Type of interaction |
| modifier | copolymer | Monomers/repeat units | polymers | with matrix |
| styrenic | block | 1. Styrene | polystyrene | like monomers |
| | | 2. olefin rubber (e.g., | polypropylene | |
| | | isoprene, butadiene, | | |
| | | hydrogenated isoprene, | | |
| | | hydrogenated butylene) | | |
| maleated | random/ | 1. maleic anhydride | polyamide | polar interaction |
| | graft | 2. ethylene | polycarbonate | chemical |
| | | | | reaction |
| ethylene- | random | 1. ethylene, propylene | polyethylene | like monomers |
| acrylate | | 2. acrylic (e.g., butyl, ethyl, | polypropylene | miscibility |
| terpolymer | | or methyl acrylates) | polyester | polar interaction |
| | | 3. glycidyl methacrylate | polyamide | reaction |
| | | | ABS | |
| polyamide | random | 1. mixed amide monomers | polyamide | like monomers |
| terpolymer | | | | |
| PEBA | block | 1. amides | polyamide | like monomers |
| | | 2. ether | | |
| ionomers | random | 1. ethylene | polyamide | polar interaction |
| | | 2. acrylic acid salt | | chemical |
| | | | | reaction |
| chlorinated | random/ | 3. vinyl chloride | PVC | like monomers |
| polyethylene | graft | 4. ethylene | | |
| in FIG. | Scrim | | | |
| 5D) | Fine fiber | | | |
| | layer (e.g., | | | |
| | any fine fiber | | | |
| | layer | | | |
| | disclosed | | | |
| | herein) | | | |
| | Spunbond | | | |
| | layer | | | |

In embodiments where the fine fibers comprise an impact modifier (and/or a matrix polymer and an impact modifier), the fine fibers (and/or the combination of matrix polymer and impact modifier in the fine fibers) may comprise any suitable amount of an impact modifier. In certain embodiments, the fine fibers (and/or the combination of matrix polymer and impact modifier in the fine fibers) comprises greater than or equal to 1 wt. %, greater than or equal to 3 wt. %, greater than or equal to 5 wt. %, greater than or equal to 10 wt. %, greater than or equal to 15 wt. %, or greater than or equal to 20 wt. % impact modifier. In some embodiments, the fine fibers (and/or the combination of matrix polymer and impact modifier in the fine fibers) comprises less than or equal to 25 wt. %, less than or equal to 20 wt. %, less than or equal to 15 wt. %, less than or equal to 10 wt. %, less than or equal to 5 wt. %, or less than or equal to 3 wt. % impact modifier. Combinations of these ranges are also possible (e.g., greater than or equal to 1 wt. % and less than or equal to 25 wt. %, greater than or equal to 3 wt. % and less than or equal to 20 wt. %, or greater than or equal to 5 wt. % and less than or equal to 15 wt. %).

The impact modifier may have any suitable average molecular weight (e.g., Mₙ and/or M_{w}). For example, in some cases, the impact modifier has an average molecular weight (e.g., Mₙ and/or M_{w}) of greater than or equal to 1 kDa, greater than or equal to 3 kDa, greater than or equal to 5 kDa, greater than or equal to 7 kDa, greater than or equal to 10 kDa, greater than or equal to 15 kDa, greater than or equal to 20 kDa, greater than or equal to 25 kDa, greater than or equal to 30 kDa, greater than or equal to 35 kDa, greater than or equal to 40 kDa, greater than or equal to 45 kDa, greater than or equal to 50 kDa, greater than or equal to 55 kDa, or greater than or equal to 60 kDa. In certain embodiments, the impact modifier has an average molecular weight (e.g., Mₙ and/or M_{w}) of less than or equal to 100 kDa, less than or equal to 90 kDa, less than or equal to 80 kDa, less than or equal to 70 kDa, less than or equal to 60 kDa, less than or equal to 50 kDa, less than or equal to 45 kDa, less than or equal to 40 kDa, less than or equal to 35 kDa, less than or equal to 30 kDa, or less than or equal to 25 kDa. Combinations of these ranges are also possible (e.g., greater than or equal to 1 kDa and less than or equal to 100 kDa, greater than or equal to 3 kDa and less than or equal to 100 kDa, greater than or equal to 7 kDa and less than or equal to 100 kDa, greater than or equal to 20 kDa and less than or equal to 70 kDa). Average molecular weight may be determined using gel permeation chromatography (GPC), and may be determined using the equations disclosed elsewhere herein.

The ratio of the average molecular weight of the impact modifier to the average molecular weight of the matrix polymer may be any suitable ratio. For example, in certain embodiments, the ratio of the average molecular weight of the impact modifier to the average molecular weight of the matrix polymer is greater than or equal to 1:30, greater than or equal to 1:20, greater than or equal to 1:10, greater than or equal to 2:10, greater than or equal to 3:10, greater than or equal to 4:10, greater than or equal to 5:10, greater than or equal to 6:10, greater than or equal to 7:10, greater than or equal to 8:10, greater than or equal to 9:10, greater than or equal to 1:1, greater than or equal to 1.25:1, greater than or equal to 1.5:1, or greater than or equal to 1.75:1. In some instances, the ratio of the average molecular weight of the impact modifier to the average molecular weight of the matrix polymer is less than or equal to 2:1, less than or equal to 1.9:1, less than or equal to 1.8:1, less than or equal to 1.7:1, less than or equal to 1.6:1, less than or equal to 1.5:1, less than or equal to 1.4:1, less than or equal to 1.3:1, less than or equal to 1.2:1, less than or equal to 1.1:1, less than or equal to 1:1, less than or equal to 8:10, less than or equal to 6:10, less than or equal to 4:10, less than or equal to 2:10, or less than or equal to 1:10. Combinations of these ranges are also possible (e.g., greater than or equal to 1:30 and less than or equal to 2:1 or greater than or equal to 1:10 and less than or equal to 2:1).

The impact modifier may have any suitable polydispersity index (PDI). For example, in some cases, the impact modifier has a PDI of less than or equal to 3, less than or equal to 2.75, less than or equal to 2.5, less than or equal to 2.25, or less than or equal to 2. In certain instances, the impact modifier has a PDI of greater than or equal to 1, greater than or equal to 1.25, greater than or equal to 1.5, greater than or equal to 1.75, greater than or equal to 2, greater than or equal to 2.25, or greater than or equal to 2.5. Combinations of these ranges are also possible (e.g., greater than or equal to 1 and less than or equal to 3 or greater than or equal to 1 and less than or equal to 2). PDI may be determined according to the following equation:

PDI=M_{w}/Mₙ

where M_{w} is the mass average molecular weight and Mₙ is the number average molecular weight and M_{w} and Mₙ may be calculated from parameters measured using gel permeation chromatography according to ASTM D 3536 (1991).
M_{w} may be determined according to the following equations, or measured:

$$\overline{{M}_{w}} = \frac{{{\sum }_{i = 1}}^{N} {w}_{i} {M}_{i}}{{{\sum }_{i = 1}}^{N} {w}_{i}} = \frac{{{\sum }_{i = 1}}^{N} {N}_{i} {M}_{i}^{2}}{{{\sum }_{i = 1}}^{N} {N}_{i} {M}_{i}}$$

where wᵢ is the total weight (mass) of polymer chains with a specific length or molecular weight, Mᵢ is the molecular weight of the individual polymer chain with a specific length or molecular weight, Nᵢ is the number of polymer chains having approximately the same specific length or molecular weight, and N is the number of unique specific lengths or molecular weights of polymer chains within a sample. M_{w} may be used to determine the values of other variables (e.g., wᵢ and Mᵢ) from the same equation.

Mₙ may be determined according to the following equation:

$$\overline{{M}_{n}} = \frac{{{\sum }_{i = 1}}^{N} {N}_{i} {M}_{i}}{{{\sum }_{i = 1}}^{N} {N}_{i}}$$

where Mᵢ, Nᵢ, and N are as described above.

In accordance with certain embodiments, the impact modifier does not substantially chemically react with the matrix polymer. For example, in some cases, less than or equal to 10% (e.g., less than or equal to 5%, less than or equal to 3%, less than or equal to 1%, or none) of the monomers of the impact modifier have functional groups that would react with the matrix polymer. This may be determined from chemical analysis utilizing FTIR (Fourier transform infrared) spectroscopy, NMR (nuclear magnetic resonance) spectroscopy, and/or titration. As another example, in certain instances, there is no observable heat flow (e.g., due to chemical reaction) when observed using calorimetry.

According to some embodiments, the impact modifier does not substantially affect thermal transitions of the matrix polymer. For example, in certain cases, the glass transition temperature of the matrix polymer is not substantially affected (e.g., stays within 25%, within 20%, within 15%, within 10%, within 5%, or the same) by the addition of the impact modifier. As another example, in some instances, the thermal transitions (e.g., melting and/or crystallization) of the matrix polymer are reversible even when combined with the impact modifier. Thermal transitions, and reversibility thereof, may be determined by differential scanning calorimetry (DSC).

In certain embodiments, the impact modifier exhibits independent thermal transitions from the matrix polymer even when combined, as determined by differential scanning calorimetry (DSC).

In some embodiments, the impact modifier may be separated from the matrix polymer by physical means (e.g., extraction) even after combined.

In some instances, the impact modifier is dispersed in the matrix polymer. For example, in certain cases, the impact modifier is uniformly dispersed throughout the matrix polymer. In certain embodiments, the impact modifier is present in microdomains in a continuous phase (the matrix polymer). The dispersion of the impact modifier in the matrix polymer may be determined by transmission electron microscopy (TEM) using staining for contrast.

According to certain embodiments, the impact modifiers are discrete microdomains. The impact modifier discrete microdomains may have any suitable average largest cross-sectional diameter. For example, in some cases, the impact modifier discrete microdomains have an average largest cross-sectional diameter of greater than or equal to 1/100, greater than or equal to 1/90, greater than or equal to 1/80, greater than or equal to 1/70, greater than or equal to 1/60, greater than or equal to 1/50, greater than or equal to 1/40, greater than or equal to 1/30, greater than or equal to 1/20, greater than or equal to 1/10, greater than or equal to 1/7, greater than or equal to ⅕, greater than or equal to ¼, greater than or equal to ⅓, or greater than or equal to ½ of the average diameter of the fine fibers. In certain embodiments, the impact modifier discrete microdomains have an average largest cross-sectional diameter of less than or equal to ¾, less than or equal to ⅔, less than or equal to ½, less than or equal to ⅓, less than or equal to ¼, less than or equal to ⅕, less than or equal to 1/7, less than or equal to 1/10, less than or equal to 1/20, less than or equal to 1/30, less than or equal to 1/40, less than or equal to 1/50, less than or equal to 1/60, less than or equal to 1/70, less than or equal to 1/80, or less than or equal to 1/90 of the average largest cross-sectional diameter of the fine fibers. Combinations of these ranges are also possible (e.g., greater than or equal to 1/100 and less than or equal to ¾ or greater than or equal to 1/100 and less than or equal to ¼).

As another example, in some embodiments, the average diameter of the impact modifier discrete microdomains is greater than or equal to 10 nm, greater than or equal to 25 nm, greater than or equal to 50 nm, greater than or equal to 75 nm, greater than or equal to 100 nm, greater than or equal to 150 nm, greater than or equal to 200 nm, greater than or equal to 250 nm, greater than or equal to 300 nm, greater than or equal to 350 nm, greater than or equal to 400 nm, or greater than or equal to 450 nm. In certain embodiments, the average diameter of the impact modifier discrete microdomains is less than or equal to 500 nm, less than or equal to 450 nm, less than or equal to 400 nm, less than or equal to 350 nm, less than or equal to 300 nm, less than or equal to 250 nm, less than or equal to 200 nm, less than or equal to 150 nm, less than or equal to 100 nm, less than or equal to 75 nm, less than or equal to 50 nm, or less than or equal to 25 nm. Combinations of these ranges are also possible (e.g., greater than or equal to 10 nm and less than or equal to 500 nm). The average diameter of the impact modifier discrete microdomains may be determined by transmission electron microscopy (TEM).

The impact modifier may have any suitable glass transition temperature relative to the temperature at which the filter media would be used. For example, in some embodiments, the glass transition temperature of the impact modifier is lower than (e.g., at least 1° C., at least 3° C., at least 5° C., at least 10° C., at least 15° C., or at least 20° C. lower than) the temperature at which the filter media would be used (e.g., a use temperature of greater than or equal to 20° C., greater than or equal to 40° C., greater than or equal to 60° C., or greater than or equal to 80° C.; less than or equal to 100° C., less than or equal to 80° C., less than or equal to 60° C., or less than or equal to 40° C.; combinations of these ranges are also possible, such as greater than or equal to 20° C. and less than or equal to 100° C. or greater than or equal to 20° C. and less than or equal to 60° C.). Without wishing to be bound by any theory, it is believed that using an impact modifier with a glass transition temperature lower than the use temperature (e.g., by a range specified herein) allows the impact modifier to absorb energy at approximately the velocity/frequency of crack propagation in the matrix polymer.

The impact modifier may have any suitable absolute glass transition temperature. For example, in certain cases, the impact modifier has a glass transition temperature of greater than or equal to −50° C., greater than or equal to −40° C., greater than or equal to −30° C., greater than or equal to −20° C., greater than or equal to −10° C., greater than or equal to 0° C., or greater than or equal to 10° C. In some instances, the impact modifier has a glass transition temperature of less than or equal to 15° C., less than or equal to 10° C., less than or equal to 5° C., less than or equal to 0° C., less than or equal to −10° C., less than or equal to −20° C., less than or equal to −30° C., or less than or equal to −40° C. Combinations of these ranges are also possible (e.g., greater than or equal to −50° C. and less than or equal to 15° C.). The value of the glass transition temperature may be measured by differential scanning calorimetry. Without wishing to be bound by theory, it is believed that having a low glass transition temperature imparts a rubbery nature to the impact modifier, which allows it to make brittle materials more impact resistant.

In certain embodiments, the fine fibers comprise a salt. Examples of suitable salts may include ammonium salts (e.g., tetraethylammonium bromide (TEAB)), sulfonium salts, organic salts (e.g., pyridine), and/or inorganic salts.

In embodiments where the fine fibers comprise a salt, the fine fibers may comprise any suitable amount of salt. For example, in some cases, the fine fibers comprises less than or equal to 5 wt. %, less than or equal to 4 wt. %, less than or equal to 3 wt. %, less than or equal to 2 wt. % or less than or equal to 1 wt. % salt. In certain instances, the fine fibers comprise greater than or equal to 0.1 wt. %, greater than or equal to 0.5 wt. %, greater than or equal to 1 wt. %, greater than or equal to 2 wt. %, greater than or equal to 3 wt. %, or greater than or equal to 4 wt. % salt. Combinations of these ranges are also appropriate (e.g., greater than or equal to 0.1 wt. % and less than or equal to 5 wt. % or greater than or equal to 1 wt. % and less than or equal to 5 wt. %).

In certain embodiments, a fine fiber layer comprises fine fibers (e.g., any fine fibers disclosed herein). For example, in FIG. 1A, layer 110 comprises fine fibers. The fine fiber layer may include 100 wt. % fine fibers.

In some embodiments, the fine fibers and/or the fine fiber layer is substantially free (e.g., less than or equal to 1 wt. %, less than or equal to 0.05 wt. %, or less than or equal to 0.01 wt. %) or free of glass fibers. Without wishing to be bound by theory, it is believed that reducing the amount of, or eliminating, glass fibers in the fine fiber layer may result in higher gamma, improved pleating, and/or improved handling durability (e.g., reduced shedding of fibers).

In certain embodiments, the fine fibers and/or the fine fiber layer is substantially free (e.g., less than or equal to 1 wt. %, less than or equal to 0.05 wt. %, or less than or equal to 0.01 wt. %) or free of a crosslinker.

The fine fiber layer may have any suitable thickness. For example, in some cases, the fine fiber layer has a thickness greater than the average fiber diameter of the fine fibers. For example, in certain embodiments, the fine fiber layer has a thickness of greater than or equal to 10 nm, greater than or equal to 20 nm, greater than or equal to 30 nm, greater than or equal to 40 nm, greater than or equal to 50 nm, greater than or equal to 100 nm, greater than or equal to 500 nm, greater than or equal to 1 micron, greater than or equal to 10 microns, greater than or equal to 0.1 mm, greater than or equal to 1 mm, greater than or equal to 3 mm, or greater than or equal to 3 mm. In some embodiments, the fine fiber layer has a thickness of less than or equal to 5 mm, less than or equal to 4 mm, less than or equal to 3 mm, less than or equal to 2 mm, less than or equal to 1 mm, less than or equal to 0.5 mm, less than or equal to 0.2 mm, less than or equal to 0.1 mm, less than or equal to 10 microns, less than or equal to 1 micron, less than or equal to 500 nm, or less than or equal to 100 nm. Combinations of these ranges are also possible (e.g., greater than or equal to 10 nm and less than or equal to 5 mm, greater than or equal to 20 nm and less than or equal to 1 mm, or greater than or equal to 50 nm and less than or equal to 0.2 mm). Thickness may be determined using Scanning Electron Microscopy (SEM) to image a cross-section of the fine fiber layer.

The fine fiber layer may have any suitable basis weight. For example, in certain embodiments, the fine fiber layer has a basis weight of greater than or equal to 0.001 gsm, greater than or equal to 0.01 gsm, greater than or equal to 0.1 gsm, greater than or equal to 1 gsm, greater than or equal to 2 gsm, greater than or equal to 3 gsm, greater than or equal to 4 gsm, greater than or equal to 5 gsm, greater than or equal to 7 gsm, greater than or equal to 10 gsm, greater than or equal to 12 gsm, or greater than or equal to 15 gsm. In some embodiments, the fine fiber layer has a basis weight of less than or equal to 20 gsm, less than or equal to 18 gsm, less than or equal to 15 gsm, less than or equal to 13 gsm, less than or equal to 10 gsm, less than or equal to 8 gsm, less than or equal to 5 gsm, less than or equal to 4 gsm, less than or equal to 3 gsm, less than or equal to 2 gsm, or less than or equal to 1 gsm. Combinations of these ranges are also possible (e.g., greater than or equal to 0.001 gsm and less than or equal to 20 gsm, greater than or equal to 0.01 gsm and less than or equal to 10 gsm, or greater than or equal to 0.1 gsm and less than or equal to 5 gsm). Basis weight may be measured according to ISO 536 (2012).

The fine fiber layer may have any suitable void volume. For example, in some cases, the fine fiber layer has a void volume of greater than or equal to 65%, greater than or equal to 70%, greater than or equal to 75%, greater than or equal to 80%, greater than or equal to 85%, greater than or equal to 90%, greater than or equal to 95%, or greater than or equal to 97%. In certain embodiments, the fine fiber layer has a void volume of less than or equal to 99%, less than or equal to 98%, less than or equal to 97%, less than or equal to 95%, less than or equal to 90%, less than or equal to 85%, less than or equal to 80%, or less than or equal to 75%. Combinations of these ranges are also possible (e.g., greater than or equal to 65% and less than or equal to 99%, greater than or equal to 70% and less than or equal to 97%, greater than or equal to 80% and less than or equal to 97%, or greater than or equal to 90% and less than or equal to 97%). As used herein, the void volume (%) is 100%−the solidity (%), wherein solidity (%)=[basis weight/(fiber density*thickness)]*100%, and wherein the basis weight and thickness may be determined as described elsewhere herein. The fiber density is equivalent to the average density of the material or material(s) forming the fiber, which is typically specified by the fiber manufacturer. The average density of the materials forming the fibers may be determined by: (1) determining the total volume of all of the fibers in the fine fiber layer; and (2) dividing the total mass of all of the fibers in the fine fiber layer by the total volume of all of the fibers in the fine fiber layer. If the mass and density of each type of fiber in the fine fiber layer are known, the volume of all the fibers in the fine fiber layer may be determined by: (1) for each type of fiber, dividing the total mass of the type of fiber in the fine fiber layer by the density of the type of fiber; and (2) summing the volumes of each fiber type. If the mass and density of each type of fiber in the fine fiber layer are not known, the volume of all the fibers in the fine fiber layer may be determined in accordance with Archimedes' principle.

The fine fiber layer may have any suitable average pore size. For example, in some embodiments, the fine fiber layer has an average pore size of greater than or equal to 0.001 microns, greater than or equal to 0.01 microns, greater than or equal to 0.05 microns, greater than or equal to 0.1 microns, greater than or equal to 0.2 microns, greater than or equal to 0.5 microns, greater than or equal to 1 micron, greater than or equal to 2 microns, greater than or equal to 3 microns, greater than or equal to 4 microns, greater than or equal to 5 microns, greater than or equal to 7 microns, or greater than or equal to 9 microns. In certain embodiments, the fine fiber layer has an average pore size of less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, or less than or equal to 1 micron. Combinations of these ranges are also possible (e.g., greater than or equal to 0.001 microns and less than or equal to 10 microns, greater than or equal to 0.01 microns and less than or equal to 8 microns, greater than or equal to 0.01 microns and less than or equal to 5 microns, greater than or equal to 0.05 microns and less than or equal to 5 microns, or greater than or equal to 0.2 microns and less than or equal to 3 microns). The average pore size may be measured using ASTM F316 (2003).

The fine fiber layer may have any suitable maximum pore diameter. For example, in certain embodiments, the fine fiber layer has a maximum pore diameter of greater than or equal to 0.1 microns, greater than or equal to 0.2 microns, greater than or equal to 0.3 microns, greater than or equal to 0.4 microns, greater than or equal to 0.5 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, or greater than or equal to 12 microns. In some cases, the fine fiber layer has a maximum pore diameter of less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, or less than or equal to 1 micron. Combinations of these ranges are also possible (e.g., greater than or equal to 0.1 microns and less than or equal to 15 microns or greater than or equal to 0.3 microns and less than or equal to 12 microns). The maximum pore size may be measured using ASTM F316 (2003).

The fine fiber layer may have any suitable air permeability. For example, in certain instances, the fine fiber layer has an air permeability of greater than 0 CFM, greater than or equal to 0.1 CFM, greater than or equal to 0.5 CFM, greater than or equal to 1 CFM, greater than or equal to 2 CFM, greater than or equal to 5 CFM, greater than or equal to 7 CFM, greater than or equal to 10 CFM, greater than or equal to 12 CFM, greater than or equal to 15 CFM, greater than or equal to 20 CFM, greater than or equal to 25 CFM, greater than or equal to 30 CFM, greater than or equal to 40 CFM, greater than or equal to 50 CFM, greater than or equal to 60 CFM, greater than or equal to 70 CFM, greater than or equal to 80 CFM, or greater than or equal to 90 CFM. In some cases, the fine fiber layer has an air permeability of less than or equal to 100 CFM, less than or equal to 90 CFM, less than or equal to 80 CFM, less than or equal to 70 CFM, less than or equal to 60 CFM, less than or equal to 50 CFM, less than or equal to 40 CFM, less than or equal to 30 CFM, less than or equal to 25 CFM, less than or equal to 20 CFM, less than or equal to 15 CFM, less than or equal to 12 CFM, less than or equal to 10 CFM, less than or equal to 7 CFM, or less than or equal to 5 CFM. Combinations of these ranges are also possible (e.g., greater than 0 CFM and less than or equal to 100 CFM, greater than or equal to 0.1 CFM and less than or equal to 50 CFM, or greater than or equal to 0.5 CFM and less than or equal to 30 CFM). Air permeability may be measured according to ASTM D737-04 (2016) at a pressure of 125 Pa.

The fine fiber layer may have any suitable elongation at break. For example, in certain cases, the fine fiber layer has an elongation at break of greater than or equal to 5%, greater than or equal to 10%, greater than or equal to 15%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 100%, greater than or equal to 125%, greater than or equal to 150%, greater than or equal to 175%, or greater than or equal to 200%. In some embodiments, the fine fiber layer has an elongation at break of less than or equal to 300%, less than or equal to 275%, less than or equal to 250%, less than or equal to 225%, less than or equal to 200%, less than or equal to 175%, less than or equal to 150%, less than or equal to 125%, less than or equal to 100%, less than or equal to 90%, less than or equal to 80%, less than or equal to 70%, less than or equal to 60%, or less than or equal to 50%. Combinations of these ranges are also possible (e.g., greater than or equal to 5% and less than or equal to 300%, greater than or equal to 20% and less than or equal to 300%, greater than or equal to 40% and less than or equal to 300%, greater than or equal to 30% and less than or equal to 200%, or greater than or equal to 40% and less than or equal to 80%).

The elongation at break may be determined by performing a tensile test, as described below. Briefly, the following procedure may be followed: (1) A 1″ by 7″ sample of the layer comprising the fine fibers is cut from the layer comprising the fine fibers; (2) The 1″ by 7″ sample is loaded into a Thwing-Albert tensile tester equipped with a 20 N load cell and having a gap between the jaws of 3.5″; (3) The sample is extended by the jaws at a rate of 12″ per minute until the sample breaks. The starting length and distance at break are analyzed by the tester.

The fine fiber layer may have any suitable tensile strength. For example, in some embodiments, the fine fiber layer has a tensile strength of greater than or equal to 15 gf/gsm, greater than or equal to 30 gf/gsm, greater than or equal to 50 gf/gsm, greater than or equal to 60 gf/gsm, greater than or equal to 70 gf/gsm, greater than or equal to 75 gf/gsm, greater than or equal to 80 gf/gsm, greater than or equal to 100 gf/gsm, greater than or equal to 125 gf/gsm, greater than or equal to 150 gf/gsm, greater than or equal to 200 gf/gsm, greater than or equal to 250 gf/gsm, greater than or equal to 300 gf/gsm, greater than or equal to 400 gf/gsm, greater than or equal to 500 gf/gsm, greater than or equal to 600 gf/gsm, greater than or equal to 700 gf/gsm, greater than or equal to 800 gf/gsm, or greater than or equal to 900 gf/gsm. In certain embodiments, the fine fiber layer has a tensile strength of less than or equal to 1000 gf/gsm, less than or equal to 900 gf/gsm, less than or equal to 800 gf/gsm, less than or equal to 700 gf/gsm, less than or equal to 600 gf/gsm, less than or equal to 500 gf/gsm, less than or equal to 400 gf/gsm, less than or equal to 300 gf/gsm, less than or equal to 250 gf/gsm, less than or equal to 200 gf/gsm, less than or equal to 150 gf/gsm, less than or equal to 125 gf/gsm, less than or equal to 100 gf/gsm, less than or equal to 80 gf/gsm, less than or equal to 70 gf/gsm, or less than or equal to 60 gf/gsm. Combinations of these ranges are also possible (e.g., greater than or equal to 15 gf/gsm and less than or equal to 1000 gf/gsm, greater than or equal to 30 gf/gsm and less than or equal to 1000 gf/gsm, greater than or equal to 50 gf/gsm and less than or equal to 1000 gf/gsm, greater than or equal to 75 gf/gsm and less than or equal to 1000 gf/gsm, or greater than or equal to 80 gf/gsm and less than or equal to 150 gf/gsm).

Tensile strength, as described herein, may be determined by depositing fine fibers onto wax paper, to have a basis weight of 5 gsm. These freestanding fine fiber layers are then removed from the wax paper, with specimens cut to dimensions of 1 inch×7 inch for measurement on a Thwing-Albert tensile tester equipped with 20 N load cell. The gap between the jaws on the machine is 3.5 inches, and the rate of extension is 12 in/min. The tensile test data is then translated into stress-strain curves (e.g., using Winwedge—12—software). Average tensile strength is determined from at least 10 individual measurements and calculated from the stress-strain curves. Tensile strength is the average tensile strength normalized by dividing by the basis weight.

The fine fiber layer may have any suitable average puncture strength. For example, in certain embodiments, the fine fiber layer has an average puncture strength of greater than or equal to 1 N, greater than or equal to 5 N, greater than or equal to 10 N, greater than or equal to 15 N, greater than or equal to 20 N, greater than or equal to 25 N, greater than or equal to 30 N, greater than or equal to 35 N, greater than or equal to 40 N, or greater than or equal to 45 N. In some instances, the fine fiber layer has an average puncture strength of less than or equal to 50 N, less than or equal to 45 N, less than or equal to 40 N, less than or equal to 35 N, less than or equal to 30 N, less than or equal to 25 N, less than or equal to 20 N, less than or equal to 15 N, less than or equal to 10 N, or less than or equal to 5 N. Combinations of these ranges are also possible (e.g., greater than or equal to 1 N and less than or equal to 50 N, greater than or equal to 10 N and less than or equal to 45 N, or greater than or equal to 20 N and less than or equal to 40 N). Average puncture strength may be measured according to BCIS 03B-35 using an instrument called “Chatillon TCM 201 tester.” The sample to be measured is placed underneath the probe, which drops down at a speed of 4″ per minute to puncture the substrate. Once it punctures the media it measures the puncture strength.

The fine fiber layer may have any suitable toughness, wherein the toughness is the amount of tensile energy absorbed by the fine fiber layer without breaking. For example, in some instances, the fine fiber layer has a toughness of greater than or equal to 20 g/gsm, greater than or equal to 25 g/gsm, greater than or equal to 30 g/gsm, greater than or equal to 35 g/gsm, greater than or equal to 40 g/gsm, greater than or equal to 50 g/gsm, greater than or equal to 60 g/gsm, greater than or equal to 70 g/gsm, greater than or equal to 80 g/gsm, greater than or equal to 90 g/gsm, or greater than or equal to 100 g/gsm. In certain cases, the fine fiber layer has a toughness of less than or equal to 120 g/gsm, less than or equal to 110 g/gsm, less than or equal to 100 g/gsm, less than or equal to 90 g/gsm, less than or equal to 80 g/gsm, less than or equal to 70 g/gsm, less than or equal to 60 g/gsm, less than or equal to 50 g/gsm, less than or equal to 40 g/gsm, or less than or equal to 35 g/gsm. Combinations of these ranges are also possible (e.g., greater than or equal to 20 g/gsm and less than or equal to 120 g/gsm, greater than or equal to 25 g/gsm and less than or equal to 110 g/gsm, or greater than or equal to 40 g/gsm and less than or equal to 100 g/gsm). Toughness may be measured according to T494 om-96, wherein the toughness is the total area under the stress-strain curve.

In some embodiments, the fine fiber layer is treated. For example, in certain cases, the fine fiber layer is heat treated (e.g., by passing the fine fiber layer through a hot air dryer).

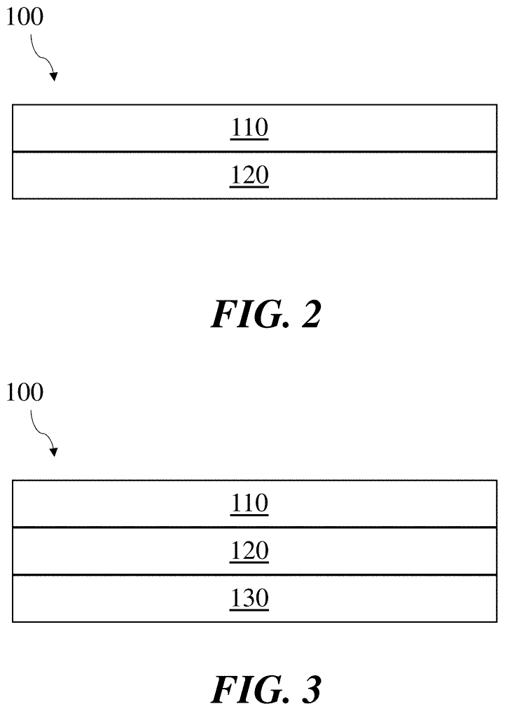

In some embodiments, the filter media comprises one or more supplemental layers (e.g., in addition to the fine fiber layer). For example, in FIG. 2, in some cases, filter media 100 comprises fine fiber layer 110 and second layer 120, wherein second layer 120 is a supplemental layer. Similarly, in FIG. 3, in certain instances, filter media 100 comprises fine fiber layer 110, second layer 120, and third layer 130, wherein second layer 120 and third layer 130 are supplemental layers.

The filter media may have any suitable number of supplemental layers. For example, in certain embodiments, the filter media comprises greater than 0, greater than or equal to 1, greater than or equal to 2, greater than or equal to 3, greater than or equal to 4, greater than or equal to 5, greater than or equal to 6, greater than or equal to 7, greater than or equal to 10, or greater than or equal to 15 supplemental layers. In some cases, the filter media comprises less than or equal to 20, less than or equal to 18, less than or equal to 15, less than or equal to 13, less than or equal to 10, less than or equal to 8, less than or equal to 6, less than or equal to 5, less than or equal to 4, less than or equal to 3, or less than or equal to 2 supplemental layers. Combinations of these ranges are also possible (e.g., greater than 0 and less than or equal to 20 supplemental layers, greater than or equal to 1 and less than or equal to 10 supplemental layers, greater than or equal to 3 and less than or equal to 6 supplemental layers, or greater than or equal to 2 and less than or equal to 6 supplemental layers).

A variety of suitable supplemental layers may be employed (e.g., in conjunction with at least one fine fiber layer to form a multilayer filter media). For instance, examples of suitable supplemental layer may include: prefilter layers, backers, scrims, spacers, meltblown layers, wetlaid layers, drylaid layers, airlaid layers, spunbond layers, carded layers, calendered layers, oleophobic layers (e.g., a layer comprising an oleophobic additive or coating and/or a layer having an oil range of greater than or equal to 1), oleophilic layers, charged (e.g., electrostatically charged, triboelectrically charged, and/or hydrocharged) layers, and/or uncharged layers. A fine fiber layer may be deposited onto a backer layer, and then one or more further supplemental layers may be laminated thereon (e.g., facing the backer layer, facing the fine fiber layer). Without wishing to be bound by any particular theory, it is believed that meltblown layers may enhance the capacity of the filter media and/or may perform intermediate stage filtration, backer layers may enhance the strength and/or pleatability of the filter media, scrims may protect the filter media, and prefilter layers may enhance the capacity of the filter media and/or protect the filter media.

In embodiments in which one or more supplemental layers is oleophobic, the one or more supplemental layers may comprise a coating (e.g., an oleophobic coating, an oleophobic component that is an oleophobic coating) and/or comprise a resin (e.g., an oleophobic resin, an oleophobic component that is an oleophobic resin). The coating process may involve chemical deposition techniques and/or physical deposition techniques. For instance, a coating process may comprise introducing resin or a material (e.g., an oleophobic component that is a resin or material) dispersed in a solvent or solvent mixture into a pre-formed fiber layer (e.g., a pre-formed fiber web formed by a meltblown process). As an example, a pre-filter may be sprayed with a coating material (e.g., a water-based fluoroacrylate such as AGE 550D). Non-limiting examples of coating methods include the use of vapor deposition (e.g., chemical vapor deposition, physical vapor deposition), layer-by-layer deposition, wax solidification, self-assembly, sol-gel processing, a slot die coater, gravure coating, screen coating, size press coating (e.g., a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, laboratory size press coating, melt coating, dip coating, knife roll coating, spin coating, powder coating, spray coating (e.g., electrospraying), gapped roll coating, roll transfer coating, padding saturant coating, saturation impregnation, chemical bath deposition, and solution deposition. Other coating methods are also possible.

In some embodiments, the coating material may be applied to the fiber web using a non-compressive coating technique. The non-compressive coating technique may coat the fiber web, while not substantially decreasing the thickness of the web. In other embodiments, the resin may be applied to the fiber web using a compressive coating technique.

Other techniques include vapor deposition methods. Such methods include atmospheric pressure chemical vapor deposition (APCVD), low pressure chemical vapor deposition (LPCVD), metal-organic chemical vapor deposition (MOCVD), plasma assisted chemical vapor deposition (PACVD) or plasma enhanced chemical vapor deposition (PECVD), laser chemical vapor deposition (LCVD), photochemical vapor deposition (PCVD), chemical vapor infiltration (CVI) chemical beam epitaxy (CBE), electron beam assisted radiation curing, and atomic layer deposition. In physical vapor deposition (PVD) thin films (e.g., thin films comprising an oleophobic component) are deposited by the condensation of a vaporized form of the desired film material onto substrate. This method involves physical processes such as high-temperature vacuum evaporation with subsequent condensation, plasma sputter bombardment rather than a chemical reaction, electron beam evaporation, molecular beam epitaxy, and/or pulsed laser deposition.

In some embodiments, a surface of one or more layers (e.g., a surface of a first layer, a surface of a second layer, a surface of a third layer, a surface of a pre-filter layer, a surface of a main filter layer) may be modified using additives (e.g., oleophobic components that are additives such as oleophobic additives). In some embodiments, one or more layers (e.g., a first layer, a second layer, a third layer, a pre-filter layer, a main filter layer) may comprise an additive or additives (e.g., oleophobic components that are additive(s) such as oleophobic additive(s)). The additives may be functional chemicals that are added to polymeric/thermoplastic fibers during a meltblowing process, an electrospinning process, and/or an extrusion process that may render different physical and chemical properties at the surface from those of the polymer/thermoplastic itself after formation. The additive(s) may, in some embodiments, migrate towards the surface of the fiber during or after formation of the fiber material (polymer/thermoplastic) such that the surface of the fiber is modified with the additive, with the center of the fiber including more of the polymer/thermoplastic material. In some embodiments, one or more additives are included to render the surface of a fiber oleophobic as described herein. For instance, the additive may be an oleophobic material as described herein. Non-limiting examples of suitable additives include fluoroacrylates, fluorosurfactants, oleophobic silicones, fluoropolymers, fluoromonomers, fluorooligomers, and oleophobic polymers.

The additive (e.g., the oleophobic component in the form of an additive), if present, may be present in any suitable form prior to undergoing a meltblowing, electrospinning, or wetlaying procedure, or in any suitable form in the fiber after fiber formation. For instance, in some embodiments, the additive may be in a liquid (e.g., melted) form that is mixed with the thermoplastic material prior to or during fiber formation. In some cases, the additive may be in particulate form prior to, during, or after fiber formation. In certain embodiments, particles of the melt additive may be present in the fully formed fibers. In some embodiments, an additive may be one component of a binder, and/or may be added to one or more layers by spraying the layer with a composition comprising the additive. If particulate, the additive may have any suitable morphology (e.g., particles of different shapes and sizes, flakes, ellipsoids, fibers).

Any suitable size of particles of additive (e.g., particles of an oleophobic component that is an additive) may be included with the fiber forming thermoplastic material to form the fibers and/or present in the fully formed fibers. For example, the average particle size (e.g., average diameter, or average cross-sectional dimension) of the particles may be greater than or equal to about 0.002 microns, greater than or equal to about 0.01 microns, greater than or equal to about 0.05 microns, greater than or equal to about 0.1 microns, greater than or equal to about 0.5 microns, greater than or equal to about 1 micron, greater than or equal to about 5 microns, greater than or equal to about 10 microns, greater than or equal to about 20 microns, greater than or equal to about 50 microns, greater than or equal to about 100 microns, or greater than or equal to about 200 microns. The particles may have an average particle size of, for example, less than or equal to about 300 microns, less than or equal to about 200 microns, less than or equal to about 100 microns, less than or equal to about 50 microns, less than or equal to about 30 microns, less than or equal to about 15 microns, less than 10 or equal to about 10 microns, less than or equal to about 5 microns, less than or equal to about 1 micron, less than or equal to about 0.1 microns, or less than or equal to about 0.01 microns. Combinations of the above-referenced ranges are also possible (e.g., greater than or equal to about 0.01 microns and less than or equal to about 10 microns). Other ranges are also possible. The average particle sizes as used herein are measured by dynamic light scattering.

In some embodiments, a material (e.g., an oleophobic component, a precursor that reacts to form an oleophobic component) may undergo a chemical reaction (e.g., polymerization) after being applied to a layer (e.g., a first layer, a second layer, a third layer, a pre-filter layer, a main filter layer). For example, a surface of a layer may be coated with one or more monomers that is polymerized after coating. In another example, a surface of a layer may include monomers, as a result of a melt additive, that are polymerized after formation of the fiber web. In some such embodiments, an in-line polymerization may be used. In-line polymerization (e.g., in-line ultraviolet polymerization) is a process to cure a monomer or liquid polymer solution onto a substrate under conditions sufficient to induce polymerization (e.g., under UV irradiation).

The term “self-assembled monolayers” (SAMs) refers to molecular assemblies that may be formed spontaneously by the immersion of an appropriate substrate into a solution of an active surfactant in an organic solvent to create an oleophobic surface.

In wax solidification, the layer is dipped into melted alkylketene dimer (AKD) heated at 90° C., and then cooled at room temperature in an atmosphere of dry N₂ gas. AKD undergoes fractal growth when it solidifies and improves the oleophobicity of the substrate.

In some embodiments, a species used to form a surface-modified layer (e.g., a surface-modified first layer, a surface-modified second layer, a surface-modified third layer, a surface-modified pre-filter layer, a surface-modified main filter layer) or a species that is a component of a surface-modified layer (e.g., an oleophobic component, a precursor that reacts to form an oleophobic component) may comprise a small molecule, such as an inorganic or organic oleophobic molecule. Non-limiting examples include hydrocarbons (e.g., CH₄, C₂H₂, C₂H₄, C₆H₆), fluorocarbons (e.g., fluoroaliphatic compounds, fluoroaromatic compounds, fluoropolymers, fluorocarbon block copolymers, fluorocarbon acrylate polymers, fluorocarbon methacrylate polymers, fluoroelastomers, fluorosilanes, fluorosiloxanes, fluoro polyhedral oligomeric silsesquioxane, fluorinated dendrimers, inorganic fluorine compounds, CF₄, C₂F₄, C₃F₆, C₃F₈, C₄H₈, C₅H₁₂, C₆F₆, SF₃, SiF₄, BF₃), silanes (e.g., SiH₄, Si₂H₆, Si₃H₈, Si₄H₁₀), organosilanes (e.g., methylsilane, dimethylsilane, triethylsilane), siloxanes (e.g., dimethylsiloxane, hexamethyldisiloxane), ZnS, CuSe, InS, CdS, tungsten, silicon carbide, silicon nitride, silicon oxynitride, titanium nitride, carbon, silicon-germanium, and hydrophobic acrylic monomers terminating with alkyl groups and their halogenated derivatives (e.g., ethyl 2-ethylacrylate, methyl methacrylate; acrylonitrile). In certain embodiments, suitable hydrocarbons for modifying a surface of a layer may have the formula CₓH_{y}, where x is an integer from 1 to 10 and y is an integer from 2 to 22. In certain embodiments, suitable silanes for modifying a surface of a layer may have the formula SiₙH₂ₙ₊₂ where any hydrogen may be substituted for a halogen (e.g., Cl, F, Br, I), and where n is an integer from 1 to 10. In some embodiments, a species used to form a surface-modified layer or a species that is a component of a surface-modified layer may comprise one or more of a wax, a silicone, and a corn based polymer (e.g., Zein). In some embodiments, a species used to form a surface-modified layer or a species that is a component of a surface-modified layer may comprise one or more nano-particulate materials. Other compositions are also possible.

As used herein, “small molecules” refers to molecules, whether naturally occurring or artificially created (e.g., via chemical synthesis) that have a relatively low molecular weight. Typically, a small molecule is an organic compound (i.e., it contains carbon). The small organic molecule may contain multiple carbon-carbon bonds, stereocenters, and other functional groups (e.g., amines, hydroxyl, carbonyls, and heterocyclic rings, etc.). In certain embodiments, the molecular weight of a small molecule is at most about 1,000 g/mol, at most about 900 g/mol, at most about 800 g/mol, at most about 700 g/mol, at most about 600 g/mol, at most about 500 g/mol, at most about 400 g/mol, at most about 300 g/mol, at most about 200 g/mol, or at most about 100 g/mol. In certain embodiments, the molecular weight of a small molecule is at least about 100 g/mol, at least about 200 g/mol, at least about 300 g/mol, at least about 400 g/mol, at least about 500 g/mol, at least about 600 g/mol, at least about 700 g/mol, at least about 800 g/mol, or at least about 900 g/mol, or at least about 1,000 g/mol. Combinations of the above ranges (e.g., at least about 200 g/mol and at most about 500 g/mol) are also possible.

In some embodiments, a species used to form a surface-modified layer (e.g., a surface-modified first layer, a surface-modified second layer, a surface-modified third layer, a surface-modified pre-filter layer, a surface-modified main filter layer) or a species that is a component of a surface-modified layer (e.g., an oleophobic component, a precursor that reacts to form an oleophobic component) may comprise a cross-linker. Non-limiting examples of suitable cross-linkers include species with one or more acrylate groups, such as 1,6-hexanediol diacrylate, and aloxylated cyclohexane dimethonol diacrylate.

In some embodiments, a surface of a layer (e.g., a surface of a first layer, a surface of a second layer, a surface of a third layer, a surface of a pre-filter layer, a surface of a main filter layer) may be modified by roughening the surface or material on the surface of the layer. In some such cases, the surface modification may be a roughened surface or material. The surface roughness of the surface of a layer or material on the surface of a layer may be roughened microscopically and/or macroscopically. Non-limiting examples of methods for enhancing roughness include modifying a surface with certain fibers, mixing fibers having different diameters, and lithography. In certain embodiments, fibers with different diameters (e.g., staple fibers, continuous fibers) may be mixed or used to enhance or decrease surface roughness. In some embodiments, electrospinning may be used to create applied surface roughness alone or in combination with other methods, such as chemical vapor deposition. In some embodiments, lithography may be used to roughen a surface. Lithography encompasses many different types of surface preparation in which a design is transferred from a master onto a surface.

In some embodiments, the roughness of a layer (e.g., the roughness of a first layer, the roughness of a second layer, the roughness of a third layer, the roughness of a pre-filter layer, the roughness of a main filter layer) may be used to modify the wettability of a layer with respect to a particular fluid. In some instances, the roughness may alter or enhance the wettability of a surface of a layer. In some cases, roughness may be used to enhance the oleophobicity of an intrinsically oleophobic surface. Those of ordinary skill in the art would be knowledgeable of methods to alter the roughness of the surface of a fiber web.

The filter media described herein may have a variety of suitable arrangements of layers. In some embodiments, a filter media comprises a fine fiber layer as one of its outermost layers. In some embodiments, a filter media comprises a fine fiber layer that is an interior layer (i.e., a layer that is not an outermost layer). Filter media described herein that are incorporated into filter elements may be positioned such that a fine fiber layer is an upstream-most layer, a downstream-most layer, and/or an interior layer. Further information regarding suitable features for fine fiber layers and for supplemental layers is provided below.

In certain embodiments, one or more supplemental layers comprises a gradient in one or more properties (e.g., in diameter of fibers). A filter media comprising two or more layers may display a stepwise change in one or more properties at the interfaces between the layers. One or more properties may change monotonically (e.g., increase monotonically decrease monotonically) across the filter media and/or one or more properties may change in a manner other than monotonically across the filter media. In some embodiments, air permeability, mean flow pore size, and/or penetration may decrease monotonically across the filter media (e.g., from an upstream surface to a downstream surface) and/or decrease from an upstream surface of the filter media to a fine fiber layer therein. In some embodiments, a layer other than an outermost layer may have lower values of air permeability, mean flow pore size, and/or penetration than the other layers in the filter media.

In some instances, one or more supplemental layers is a fine fiber layer and may have any features disclosed herein for the fine fiber layer or for the supplemental layer. In embodiments where multiple fine fiber layers are included, the fine fiber layers may be the same or different.

In some embodiments, the one or more supplemental layers may comprise one or more backer layers. The backer layer(s) may support another layer present in the filter media (e.g., a fine fiber layer) and/or may be a layer onto which another layer was deposited during fabrication of the filter media. For example, in some embodiments, a filter media may comprise a backer layer onto which a fine fiber layer was deposited. The backer layer(s) may provide structural support and/or enhance the ease with which the filter media may be fabricated without appreciably increasing the resistance of the filter media. In some embodiments, the backer layer does not contribute appreciably to the filtration performance of the filter media. In other embodiments, the backer layer(s) may enhance the performance of the filter media in one or more ways (e.g., one or more backer layers may be positioned upstream of other layers and/or may serve as prefilter layers). In some embodiments, a filter media comprises two or more backer layers. For instance, a filter media may comprise two or more backer layers disposed on one another that together form a composite backer layer. In some embodiments, an adhesive may be disposed on the backer layer (e.g., positioned between the backer layer and a fine fiber layer).

In certain embodiments, the backer layer is flame retardant. For example, in some embodiments, the backer layer comprises flame retardant fibers. The flame retardant fibers (e.g., synthetic fibers) may comprise a flame retardant, such as certain phosphorus-based flame retardants, which may have a relatively low concentration of or be substantially free of certain undesirable and/or toxic components (e.g., halogens). In certain embodiments, the backer layer may comprise a blend of fibers (e.g., flame retardant fibers, non-flame retardant fibers). In some embodiments, the backer layer may be designed to have a desirable flame retardancy (e.g., F1 rating, K1 rating).

It should be understood that any individual backer layer (and/or composite backer layer) may independently have some or all of the properties described below with respect to backer layers. It should also be understood that a filter media may comprise two backer layers that are identical and/or may comprise two or more backer layers that differ in one or more ways.

As described above, in some embodiments a filter media comprises one or more supplemental layers other than backer layers. Such supplemental layers are referred to herein as “additional layers”. The additional layer(s) may be provided in addition to a fine fiber layer (e.g., in combination with a backer layer). Non-limiting examples of suitable additional layers include prefilter layers and protective layers. In some embodiments, a filter media comprises an additional layer that is a scrim (e.g., a prefilter layer that is also a scrim, a protective layer that is also a scrim). The additional layer(s) may be attached to another layer in the fiber web (e.g., a fine fiber layer, a backer layer, another additional layer) in a variety of suitable manners, such as with an adhesive, by use of a calender, and/or by ultrasonic bonding.

When present, an additional layer may have a wide variety of properties. In some embodiments, the additional layer does not contribute appreciably to the filtration performance of the filter media. In other embodiments, the additional layer does contribute to one or more properties of the filter media. For instance, the additional layer may serve as a prefilter layer. As another example, a relatively large percentage of the total pressure drop across the filter media may occur across the additional layer. This may be beneficial when one or more other layers in the filter media are relatively fragile and/or may not be able to withstand a large pressure drop.

It should be understood that any individual additional layer may independently have some or all of the properties described below with respect to additional layers. It should also be understood that a filter media may comprise two additional layers that are identical and/or may comprise two or more additional layers that differ in one or more ways.

When present, a supplemental layer (e.g., a backer layer, an additional layer) typically comprises a non-woven fiber web comprising a plurality of fibers. A variety of suitable types of non-woven fiber webs may be employed as supplemental layers in the filter media described herein. For instance, a filter media may comprise a supplemental layer comprising a wetlaid non-woven fiber web, a non-wetlaid non-woven fiber web (such as, e.g., a meltblown non-woven fiber web, an airlaid non-woven fiber web, a carded non-woven fiber web, a spunbond non-woven fiber web), an electrospun non-woven fiber web, a scrim, and/or another type of non-woven fiber web. In some embodiments, a filter media comprises a supplemental layer that is a paste-dot scrim. The paste-dot scrim may comprise a topological pattern (e.g., of dots having a cylindrical cross-section, of dots having a non-cylindrical cross-section) formed from an adhesive. The adhesive may be polymeric (e.g., it may comprise poly(ester)) and/or may have a relatively high glass transition temperature (e.g., of greater than 100° C.).

In embodiments in which more than one supplemental layer is present, each supplemental layer may independently be of one or more of the types described above.

In some embodiments, a supplemental layer (e.g., a backer layer, an additional layer) may be compressed. For instance, a filter media may comprise a supplemental layer that has been calendered, such as a calendered meltblown layer, a calendered carded layer, a calendered spunbond layer, and/or a calendered wetlaid layer. Calendering may involve, for example, compressing one or more layers using calender rolls under a particular linear pressure, temperature, and line speed. For instance, the linear pressure may be between 50 lb/inch and 400 lb/inch (e.g., between 200 lb/inch and 400 lb/inch, between 50 lb/inch and 200 lb/inch, or between 75 lb/inch and 300 lb/inch); the temperature may be between 75° F. and 400° F. (e.g., between 75° F. and 300° F., between 200° F. and 350° F., or between 275° F. and 390° F.); and the line speed may be between 5 ft/min and 100 ft/min (e.g., between 5 ft/min and 80 ft/min, between 10 ft/min and 50 ft/min, between 15 ft/min and 100 ft/min, or between 20 ft/min and 90 ft/min). Other ranges for linear pressure, temperature and line speed are also possible. In embodiments in which more than one supplemental layer is present, each supplemental layer may independently be compressed at a linear pressure, temperature, and/or line speed in one or more of the ranges described above.

When present, a supplemental layer (e.g., a backer layer, an additional layer) may comprise a plurality of fibers comprising a variety of suitable types of fibers. In some embodiments, a supplemental layer comprises a plurality of fibers comprising natural fibers (e.g., hard wood fibers, soft wood fibers, cellulose fibers) and/or regenerated cellulose fibers. For example, cellulose fibers can be hardwood or soft wood fibers. Cellulose fibers can be other than natural cellulose fibers. As an example, the cellulose fibers may comprise regenerated and/or synthetic cellulose such as rayon, lyocell, and celluloid. As another example, the cellulose fibers comprise natural cellulose derivatives, such as cellulose acetate and carboxymethylcellulose. The cellulose fibers, when present, may comprise fibrillated cellulose fibers, and/or may comprise un-fibrillated cellulose fibers.

In some embodiments, a supplemental layer comprises a plurality of fibers comprising synthetic fibers and/or is made up of synthetic fibers (in other words, it may be a synthetic layer). The synthetic fibers, if present, may include monocomponent synthetic fibers and/or multicomponent synthetic fibers (e.g., bicomponent synthetic fibers). Non-limiting examples of suitable synthetic fibers include fibers comprising one or more of the following materials: poly(olefin)s (e.g., poly(propylene)), poly(ester)s (e.g., poly(butylene terephthalate), poly(ethylene terephthalate)), Nylons, poly(aramid)s (para and/or meta), poly(vinyl alcohol), poly(ether sulfone), poly(acrylic)s (e.g., poly(acrylonitrile)), fluorinated polymers (e.g., poly(vinylidene difluoride)), cellulose acetate, acrylics (dry-spun acrylic, mod-acrylic, wet-spun acrylic), polyvinyl chloride, polytetrafluoroethylene, polystyrene, polysulfone, polycarbonate, polyamide, polyurethane, phenolic, polyvinylidene fluoride, polyethylene, polyimide, Kevlar, Nomex, halogenated polymers, polyphenylene oxide, polyphenylene sulfide, polymethyl pentene, polyether ether ketones, PET, liquid crystal polymers (e.g., poly p-phenylene-2,6-bezobisoxazole (PBO), polyester-based liquid crystal polymers such as polyesters produced by the polycondensation of 4-hydroxybenzoic acid and 6-hydroxynaphthalene-2-carboxylic acid), and combinations thereof.

The synthetic fibers, if present, may include binder fibers. The binder fibers, if present, may include monocomponent binder fibers and/or multicomponent binder fibers (e.g., bicomponent binder fibers). Non-limiting examples of suitable materials that may be included in binder fibers include poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide)s and co-poly(amides) such as nylons and aramids; halogenated polymers such as poly(tetrafluoroethylene); epoxy; phenolic resins; and melamine. Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

In some embodiments, a supplemental layer comprises a plurality of fibers comprising glass fibers.

The supplemental layer may include more than one type of fiber (e.g., both glass fibers and synthetic fibers) or may include exclusively one type of fiber (e.g., exclusively synthetic fibers of multiple sub-types, such as both fibers comprising a poly(olefin) and fibers comprising a poly(ester); or exclusively fibers comprising poly(propylene)). In some embodiments, the plurality of fibers in the supplemental layer comprises fibers comprising a blend of two or more of the polymers listed above (e.g., a blend of a Nylon and a poly(ester)).

In embodiments in which more than one supplemental layer is present, each supplemental layer may independently comprise fibers comprising one or more of the types of fibers described above.

When a supplemental layer (e.g., a backer layer, an additional layer) comprises a plurality of fibers comprising cellulose fibers, the supplemental layer may have any suitable amount of cellulose fibers. For example, in some embodiments, the cellulose fibers are present in the supplemental layer in an amount greater than or equal to 0 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % versus the total weight of the supplemental layer. In some embodiments, the cellulose fibers are present in the supplemental layer in an amount less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, or less than or equal to 1 wt % versus the total weight of the supplemental layer. Combinations of the above-referenced ranges are also possible (e.g., greater than or equal to 0 wt % and less than or equal to 100 wt %, greater than or equal to 1 wt % and less than or equal to 50 wt %, greater than or equal to 1 wt % and less than or equal to 20 wt %, greater than or equal to 10 wt % and less than or equal to 30 wt %). Other ranges are also possible. In some embodiments, cellulose fibers may be present in the supplemental layer in an amount of 100 wt % versus the total weight of the supplemental layer and/or versus the total weight of the fibers in the supplemental layer.

When a supplemental layer (e.g., a backer layer, an additional layer) comprises a plurality of fibers comprising synthetic fibers (e.g., binder fibers), the supplemental layer may have any suitable amount of synthetic fibers. For example, in some embodiments, the synthetic fibers (e.g., binder fibers) are present in the supplemental layer in an amount greater than or equal to 0 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % versus the total weight of the supplemental layer. In some embodiments, the synthetic fibers (e.g., binder fibers) are present in the supplemental layer in an amount less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, or less than or equal to 1 wt % versus the total weight of the supplemental layer. Combinations of the above-referenced ranges are also possible (e.g., greater than or equal to 0 wt % and less than or equal to 100 wt %, greater than or equal to 1 wt % and less than or equal to 100 wt %, greater than or equal to 1 wt % and less than or equal to 50 wt %, greater than or equal to 10 wt % and less than or equal to 30 wt %, greater than or equal to 30 wt % and less than or equal to 80 wt %, greater than or equal to 80 wt % and less than or equal to 100 wt %, greater than or equal to 1 wt % and less than or equal to 20 wt %, or greater than or equal to 1 wt % and less than or equal to 10 wt %). Other ranges are also possible. In some embodiments, synthetic fibers may be present in the supplemental layer in an amount of 100 wt % versus the total weight of the supplemental layer and/or versus the total weight of the fibers in the supplemental layer.

When a supplemental layer (e.g., a backer layer, an additional layer) comprises a plurality of fibers comprising glass fibers, the supplemental layer may have any suitable amount of glass fibers. For example, in some embodiments, the glass fibers are present in the supplemental layer in an amount greater than or equal to 0 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % versus the total weight of the supplemental layer. In some embodiments, the glass fibers are present in the supplemental layer in an amount less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, or less than or equal to 1 wt % versus the total weight of the supplemental layer. Combinations of the above-referenced ranges are also possible (e.g., greater than or equal to 0 wt % and less than or equal to 100 wt %, greater than or equal to 1 wt % and less than or equal to 100 wt %, greater than or equal to 1 wt % and less than or equal to 50 wt %, greater than or equal to 1 wt % and less than or equal to 20 wt %, greater than or equal to 10 wt % and less than or equal to 30 wt %). Other ranges are also possible. In some embodiments, glass fibers may be present in the supplemental layer in an amount of 100 wt % versus the total weight of the supplemental layer and/or versus the total weight of the fibers in the supplemental layer.

When present, a supplemental layer (e.g., a backer layer, an additional layer) may have any suitable average fiber diameter, regardless of the types of fibers present. For example, in some embodiments, the supplemental layer has an average fiber diameter of greater than or equal to 0.01 microns, greater than or equal to 0.05 microns, greater than or equal to 0.075 microns, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, the supplemental layer has an average fiber diameter of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 micron, or less than or equal to 0.075 microns. Combinations of the above-referenced ranges are also possible (e.g., greater than or equal to 0.01 microns and less than or equal to 100 microns, greater than or equal to 0.1 microns and less than or equal to 75 microns, or greater than or equal to 0.5 microns and less than or equal to 25 microns). Other ranges are also possible. The average diameter may be determined by scanning electron microscopy.

When a supplemental layer (e.g., a backer layer, an additional layer) comprises a plurality of fibers comprising cellulose fibers, the cellulose fibers therein may have any suitable average diameter. In some embodiments, a supplemental layer comprises cellulose fibers having an average diameter of greater than or equal to 0.1 microns, greater than or equal to 0.5 microns, greater than or equal to 1 micron, greater than or equal to 3 microns, greater than or equal to 5 microns, greater than or equal to 7 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a supplemental layer comprises cellulose fibers having an average diameters of less than or equal to 75 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, or less than or equal to 7 microns. Combinations of the above-referenced ranges are also possible (e.g., greater than or equal to 0.1 microns and less than or equal to 75 microns, greater than or equal to 5 microns and less than or equal to 50 microns, greater than or equal to 7 microns and less than or equal to 30 microns, or greater than or equal to 10 microns and less than or equal to 20 microns). Other ranges are also possible. The average diameter may be determined by scanning electron microscopy.

In embodiments in which a filter media comprises two or more supplemental layers comprising cellulose fibers, each supplemental layer comprising cellulose fibers may independently comprise cellulose fibers having an average diameter in one or more of the ranges described above.

When a supplemental layer (e.g., a backer layer, an additional layer) comprises a plurality of fibers comprising synthetic fibers, the synthetic fibers (e.g., binder fibers) therein may have a variety of average diameters. In some embodiments, a supplemental layer comprises synthetic fibers (e.g., binder fibers) having an average diameter of greater than or equal to 0.01 microns, greater than or equal to 0.05 microns, greater than or equal to 0.075 microns, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a supplemental layer comprises synthetic fibers (e.g., binder fibers) having an average diameters of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 micron, or less than or equal to 0.075 microns. Combinations of the above-referenced ranges are also possible (e.g., greater than or equal to 0.01 microns and less than or equal to 100 microns, greater than or equal to 0.01 microns and less than or equal to 50 microns, greater than or equal to 0.1 microns and less than or equal to 20 microns, greater than or equal to 1 micron and less than or equal to 20 microns, greater than or equal to 10 microns and less than or equal to 60 microns, greater than or equal to 17 microns and less than or equal to 35 microns, greater than or equal to 0.05 microns and less than or equal to 50 microns, greater than or equal to 0.05 microns and less than or equal to 30 microns, greater than or equal to 0.05 microns and less than or equal to 5 microns, greater than or equal to 0.05 microns and less than or equal to 2 microns, greater than or equal to 0.075 microns and less than or equal to 0.5 microns, greater than or equal to 0.15 microns and less than or equal to 3 microns, greater than or equal to 0.25 microns and less than or equal to 3 microns, or greater than or equal to 0.25 microns and less than or equal to 2 microns). Other ranges are also possible. The average diameter may be determined by scanning electron microscopy.

In embodiments in which more than one supplemental layer comprising synthetic fibers is present, each supplemental layer comprising synthetic fibers may independently comprise synthetic fibers having an average fiber diameter in one or more of the ranges described above.

When a supplemental layer (e.g., a backer layer, an additional layer) comprises a plurality of fibers comprising glass fibers, the glass fibers therein may have a variety of average diameters. In some embodiments, a supplemental layer comprises glass fibers having an average diameters of greater than or equal to 0.1 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, or greater than or equal to 12.5 microns. In some embodiments, a supplemental layer comprises glass fibers having an average diameter of less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, or less than or equal to 0.2 microns. Combinations of the above-referenced ranges are also possible (e.g., greater than or equal to 0.1 microns and less than or equal to 40 microns, greater than or equal to 0.4 microns and less than or equal to 20 microns, greater than or equal to 0.15 microns and less than or equal to 15 microns, greater than or equal to 0.15 microns and less than or equal to 3 microns, greater than or equal to 0.25 microns and less than or equal to 3 microns, or greater than or equal to 0.25 microns and less than or equal to 2 microns). Other ranges are also possible. The average diameter may be determined by scanning electron microscopy.

In embodiments in which more than one supplemental layer comprising glass fibers is present, each supplemental layer comprising glass fibers may independently comprise glass fibers having an average fiber diameter in one or more of the ranges described above.

The fibers in a plurality of fibers in a supplemental layer (e.g., a backer layer, an additional layer), if present, may have a variety of suitable average lengths. In some embodiments, the average length of the fibers in a supplemental layer is greater than or equal to 0.01 mm, greater than or equal to 0.1 mm, greater than or equal to 0.2 mm, greater than or equal to 0.3 mm, greater than or equal to 0.4 mm, greater than or equal to 0.5 mm, greater than or equal to 0.75 mm, greater than or equal to 1 mm, greater than or equal to 1.25 mm, greater than or equal to 1.5 mm, greater than or equal to 2 mm, greater than or equal to 3 mm, greater than or equal to 4 mm, greater than or equal to 5 mm, greater than or equal to 6 mm, greater than or equal to 7.5 mm, greater than or equal to 10 mm, greater than or equal to 12.5 mm, greater than or equal to 15 mm, greater than or equal to 20 mm, greater than or equal to 25 mm, greater than or equal to 30 mm, greater than or equal to 40 mm, greater than or equal to 50 mm, or greater than or equal to 75 mm. In some embodiments, the average length of the fibers in a supplemental layer is less than or equal to 300 mm, less than or equal to 250 mm, less than or equal to 200 mm, less than or equal to 150 mm, less than or equal to 100 mm, less than or equal to 75 mm, less than or equal to 50 mm, less than or equal to 40 mm, less than or equal to 30 mm, less than or equal to 25 mm, less than or equal to 20 mm, less than or equal to 15 mm, less than or equal to 12.5 mm, less than or equal to 12 mm, less than or equal to 10 mm, less than or equal to 7.5 mm, less than or equal to 5 mm, less than or equal to 4 mm, less than or equal to 3 mm, less than or equal to 2.5 mm, less than or equal to 2 mm, less than or equal to 1.5 mm, less than or equal to 1.25 mm, less than or equal to 1 mm, less than or equal to 0.75 mm, less than or equal to 0.5 mm, or less than or equal to 0.4 mm. Combinations of the above-referenced ranges are also possible (e.g., greater than or equal to 0.01 mm and less than or equal to 300 mm, greater than or equal to 0.1 mm and less than or equal to 300 mm, greater than or equal to 0.1 mm and less than or equal to 25 mm, greater than or equal to 0.1 mm and less than or equal to 12 mm, greater than or equal to 0.3 mm and less than 100 mm, greater than or equal to 1 mm and less than or equal to 70 mm, greater than or equal to 1 mm and less than or equal to 10 mm, greater than or equal to 3 mm and less than or equal to 300 mm, greater than or equal to 6 mm and less than or equal to 100 mm, or greater than or equal to 1 mm and less than or equal to 50 mm). Other ranges are also possible.

In embodiments in which more than one supplemental layer is present, each supplemental layer may independently comprise fibers having an average length in one or more of the ranges described above.

In some embodiments, a supplemental layer (e.g., a backer layer, an additional layer) comprises continuous fibers, which may have a variety of suitable lengths. For instance, the average length of the fibers in a supplemental layer may be greater than or equal to 100 mm, greater than or equal to 125 mm, greater than or equal to 150 mm, greater than or equal to 200 mm, greater than or equal to 250 mm, greater than or equal to 300 mm, greater than or equal to 400 mm, greater than or equal to 500 mm, greater than or equal to 750 mm, greater than or equal to 1 m, greater than or equal to 1.25 m, greater than or equal to 1.5 m, greater than or equal to 2 m, greater than or equal to 2.5 m, greater than or equal to 3 m, greater than or equal to 4 m, greater than or equal to 5 m, greater than or equal to 7.5 m, greater than or equal to 10 m, greater than or equal to 12.5 m, greater than or equal to 15 m, greater than or equal to 20 m, greater than or equal to 25 m, greater than or equal to 30 m, greater than or equal to 40 m, greater than or equal to 50 m, greater than or equal to 75 m, greater than or equal to 100 m, greater than or equal to 125 m, greater than or equal to 150 m, greater than or equal to 200 m, greater than or equal to 250 m, greater than or equal to 300 m, greater than or equal to 400 m, greater than or equal to 500 m, or greater than or equal to 750 m. In some embodiments, the average length of the fibers in a supplemental layer is less than or equal to 1 km, less than or equal to 750 m, less than or equal to 500 m, less than or equal to 400 m, less than or equal to 300 m, less than or equal to 250 m, less than or equal to 200 m, less than or equal to 150 m, less than or equal to 125 m, less than or equal to 100 m, less than or equal to 75 m, less than or equal to 50 m, less than or equal to 40 m, less than or equal to 30 m, less than or equal to 25 m, less than or equal to 20 m, less than or equal to 15 m, less than or equal to 12.5 m, less than or equal to 10 m, less than or equal to 7.5 m, less than or equal to 5 m, less than or equal to 4 m, less than or equal to 3 m, less than or equal to 2.5 m, less than or equal to 2 m, less than or equal to 1.5 m, less than or equal to 1.25 m, less than or equal to 1 m, less than or equal to 750 mm, less than or equal to 500 mm, less than or equal to 400 mm, less than or equal to 300 mm, less than or equal to 250 mm, less than or equal to 200 mm, less than or equal to 150 mm, or less than or equal to 125 mm. Combinations of the above-referenced ranges are also possible (e.g., greater than or equal to 100 mm and less than or equal to 1 km, greater than or equal to 125 mm and less than or equal to 25 m, greater than or equal to 125 mm and less than or equal to 2 m). Other ranges are also possible.

In embodiments in which more than one supplemental layer is present, each supplemental layer may independently comprise fibers having an average length in one or more of the ranges described above.

Some supplemental layers (e.g., backer layers, additional layers) include components other than fibers. For instance, a supplemental layer may comprise a binder resin. The binder resin may make up less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1.25 wt %, less than or equal to 1 wt %, less than or equal to 0.75 wt %, less than or equal to 0.5 wt %, less than or equal to 0.4 wt %, less than or equal to 0.3 wt %, less than or equal to 0.25 wt %, less than or equal to 0.2 wt %, less than or equal to 0.15 wt %, less than or equal to 0.125 wt %, or less than or equal to 0.1 wt % of the supplemental layer. The binder resin may make up greater than or equal to 0 wt %, greater than or equal to 0.1 wt %, greater than or equal to 0.125 wt %, greater than or equal to 0.15 wt %, greater than or equal to 0.2 wt %, greater than or equal to 0.25 wt %, greater than or equal to 0.3 wt %, greater than or equal to 0.4 wt %, greater than or equal to 0.5 wt %, greater than or equal to 0.75 wt %, greater than or equal to 1 wt %, greater than or equal to 1.25 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, or greater than or equal to 25 wt % of the supplemental layer. Combinations of the above-referenced ranges are also possible (e.g., greater than or equal to 0 wt % and less than or equal to 90 wt %, less than or equal to 30 wt % of the supplemental layer, or greater than or equal to 10 wt % and less than or equal to 30 wt %). Other ranges are also possible. In some embodiments, the supplemental layer is binder resin-free (i.e., binder resin makes up 0 wt % of the supplemental layer).

In embodiments in which more than one supplemental layer is present, each supplemental layer may independently comprise a binder resin in an amount in one or more of the ranges described above.

In some embodiments, the binder resin comprises a polymer. Non-limiting examples of suitable polymers for use with a binder resin include thermoplastic polymers (e.g., acrylics, poly(vinylacetate), poly(ester)s, poly(amide)s), thermosetting polymers (e.g., epoxy, phenolic resin, melamine), a vinyl acetate resin, an epoxy resin, a poly(ester) resin, a copoly(ester) resin, a poly(vinyl alcohol) resin, an acrylic resin (e.g., a styrene acrylic resin), styrene acrylate, styrene butyl acrylate, styrene butadiene, poly(methyl methacrylate), a copolymer of styrene and methyl methacrylate, a phenolic resin, acrylonitrile rubber, poly(ethylene), and poly(urethane), or combinations thereof.

When a supplemental layer (e.g., a backer layer, an additional layer) comprises a plurality of fibers comprising cellulose fibers, the cellulose fibers therein may have any suitable level of fibrillation (i.e., the extent of branching in the fiber). The level of fibrillation may be measured according to any number of suitable methods. For example, the level of fibrillation of the fibrillated fibers can be measured according to a Canadian Standard Freeness (CSF) test, specified by TAPPI test method T 227 om 09 Freeness of pulp. The test can provide an average CSF value.

In certain embodiments, the average CSF value of the cellulose fibers/regenerated cellulose fibers, when present, may be greater than or equal to 0.1 mL, greater than or equal to 0.5 mL, greater than or equal to 1 mL, greater than or equal to 10 mL, greater than or equal to 20 mL, greater than or equal to 35 mL, greater than or equal to 45 mL, greater than or equal to 50 mL, greater than or equal to 65 mL, greater than or equal to 70 mL, greater than or equal to 75 mL, greater than or equal to 80 mL, greater than or equal to 100 mL, greater than or equal to 110 mL, greater than or equal to 120 mL, greater than or equal to 130 mL, greater than or equal to 140 mL, greater than or equal to 150 mL, greater than or equal to 175 mL, greater than or equal to 200 mL, greater than or equal to 250 mL, greater than or equal to 300 mL, greater than or equal to 350 mL, greater than or equal to 400 mL, greater than or equal to 500 mL, greater than or equal to 600 mL, greater than or equal to 650 mL, greater than or equal to 700 mL, or greater than or equal to 750 mL. In some embodiments, the average CSF value of the cellulose fibers may be less than or equal to 800 mL, less than or equal to 750 mL, less than or equal to 700 mL, less than or equal to 650 mL, less than or equal to 600 mL, less than or equal to 550 mL, less than or equal to 500 mL, less than or equal to 450 mL, less than or equal to 400 mL, less than or equal to 350 mL, less than or equal to 300 mL, less than or equal to 250 mL, less than or equal to 225 mL, less than or equal to 200 mL, less than or equal to 150 mL, less than or equal to 140 mL, less than or equal to 130 mL, less than or equal to 120 mL, less than or equal to 110 mL, less than or equal to 100 mL, less than or equal to 90 mL, less than or equal to 85 mL, less than or equal to 70 mL, less than or equal to 50 mL, less than or equal to 40 mL, or less than or equal to 25 mL. Combinations of the above-referenced lower limits and upper limits are also possible (e.g., greater than or equal to 45 mL and less than or equal to 800 mL, greater than or equal to 120 mL and less than or equal to 500 mL, or greater than or equal to 0.1 mL and less than or equal to 800 mL). It should be understood that, in certain embodiments, the fibers may have fibrillation levels outside the above-noted ranges. The average CSF value of the cellulose fibers used in the layer(s) may be based on one type of cellulose fiber or more than one type cellulose fiber.

The thickness of the supplemental layer (e.g., backer layer, additional layer) may be selected as desired. For instance, in some embodiments, the supplemental layer may have a thickness of greater than or equal to 10 nm, greater than or equal to 20 nm, greater than or equal to 30 nm, greater than or equal to 40 nm, greater than or equal to 50 nm, greater than or equal to 100 nm, greater than or equal to 500 nm, greater than or equal to 1 micron, greater than or equal to 0.02 mm, greater than or equal to 0.05 mm, greater than or equal to 0.1 mm, greater than or equal to 0.2 mm, greater than or equal to 0.4 mm, greater than or equal to 0.5 mm, greater than or equal to 0.8 mm, greater than or equal to 1.0 mm, greater than or equal to 2.0 mm, greater than or equal to 3.0 mm, or greater than or equal to 4.0 mm. In some instances, the supplemental layer may have a thickness of less than or equal to 10 mm, less than or equal to 9 mm, less than or equal to 8 mm, less than or equal to 7 mm, less than or equal to 6 mm, less than or equal to 5 mm, less than or equal to 3 mm, less than or equal to 2 mm, less than or equal to 1.2 mm, less than or equal to 1, less than or equal to 0.8 mm, less than or equal to 0.5 mm, less than or equal to 0.4 mm, or less than or equal to 0.2 mm. Combinations of the above-referenced ranges are also possible (e.g., a thickness of greater than or equal to 10 nm and less than or equal to 10 mm, greater than or equal to 0.02 mm and less than or equal to 10 mm, greater than or equal to 0.05 mm and less than or equal to 5 mm, greater than or equal to 0.1 mm and less than or equal to 5 mm, greater than or equal to 0.1 mm and less than or equal to 3 mm, or a thickness of greater than or equal to 0.1 mm and less than or equal to 1 mm). Other values of thickness are also possible. As determined herein, the thickness is measured according to the standard ISO 534 (2011) at 2 N/cm². In embodiments where the supplemental layer is a fine fiber layer, the thickness may be determined using Scanning Electron Microscopy (SEM) to image a cross-section of the fine fiber layer.

When present, a supplemental layer (e.g., a backer layer, an additional layer) may have a variety of suitable solidities. In some embodiments, a supplemental layer has a solidity of greater than or equal to 0.001%, greater than or equal to 0.01%, greater than or equal to 0.1%, greater than or equal to 1%, greater than or equal to 2%, greater than or equal to 3%, greater than or equal to 4%, greater than or equal to 5%, greater than or equal to 7.5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 60%, greater than or equal to 70%, or greater than or equal to 80%. In some embodiments, a supplemental layer has a solidity of less than or equal to 90%, less than or equal to 80%, less than or equal to 70%, less than or equal to 60%, less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 7.5%, or less than or equal to 5%. Combinations of the above-referenced ranges are also possible (e.g., greater than or equal to 0.001% and less than or equal to 50%, greater than or equal to 0.01% and less than or equal to 25%, greater than or equal to 4% and less than or equal to 90%, greater than or equal to 4% and less than or equal to 50%, greater than or equal to 5% and less than or equal to 40%, or greater than or equal to 5% and less than or equal to 35%). Other ranges are also possible. Solidity may be measured as described elsewhere herein. In embodiments in which more than one supplemental layer is present, each supplemental layer may independently have a solidity in one or more of the ranges described above.

When present, a supplemental layer (e.g., a backer layer, an additional layer) may have a variety of suitable basis weights. In some embodiments, a supplemental layer has a basis weight of greater than or equal to 0.001 gsm, greater than or equal to 0.01 gsm, greater than or equal to 0.1 gsm, greater than or equal to 1 gsm, greater than or equal to 2 gsm, greater than or equal to 5 gsm, greater than or equal to 7.5 gsm, greater than or equal to 10 gsm, greater than or equal to 12.5 gsm, greater than or equal to 15 gsm, greater than or equal to 17.5 gsm, greater than or equal to 20 gsm, greater than or equal to 25 gsm, greater than or equal to 30 gsm, greater than or equal to 40 gsm, greater than or equal to 50 gsm, greater than or equal to 75 gsm, greater than or equal to 100 gsm, greater than or equal to 150 gsm, greater than or equal to 200 gsm, greater than or equal to 250 gsm, greater than or equal to 300 gsm, or greater than or equal to 400 gsm. In some embodiments, a supplemental layer has a basis weight of less than or equal to 1000 gsm, less than or equal to 900 gsm, less than or equal to 800 gsm, less than or equal to 700 gsm, less than or equal to 600 gsm, less than or equal to 500 gsm, less than or equal to 400 gsm, less than or equal to 300 gsm, less than or equal to 250 gsm, less than or equal to 200 gsm, less than or equal to 150 gsm, less than or equal to 120 gsm, less than or equal to 100 gsm, less than or equal to 75 gsm, less than or equal to 50 gsm, less than or equal to 40 gsm, less than or equal to 30 gsm, less than or equal to 25 gsm, less than or equal to 20 gsm, less than or equal to 17.5 gsm, less than or equal to 15 gsm, less than or equal to 12.5 gsm, less than or equal to 10 gsm, or less than or equal to 7.5 gsm. Combinations of the above-referenced ranges are also possible (e.g., greater than or equal to 0.001 gsm and less than or equal to 1000 gsm, greater than or equal to 2 gsm and less than or equal to 1000 gsm, greater than or equal to 5 gsm and less than or equal to 500 gsm, greater than or equal to 10 gsm and less than or equal to 300 gsm, greater than or equal to 15 gsm and less than or equal to 500 gsm, greater than or equal to 20 gsm and less than or equal to 300 gsm, greater than or equal to 20 gsm and less than or equal to 120 gsm, or greater than or equal to 30 gsm and less than or equal to 200 gsm). Other ranges of basis weight are also possible. The basis weight of a supplemental layer may be determined in accordance with ISO 536:2012.

In embodiments in which more than one supplemental layer is present, each supplemental layer may independently have a basis weight in one or more of the ranges described above.

When present, a supplemental layer (e.g., a backer layer, an additional layer) may have a variety of suitable values of elongation at break. In some embodiments, a supplemental layer (and/or an overall filter media) has an elongation at break of greater than or equal to 1%, greater than or equal to 2%, greater than or equal to 5%, greater than or equal to 7.5%, greater than or equal to 10%, greater than or equal to 15%, greater than or equal to 20%, greater than or equal to 25%, greater than or equal to 30%, or greater than or equal to 40%. In some embodiments, a supplemental layer (and/or an overall filter media) has an elongation at break of less than or equal to 50%, less than or equal to 40%, less than or equal to 30%, less than or equal to 25%, less than or equal to 20%, less than or equal to 15%, less than or equal to 10%, less than or equal to 7.5%, less than or equal to 5%, or less than or equal to 2%. Combinations of the above-referenced ranges are also possible (e.g., greater than or equal to 1% and less than or equal to 50%, greater than or equal to 1% and less than or equal to 10%, greater than or equal to 2% and less than or equal to 10%, or greater than or equal to 5% and less than or equal to 25%). Other ranges are also possible. The elongation at break of a supplemental layer (and/or an overall filter media) may be determined in accordance with T494 om-96 using a test span of 5 inches and a jaw separation speed of 12 in/min.

It should be understood that when there are two or more supplemental layers, each supplemental layer may independently have an elongation at break in one or more of the ranges described above.

When present, a supplemental layer (e.g., a backer layer, an additional layer) may have a variety of suitable specific surface areas. In some embodiments, a supplemental layer has a specific surface area of greater than or equal to 0.1 m²/g, greater than or equal to 0.2 m²/g, greater than or equal to 0.5 m²/g, greater than or equal to 1 m²/g, greater than or equal to 2 m²/g, greater than or equal to 5 m²/g, greater than or equal to 10 m²/g, greater than or equal to 15 m²/g, greater than or equal to 20 m²/g, greater than or equal to 25 m²/g, greater than or equal to 30 m²/g, greater than or equal to 35 m²/g, greater than or equal to 40 m²/g, or greater than or equal to 45 m²/g. In some embodiments, a supplemental layer has a specific surface area of less than or equal to 50 m²/g, less than or equal to 45 m²/g, less than or equal to 40 m²/g, less than or equal to 35 m²/g, less than or equal to 30 m²/g, less than or equal to 25 m²/g, less than or equal to 20 m²/g, less than or equal to 15 m²/g, less than or equal to 10 m²/g, less than or equal to 5 m²/g, less than or equal to 2 m²/g, less than or equal to 1 m²/g, less than or equal to 0.5 m²/g, less than or equal to 0.2 m²/g, or less than or equal to 0.1 m²/g. Combinations of the above-referenced ranges are also possible (e.g., greater than 0 m²/g and less than or equal to 50 m²/g, greater than 0 m²/g and less than or equal to 40 m²/g, or greater than 0 m²/g and less than or equal to 35 m²/g). Other ranges are also possible. The specific surface area may be determined in accordance with section 10 of Battery Council International Standard BCIS-03A (2009), “Recommended Battery Materials Specifications Valve Regulated Recombinant Batteries”, section 10 being “Standard Test Method for Surface Area of Recombinant Battery Separator Mat”. Following this technique, the specific surface area is measured via adsorption analysis using a BET surface analyzer (e.g., Micromeritics Gemini III 2375 Surface Area Analyzer) with nitrogen gas; the sample amount is between 0.5 and 0.6 grams in a ¾″ tube; and, the sample is allowed to degas at 100° C. for a minimum of 3 hours.

In embodiments in which more than one supplemental layer is present, each supplemental layer may independently have a specific surface area in one or more of the ranges described above.

When present, a supplemental layer (e.g., a backer layer, an additional layer) may have a variety of suitable mean flow pore sizes. In some embodiments, a supplemental layer has a mean flow pore size of greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 75 microns, greater than or equal to 100 microns, greater than or equal to 125 microns, greater than or equal to 150 microns, or greater than or equal to 200 microns. In some embodiments, a supplemental layer has a mean flow pore size of less than or equal to 300 microns, less than or equal to 250 microns, less than or equal to 200 microns, less than or equal to 150 microns, less than or equal to 125 microns, less than or equal to 100 microns, less than or equal to 75 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.2 microns, less than or equal to 0.15 microns, or less than or equal to 0.125 microns. Combinations of the above-referenced ranges are also possible (e.g., greater than or equal to 0.1 micron and less than or equal to 300 microns, greater than or equal to 0.1 micron and less than or equal to 250 microns, greater than or equal to 1 micron and less than or equal to 100 microns, greater than or equal to 0.1 micron and less than or equal to 50 microns, greater than or equal to 0.2 microns and less than or equal to 35 microns, or greater than or equal to 0.2 microns and less than or equal to 30 microns). Other ranges are also possible. The mean flow pore size of a supplemental layer may be determined in accordance with ASTM F316 (2003).

In embodiments in which more than one supplemental layer is present, each supplemental layer may independently have a mean flow pore size in one or more of the ranges described above.

When present, a supplemental layer (e.g., a backer layer, an additional layer) may have a variety of suitable maximum pore sizes. In some embodiments, a supplemental layer has a maximum pore size of greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 75 microns, greater than or equal to 100 microns, greater than or equal to 125 microns, greater than or equal to 150 microns, greater than or equal to 200 microns, greater than or equal to 250 microns, greater than or equal to 300 microns, greater than or equal to 400 microns, or greater than or equal to 500 microns. In some embodiments, a supplemental layer has a maximum pore size of less than or equal to 750 microns, less than or equal to 500 microns, less than or equal to 400 microns, less than or equal to 300 microns, less than or equal to 250 microns, less than or equal to 200 microns, less than or equal to 150 microns, less than or equal to 125 microns, less than or equal to 100 microns, less than or equal to 75 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, or less than or equal to 0.25 microns. Combinations of the above-referenced ranges are also possible (e.g., greater than or equal to 0.2 microns and less than or equal to 750 microns, greater than or equal to 0.2 microns and less than or equal to 50 microns, greater than or equal to 0.2 microns and less than or equal to 40 microns, or greater than or equal to 0.3 microns and less than or equal to 30 microns). Other ranges are also possible. The maximum pore size may be determined in accordance with ASTM F316 (2003).

In embodiments in which more than one supplemental layer is present, each supplemental layer may independently have a maximum pore size in one or more of the ranges described above.

When present, a supplemental layer (e.g., a backer layer, an additional layer) may have a variety of suitable ratios of maximum pore size to mean flow pore size. In some embodiments, a supplemental layer (and/or an overall filter media) has a ratio of maximum pore size to mean flow pore size of greater than or equal to 1.1, greater than or equal to 1.2, greater than or equal to 1.3, greater than or equal to 1.5, greater than or equal to 1.75, greater than or equal to 2, greater than or equal to 2.5, greater than or equal to 3, greater than or equal to 4, greater than or equal to 5, greater than or equal to 7.5, greater than or equal to 10, greater than or equal to 12.5, greater than or equal to 15, greater than or equal to 20, or greater than or equal to 25. In some embodiments, a supplemental layer (and/or an overall filter media) has a ratio of maximum pore size to mean flow pore size of less than or equal to 30, less than or equal to 25, less than or equal to 20, less than or equal to 15, less than or equal to 12.5, less than or equal to 10, less than or equal to 7.5, less than or equal to 5, less than or equal to 4, less than or equal to 3, less than or equal to 2.5, less than or equal to 2, less than or equal to 1.75, or less than or equal to 1.5. Combinations of the above-referenced ranges are also possible (e.g., greater than or equal to 1.1 and less than or equal to 30, greater than or equal to 1.3 and less than or equal to 30, greater than or equal to 1.3 and less than or equal to 25, or greater than or equal to 1.3 and less than or equal to 20). Other ranges are also possible. The ratio of maximum pore size to mean flow pore size may be determined by finding the maximum pore size and mean flow pore size in accordance with ASTM F316 (2003) and then dividing the maximum pore size by the mean flow pore size.

In embodiments in which more than one supplemental layer is present, each supplemental layer may independently have a ratio of maximum pore size to mean flow pore size in one or more of the ranges described above.

When present, a supplemental layer (e.g., a backer layer, an additional layer) may have a variety of suitable air permeabilities. In some embodiments, a supplemental layer has an air permeability of greater than or equal to 0.5 CFM, greater than or equal to 0.75 CFM, greater than or equal to 1 CFM, greater than or equal to 1.25 CFM, greater than or equal to 1.5 CFM, greater than or equal to 2 CFM, greater than or equal to 2.5 CFM, greater than or equal to 3 CFM, greater than or equal to 4 CFM, greater than or equal to 5 CFM, greater than or equal to 7.5 CFM, greater than or equal to 8 CFM, greater than or equal to 10 CFM, greater than or equal to 12.5 CFM, greater than or equal to 15 CFM, greater than or equal to 20 CFM, greater than or equal to 25 CFM, greater than or equal to 30 CFM, greater than or equal to 40 CFM, greater than or equal to 50 CFM, greater than or equal to 75 CFM, greater than or equal to 100 CFM, greater than or equal to 125 CFM, greater than or equal to 150 CFM, greater than or equal to 200 CFM, greater than or equal to 250 CFM, greater than or equal to 300 CFM, greater than or equal to 400 CFM, greater than or equal to 500 CFM, greater than or equal to 750 CFM, greater than or equal to 1000 CFM, greater than or equal to 1250 CFM, greater than or equal to 1500 CFM, greater than or equal to 2000 CFM, greater than or equal to 2500 CFM, greater than or equal to 3000 CFM, or greater than or equal to 5000 CFM. In some embodiments, a supplemental layer has an air permeability of less than or equal to 8000 CFM, less than or equal to 5000 CFM, less than or equal to 3000 CFM, less than or equal to 2500 CFM, less than or equal to 2000 CFM, less than or equal to 1500 CFM, less than or equal to 1400 CFM, less than or equal to 1250 CFM, less than or equal to 1000 CFM, less than or equal to 750 CFM, less than or equal to 500 CFM, less than or equal to 400 CFM, less than or equal to 300 CFM, less than or equal to 250 CFM, less than or equal to 200 CFM, less than or equal to 150 CFM, less than or equal to 125 CFM, less than or equal to 100 CFM, less than or equal to 75 CFM, less than or equal to 50 CFM, less than or equal to 40 CFM, less than or equal to 30 CFM, less than or equal to 25 CFM, less than or equal to 20 CFM, less than or equal to 15 CFM, less than or equal to 12.5 CFM, less than or equal to 10 CFM, less than or equal to 7.5 CFM, less than or equal to 5 CFM, less than or equal to 4 CFM, less than or equal to 3 CFM, less than or equal to 2.5 CFM, less than or equal to 2 CFM, less than or equal to 1.5 CFM, less than or equal to 1.25 CFM, less than or equal to 1 CFM, or less than or equal to 0.75 CFM. Combinations of the above-referenced ranges are also possible (e.g., greater than or equal to 0.5 CFM and less than or equal to 8000 CFM, greater than or equal to 0.5 CFM and less than or equal to 2000 CFM, greater than or equal to 1 CFM and less than or equal to 1400 CFM, greater than or equal to 0.5 CFM and less than or equal to 800 CFM, greater than or equal to 1 CFM and less than or equal to 500 CFM, greater than or equal to 0.5 CFM and less than or equal to 400 CFM, greater than or equal to 0.5 CFM and less than or equal to 200 CFM, greater than or equal to 1 CFM and less than or equal to 150 CFM, greater than or equal to 5 CFM and less than or equal to 500 CFM, greater than or equal to 8 CFM and less than or equal to 400 CFM, or greater than or equal to 1 CFM and less than or equal to 100 CFM). Other ranges are also possible. The air permeability may be determined in accordance with ASTM Test Standard D737-04 (2016) at a pressure of 125 Pa.

When present, a supplemental layer (e.g., a backer layer, an additional layer) may have a variety of suitable dry tensile strengths. In some embodiments, the dry tensile strength of the supplemental layer (and/or an overall filter media) is greater than or equal to 1 lb/in, greater than or equal to 2 lb/in, greater than or equal to 5 lb/in, greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 50 lb/in, greater than or equal to 60 lb/in, greater than or equal to 70 lb/in, greater than or equal to 80 lb/in, greater than or equal to 90 lb/in, greater than or equal to 100 lb/in, greater than or equal to 125 lb/in, greater than or equal to 150 lb/in, or greater than or equal to 175 lb/in. In some embodiments, the dry tensile strength of the supplemental layer (and/or an overall filter media) is less than or equal to 200 lb/in, less than or equal to 175 lb/in, less than or equal to 150 lb/in, less than or equal to 125 lb/in, less than or equal to 120 lb/in, less than or equal to 100 lb/in, less than or equal to 90 lb/in, less than or equal to 80 lb/in, less than or equal to 70 lb/in, less than or equal to 60 lb/in, less than or equal to 50 lb/in, less than or equal to 40 lb/in, less than or equal to 35 lb/in, less than or equal to 30 lb/in, less than or equal to 25 lb/in, less than or equal to 20 lb/in, less than or equal to 15 lb/in, less than or equal to 10 lb/in, or less than or equal to 5 lb/in. Combinations of the above-referenced ranges are also possible (e.g., greater than or equal to 1 lb/in and less than or equal to 200 lb/in, or greater than or equal to 50 lb/in and less than or equal to 200 lb/in). Other ranges are also possible. The dry tensile strength may be determined according to the standard T494 om-96 using a test span of 4 in and a jaw separation speed of 1 in/min.

When present, a supplemental layer (e.g., a backer layer, an additional layer) may have a variety of suitable dry Mullen burst strengths. In some embodiments, the supplemental layer (and/or the overall filter media) may have a dry Mullen Burst strength of greater than or equal to 0.5 psi, greater than or equal to 1 psi, greater than or equal to 2 psi, greater than or equal to 5 psi, greater than or equal to 10 psi, greater than or equal to 20 psi, greater than or equal to 25 psi, greater than or equal to 30 psi, greater than or equal to 50 psi, greater than or equal to 75 psi, greater than or equal to 100 psi, greater than or equal to 125 psi, greater than or equal to 150 psi, greater than or equal to 175 psi, greater than or equal to 200 psi, greater than or equal to 225 psi, or greater than or equal to 240 psi. In some instances, the dry Mullen Burst strength of the supplemental layer (and/or an overall filter media) may be less than or equal to 250 psi, less than or equal to 240 psi, less than or equal to 225 psi, less than or equal to 200 psi, less than or equal to 175 psi, less than or equal to 150 psi, less than or equal to 125 psi, less than or equal to 100 psi, less than or equal to 75 psi, less than or equal to 50 psi, less than or equal to 25 psi, less than or equal to 20 psi, less than or equal to 10 psi, less than or equal to 5 psi, less than or equal to 2 psi, less than or equal to 1 psi, less than or equal to 0.5 psi. Combinations of the above-referenced ranges are also possible (e.g., greater than or equal to 0.5 psi and less than or equal to 250 psi, greater than or equal to 30 psi and less than or equal to 150 psi, greater than or equal to 20 psi and less than or equal to 250 psi, or greater than or equal to 25 psi and less than or equal to 150 psi). Other values of dry Mullen Burst strength are also possible. The dry Mullen Burst strength may be determined according to the standard T403 om-91.

When present, a supplemental layer (e.g., a backer layer, an additional layer) may have any suitable Gurley stiffness (e.g., in the cross direction and/or in the machine direction). In some embodiments, the supplemental layer has a Gurley stiffness (e.g., in the cross direction and/or in the machine direction) of greater than or equal to about 1 mg, greater than or equal to about 2 mg, greater than or equal to about 5 mg, greater than or equal to about 10 mg, greater than or equal to about 50 mg, greater than or equal to about 100 mg, greater than or equal to about 200 mg, greater than or equal to about 300 mg, greater than or equal to about 500 mg, greater than or equal to about 800 mg, greater than or equal to about 1,000 mg, greater than or equal to about 1,200 mg, greater than or equal to about 1,400 mg, greater than or equal to 1,500 mg, greater than or equal to 2,000 mg, or greater than or equal to 3,000 mg. In some embodiments, the supplemental layer has a Gurley stiffness (e.g., in the cross direction and/or in the machine direction) of less than or equal to about 3,500 mg, less than or equal to about 3,000 mg, less than or equal to about 2,500 mg, less than or equal to about 2,000 mg, less than or equal to about 1,500 mg, less than or equal to about 1,400 mg, less than or equal to about 1,200 mg, less than or equal to about 1,000 mg, less than or equal to about 800 mg, less than or equal to about 500 mg, less than or equal to about 300 mg, less than or equal to about 200 mg, or less than or equal to about 100 mg. All suitable combinations of the above-referenced ranges are also possible (e.g., greater than or equal to about 1 mg and less than or equal to about 3,500 mg, greater than or equal to about 5 mg and less than or equal to about 2,500 mg, greater than or equal to about 10 mg and less than or equal to about 3,500 mg, greater than or equal to about 10 mg and less than or equal to about 1,000 mg, greater than or equal to about 50 mg and less than or equal to about 2,000 mg, greater than or equal to about 200 mg and less than or equal to about 1,000 mg). The stiffness may be determined using the Gurley stiffness (e.g., bending resistance) recorded in units of mm (equivalent to gu) in accordance with TAPPI T543 om-94.

When present, a supplemental layer (e.g., a backer layer, an additional layer) may have any suitable dust holding capacity. In certain embodiments, the supplemental layer has a dust holding capacity of greater than or equal to 10 gsm, greater than or equal to 20 gsm, greater than or equal to 30 gsm, greater than or equal to 40 gsm, greater than or equal to 50 gsm, greater than or equal to 75 gsm, greater than or equal to 100 gsm, greater than or equal to 125 gsm, greater than or equal to 150 gsm, greater than or equal to 200 gsm, greater than or equal to 250 gsm, greater than or equal to 300 gsm, greater than or equal to 350 gsm, or greater than or equal to 400 gsm. In some embodiments, the supplemental layer has a dust holding capacity of less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 125 gsm, less than or equal to 100 gsm, less than or equal to 75 gsm, or less than or equal to 50 gsm. Combinations of these ranges are also possible (e.g., greater than or equal to 10 gsm and less than or equal to 500 gsm or greater than or equal to 20 gsm and less than or equal to 450 gsm). Dust holding capacity may be measured according to ISO 19438 (2003) using ISO medium test dust (A3).

When present, a supplemental layer (e.g., a backer layer, an additional layer) may have any suitable pressure drop. In certain embodiments, the supplemental layer has a pressure drop of greater than or equal to 0.05 kPa, greater than or equal to 0.1 kPa, greater than or equal to 0.3 kPA, greater than or equal to 0.5 kPa, greater than or equal to 1 kPa, greater than or equal to 3 kPa, greater than or equal to 5 kPA, greater than or equal to 10 kPa, greater than or equal to 15 kPa, greater than or equal to 20 kPa, greater than or equal to 25 kPa, greater than or equal to 30 kPa, greater than or equal to 40 kPa, greater than or equal to 50 kPa, or greater than or equal to 60 kPa. In some embodiments, the supplemental layer has a pressure drop of less than or equal to 80 kPa, less than or equal to 75 kPa, less than or equal to 70 kPa, less than or equal to 65 kPa, less than or equal to 60 kPa, less than or equal to 55 kPa, less than or equal to 50 kPa, less than or equal to 45 kPa, less than or equal to 40 kPa, less than or equal to 35 kPa, less than or equal to 30 kPa, less than or equal to 25 kPa, less than or equal to 20 kPa, less than or equal to 15 kPa, less than or equal to 10 kPa, or less than or equal to 5 kPa. Combinations of these ranges are also possible (e.g., greater than or equal to 0.05 kPa and less than or equal to 80 kPa or greater than or equal to 0.1 kPa and less than or equal to 50 kPa). Pressure drop may be measured according to ASTM D2 986-91.

In some embodiments two or more layers of the filter media (e.g., fine fiber layer and supplemental layer or two fine fiber layers) may be formed separately and combined by any suitable method such as lamination, collation, or by use of adhesives. The two or more layers may be formed using different processes, or the same process. For example, each of the layers may be independently formed by an electrospinning process, a non-wet laid process (e.g., meltblown process, melt spinning process, centrifugal spinning process, electrospinning process, dry laid process, air laid process), a wet laid process, or any other suitable process.

Different layers may be adhered together by any suitable method. For instance, layers may be adhered by an adhesive and/or melt-bonded to one another on either side. Lamination and calendering processes may also be used. In some embodiments, a supplemental layer may be formed from any type of fiber or blend of fibers via a wetlaid or non-wetlaid process and appropriately adhered to another layer.

In some embodiments, a filter media comprises an adhesive positioned between two or more layers (e.g., between a fine fiber layer and a second layer (e.g., a backer, a supplemental layer)). As also described above, some filter media described herein comprise adhesive positioned between two or more pairs of layers (e.g., between a fine fiber layer and a second layer). It should be understood that an adhesive positioned between any specific pair of layers may have some or all of the properties described below with respect to adhesives. It should also be understood that a filter media may comprise two locations at which adhesive is positioned for which the adhesive has identical properties and/or may comprise two or more locations at which adhesive is positioned for which the adhesive differs in one or more ways.

In some embodiments, a filter media comprises an adhesive that is a solvent-based adhesive resin. As used herein, a solvent-based adhesive resin is an adhesive that is capable of undergoing a liquid to solid transition upon the evaporation of a solvent from the resin. Solvent-based adhesive resins may be applied while in the liquid state. Subsequently, the solvent that is present may evaporate to yield a solid adhesive. Solvent-based adhesives may thus be considered to be distinct from hot melt adhesives, which do not comprise volatile solvents (e.g., solvents that evaporate under normal operating conditions) and which typically undergo a liquid to solid transition as the adhesive cools. In embodiments in which adhesive is present at more than one location, each location at which adhesive is present may independently comprise an adhesive that is a solvent-based adhesive resin.

Desirable properties for adhesives may include sufficient tackiness and open time (i.e., the amount of time that the adhesive remains tacky after being exposed to the ambient atmosphere). Without wishing to be bound by theory, the tackiness of an adhesive may depend on both the glass transition temperature of the adhesive and the molecular weight of any polymeric components of the adhesive. Higher values of glass transition and lower values of molecular weight may promote enhanced tackiness, and higher values of molecular weight may result in higher cohesion in the adhesive and higher bond strength. In some embodiments, adhesives having a glass transition temperature and/or molecular weight in one or more ranges described herein may provide appropriate values of both tackiness and open time. For example, the adhesive may be configured to remain tacky for a relatively long time (e.g., the adhesive may remain tacky after full evaporation of any solvents initially present, and/or may be tacky indefinitely when held at room temperature). In some embodiments, the open time of the adhesive may be less than or equal to 24 hours, less than or equal to 12 hours, less than or equal to 6 hours, less than or equal to 1 hour, less than or equal to 30 minutes, less than or equal to 15 minutes, less than or equal to 10 minutes, less than or equal to 5 minutes, less than or equal to 3 minutes, less than or equal to 1 minute, less than or equal to 30 seconds, or less than or equal to 10 seconds. In some embodiments, the open time of the adhesive may be at least 1 second, at least 10 seconds, at least 15 seconds, at least 30 seconds, at least 1 minute, at least 3 minutes, at least 5 minutes, at least 10 minutes, at least 15 minutes, at least 30 minutes, at least 1 hour, at least 6 hours, or at least 12 hours. Combinations of the above-referenced ranges are also possible (e.g., at least 1 second and less than or equal to 24 hours). Other values are also possible. In embodiments in which adhesive is present at more than one location, each location at which adhesive is present may independently comprise an adhesive having an open time in one or more of the ranges described above.

Non-limiting examples of suitable adhesives include adhesives comprising acrylates, acrylate copolymers, poly(urethane)s, poly(ester)s, poly(vinyl alcohol), ethylene-vinyl acetate copolymers, silicone solvents, poly(olefin)s, synthetic and/or natural rubber, synthetic elastomers, ethylene-acrylic acid copolymers, ethylene-methacrylate copolymers, ethylene-methyl methacrylate copolymers, poly(vinylidene chloride), poly(amide)s, epoxies, melamine resins, poly(isobutylene), styrenic block copolymers, styrene-butadiene rubber, aliphatic urethane acrylates, and/or phenolics. In embodiments in which adhesive is present at more than one location, each location at which adhesive is present may independently comprise an adhesive comprising one or more of the materials described above.

When present, an adhesive may comprise a crosslinker and/or may be crosslinked. In certain embodiments, a crosslinker is less than or equal to 3000 g/mol. In some embodiments, the crosslinker is a small molecule as described above and/or the crosslink is a reaction product of a small molecule crosslinker as described above. In some embodiments, an adhesive comprises a small molecule crosslinker (and/or a reaction product thereof) that is one or more of a carbodiimide, an isocyanate, an aziridine, a zirconium compound such as zirconium carbonate, a metal acid ester, a metal chelate, a multifunctional propylene imine, and an amino resin. In some embodiments, the adhesive comprises at least one polymer and/or prepolymer with one or more reactive functional groups that are capable of reacting with the crosslinker and/or comprises a reaction product of one or more reactive functional groups on a polymer and/or prepolymer that have reacted with the crosslinker. Non-limiting examples of suitable reactive functional groups include alcohol groups, carboxylic acid groups, epoxy groups, amine groups, and amino groups. In some embodiments, a filter media comprises an adhesive that comprises one or more polymers and/or prepolymers that may undergo self-crosslinking via functional groups attached thereto. In some embodiments, a filter media comprises an adhesive that comprises a self-crosslinked reaction product of one or more polymers and/or prepolymers. In embodiments in which adhesive is present at more than one location, each location at which adhesive is present may independently comprise an adhesive comprising one or more of the materials described above.

When present, a small molecule crosslinker and/or crosslinks that are reaction products thereof may make up any suitable amount of an adhesive. In some embodiments, the wt % of the crosslinker and/or crosslinks that are reaction products thereof is greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 15 wt %, greater than or equal to 20 wt %, or greater than or equal to 25 wt % with respect to the total mass of the adhesive. In some embodiments, the wt % of the small molecule crosslinker and/or crosslinks that are reaction products thereof is less than or equal to 30 wt %, less than or equal to 25 wt %, less than or equal to 20 wt %, less than or equal to 15 wt %, less than or equal to 10 wt %, less than or equal to 5 wt %, less than or equal to 2 wt %, less than or equal to 1 wt %, less than or equal to 0.5 wt %, or less than or equal to 0.2 wt % with respect to the total mass of the adhesive. Combinations of the above-referenced ranges are also possible (e.g., greater than or equal to 0.1 wt % and less than or equal to 30 wt %, or greater than or equal to 1 wt % and less than or equal to 20 wt %). Other ranges are also possible. In embodiments in which adhesive is present at more than one location, each location at which adhesive is present may independently comprise an adhesive comprising a small molecule crosslinker and/or crosslinks that are reaction products thereof in one or more of the amounts described above.

The adhesive and/or any small molecule crosslinkers therein may be capable of undergoing a crosslinking reaction at any suitable temperature and/or may have undergone a crosslinking reaction at any suitable temperature. In some embodiments, an adhesive may be capable of undergoing a cross-linking reaction and/or may have undergone a crosslinking reaction at a temperature of greater than or equal to 24° C., greater than or equal to 40° C., greater than or equal to 50° C., greater than or equal to 60° C., greater than or equal to 70° C., greater than or equal to 80° C., greater than or equal to 90° C., greater than or equal to 100° C., greater than or equal to 110° C., greater than or equal to 120° C., greater than or equal to 130° C., or greater than or equal to 140° C. In some embodiments, an adhesive may be capable of undergoing a cross-linking reaction and/or may have undergone a crosslinking reaction at a temperature of less than or equal to 150° C., less than or equal to 140° C., less than or equal to 130° C., less than or equal to 120° C., less than or equal to 110° C., less than or equal to 100° C., less than or equal to 90° C., less than or equal to 80° C., less than or equal to 70° C., less than or equal to 60° C., less than or equal to 50° C., or less than or equal to 40° C. Combinations of the above-referenced ranges are also possible (e.g., greater than or equal to 25° C. and less than or equal to 150° C., or greater than or equal to 25° C. and less than or equal to 130° C.). Other ranges are also possible. In embodiments in which adhesive is present at more than one location, each location at which adhesive is present may independently comprise an adhesive capable of undergoing a crosslinking reaction and/or may have undergone a crosslinking reaction at a temperature in one or more of the ranges described above.

When present, an adhesive may comprise a solvent and/or may be formed from a composition comprising a solvent (e.g., from which the solvent has evaporated). By way of example, some embodiments relate to an adhesive applied to the layer or filter media while dissolved or suspended in a solvent. Non-limiting examples of suitable solvents include water, hydrocarbon solvents, ketones, aromatic solvents, fluorinated solvents, toluene, heptane, acetone, n-butyl acetate, methyl ethyl ketone, methylene chloride, naphtha, and mineral spirits. In embodiments in which adhesive is present at more than one location, each location at which adhesive is present may independently comprise one or more of the solvents described above and/or may be formed from a composition comprising one or more of the solvents described above.

When present, an adhesive may have a relatively low glass transition temperature. In some embodiments, an adhesive has a glass transition temperature of less than or equal to 60° C., less than or equal to 50° C., less than or equal to 45° C., less than or equal to 40° C., less than or equal to 35° C., less than or equal to 30° C., less than or equal to 25° C., less than or equal to 24° C., less than or equal to 20° C., less than or equal to 15° C., less than or equal to 10° C., less than or equal to 5° C., less than or equal to 0° C., less than or equal to −5° C., less than or equal to −10° C., less than or equal to −20° C., less than or equal to −30° C., less than or equal to −40° C., less than or equal to −50° C., less than or equal to −60° C., less than or equal to −70° C., less than or equal to −80° C., less than or equal to −90° C., less than or equal to −100° C., or less than or equal to −110° C. In some embodiments, an adhesive has a glass transition temperature of greater than or equal to −125° C., greater than or equal to −110° C., greater than or equal to −100° C., greater than or equal to −90° C., greater than or equal to −80° C., greater than or equal to −70° C., greater than or equal to −60° C., greater than or equal to −50° C., greater than or equal to −40° C., greater than or equal to −30° C., greater than or equal to −20° C., greater than or equal to −10° C., greater than or equal to 0° C., greater than or equal to 5° C., greater than or equal to 10° C., greater than or equal to 24° C., greater than or equal to 25° C., greater than or equal to 40° C., or greater than or equal to 50° C. Combinations of the above-referenced ranges are also possible (e.g., greater than or equal to −125° C. and less than or equal to 60° C., or greater than or equal to −100° C. and less than or equal to 25° C.). Other ranges are also possible. The value of the glass transition temperature for an adhesive may be measured by differential scanning calorimetry as described above. In embodiments in which adhesive is present at more than one location, each location at which adhesive is present may independently comprise an adhesive having a glass transition temperature in one or more of the ranges described above.

When present, an adhesive may have a variety of suitable molecular weights. In some embodiments, an adhesive has a number average molecular weight of greater than or equal to 10 kDa, greater than or equal to 30 kDa, greater than or equal to 50 kDa, greater than or equal to 100 kDa, greater than or equal to 300 kDa, greater than or equal to 500 kDa, greater than or equal to 1000 kDa, greater than or equal to 2000 kDa, or greater than or equal to 3000 kDa. In some embodiments, an adhesive has a number average molecular weight of less than or equal to 5000 kDa, less than or equal to 4000 kDa, less than or equal to 3000 kDa, less than or equal to 1000 kDa, less than or equal to 500 kDa, less than or equal to 300 kDa, less than or equal to 100 kDa, less than or equal to 50 kDa, or less than or equal to 30 kDa. Combinations of the above-referenced ranges are also possible (e.g., greater than or equal to 10 kDa and less than or equal to 5000 kDa, or greater than or equal to 30 kDa and less than or equal to 3000 kDa). Other ranges are also possible. The number average molecular weight may be measured by light scattering. In embodiments in which adhesive is present at more than one location, each location at which adhesive is present may independently comprise an adhesive having a molecular weight in one or more of the ranges described above.

When present, an adhesive may have a variety of suitable basis weights. In some embodiments, an adhesive has a basis weight of greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, an adhesive has a basis weight of less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible. In embodiments in which adhesive is present at more than one location, each location at which adhesive is present may independently comprise an adhesive having a basis weight in one or more of the ranges described above.

In embodiments where the filter media comprises one or more adhesives, the total basis weight of the adhesives in the filter media together (i.e., the sum of the basis weights of the adhesive at each location) may be greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, the total basis weight of the adhesives in the filter media together may be less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible.

When present, an adhesive may adhere together two or more layers between which it is positioned. The strength of adhesion between the two layers may be relatively high. For instance, an adhesive may adhere two layers together with a bond strength of greater than or equal to 100 g/in², greater than or equal to 150 g/in², greater than or equal to 200 g/in², greater than or equal to 500 g/in², greater than or equal to 750 g/in², greater than or equal to 1000 g/in², greater than or equal to 1250 g/in², greater than or equal to 1500 g/in², greater than or equal to 1750 g/in², greater than or equal to 2000 g/in², greater than or equal to 2250 g/in², greater than or equal to 2500 g/in², greater than or equal to 2750 g/in², greater than or equal to 3000 g/in², greater than or equal to 3250 g/in², greater than or equal to 3500 g/in², greater than or equal to 3750 g/in², greater than or equal to 4000 g/in², greater than or equal to 4250 g/in², greater than or equal to 4500 g/in², or greater than or equal to 4750 g/in². In some embodiments, an adhesive adheres two layers together with a bond strength of less than or equal to 5000 g/in², less than or equal to 4750 g/in², less than or equal to 4500 g/in², less than or equal to 4250 g/in², less than or equal to 4000 g/in², less than or equal to 3750 g/in², less than or equal to 3500 g/in², less than or equal to 3250 g/in², less than or equal to 3000 g/in², less than or equal to 2750 g/in², less than or equal to 2500 g/in², less than or equal to 2250 g/in², less than or equal to 2000 g/in², less than or equal to 1750 g/in², less than or equal to 1500 g/in², less than or equal to 1250 g/in², less than or equal to 1000 g/in², less than or equal to 750 g/in², less than or equal to 500 g/in², less than or equal to 200 g/in², or less than or equal to 150 g/in². Combinations of the above-referenced ranges are also possible (e.g., greater than or equal to 100 g/in² and less than or equal to 5000 g/in², or greater than or equal to 150 g/in² and less than or equal to 3000 g/in²). Other ranges are also possible. In embodiments in which adhesive is present at more than one location, each location at which adhesive is present may independently comprise an adhesive adhering together two layers with a bond strength in one or more of the ranges described above. In some embodiments, the entire filter media as a whole has an internal bond strength in one or more ranges described above. The bond strength of the entire filter media as a whole is equivalent to the weakest bond strength between two layers of the media.

The bond strength (e.g., internal bond strength) between two layers (e.g., between two layers adhered together by an adhesive) may be determined by using a z-directional peel strength test. In short, the bond strength may be determined by the following procedure. First, a 1″×1″ sample is mounted on a steel block with dimensions 1″×1″×0.5″ using double sided tape. The sample block is then mounted onto the non-traversing head of a tensile tester and another steel block of the same size is connected to the traversing head with double sided tape. The traversing head is brought down and bonded to the sample on the steel block of the non-traversing head. Enough pressure is applied so that the steel blocks are bonded together via the mounted sample. The traversing head is then moved at a traversing speed of 1″/min and the maximum load is found from the peak of a stress-strain curve. The bond strength (e.g., internal bond strength) between the two layers is considered to be equivalent to the maximum load measured by this procedure.

In some embodiments, the filter media is substantially free (e.g., less than or equal to 1 wt. %, less than or equal to 0.05 wt. %, or less than or equal to 0.01 wt. %) or free of glass fibers. Without wishing to be bound by theory, it is believed that reducing the amount of, or eliminating, glass fibers in the filter media may result in higher gamma, improved pleating, and/or improved handling durability (e.g., reduced shedding of fibers).

The filter media have any suitable thickness. For example, in some embodiments, the filter media has a thickness of greater than or equal to 0.01 mm, greater than or equal to 0.1 mm, greater than or equal to 0.05 mm, greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 15 mm, greater than or equal to 20 mm, or greater than or equal to 25 mm. In certain embodiments, the filter media has a thickness of less than or equal to 30 mm, less than or equal to 28 mm, less than or equal to 25 mm, less than or equal to 23 mm, less than or equal to 20 mm, less than or equal to 18 mm, less than or equal to 15 mm, less than or equal to 13 mm, less than or equal to 10 mm, less than or equal to 9 mm, less than or equal to 8 mm, less than or equal to 7 mm, less than or equal to 6 mm, less than or equal to 5 mm, less than or equal to 4 mm, less than or equal to 3 mm, less than or equal to 2 mm, or less than or equal to 1 mm. Combinations of these ranges are also possible (e.g., greater than or equal to 0.01 mm and less than or equal to 30 mm or greater than or equal to 0.1 mm and less than or equal to 20 mm). Thickness may be measured according to ISO 534 (2011) at 2 N/cm².

The filter media may have any suitable basis weight. For example, in certain embodiments, the filter media has a basis weight of greater than or equal to 5 gsm, greater than or equal to 10 gsm, greater than or equal to 15 gsm, greater than or equal to 20 gsm, greater than or equal to 30 gsm, greater than or equal to 40 gsm, greater than or equal to 50 gsm, greater than or equal to 75 gsm, greater than or equal to 100 gsm, greater than or equal to 125 gsm, greater than or equal to 150 gsm, greater than or equal to 200 gsm, greater than or equal to 250 gsm, greater than or equal to 300 gsm, greater than or equal to 400 gsm, greater than or equal to 500 gsm, greater than or equal to 600 gsm, greater than or equal to 700 gsm, greater than or equal to 800 gsm, or greater than or equal to 900 gsm. In some cases, the filter media has a basis weight of less than or equal to 1000 gsm, less than or equal to 900 gsm, less than or equal to 800 gsm, less than or equal to 700 gsm, less than or equal to 600 gsm, less than or equal to 500 gsm, less than or equal to 400 gsm, less than or equal to 300 gsm, less than or equal to 250 gsm, less than or equal to 200 gsm, less than or equal to 150 gsm, less than or equal to 125 gsm, less than or equal to 100 gsm, less than or equal to 75 gsm, or less than or equal to 50 gsm. Combinations of these ranges are also possible (e.g., greater than or equal to 5 gsm and less than or equal to 1000 gsm or greater than or equal to 10 gsm and less than or equal to 500 gsm). Basis weight may be measured according to ISO 536:2012.

The filter media may have any suitable mean flow pore size. For example, in some cases, the filter media has a mean flow pore size of greater than or equal to 0.001 microns, greater than or equal to 0.01 microns, greater than or equal to 0.1 microns, greater than or equal to 0.3 microns, greater than or equal to 0.5 microns, greater than or equal to 0.7 microns, greater than or equal to 1 micron, greater than or equal to 2 microns, greater than or equal to 3 microns, greater than or equal to 5 microns, greater than or equal to 7 microns, greater than or equal to 10 microns, greater than or equal to 15 microns, greater than or equal to 20 microns, greater than or equal to 30 microns, greater than or equal to 40 microns, greater than or equal to 50 microns, greater than or equal to 60 microns, greater than or equal to 70 microns, greater than or equal to 80 microns, or greater than or equal to 90 microns. In certain instances, the filter media has a mean flow pore size of less than or equal to 100 microns, less than or equal to 95 microns, less than or equal to 90 microns, less than or equal to 85 microns, less than or equal to 80 microns, less than or equal to 75 microns, less than or equal to 70 microns, less than or equal to 65 microns, less than or equal to 60 microns, less than or equal to 55 microns, less than or equal to 50 microns, less than or equal to 40 microns, less than or equal to 30 microns, less than or equal to 20 microns, less than or equal to 15 microns, less than or equal to 10 microns, less than or equal to 7 microns, less than or equal to 5 microns, less than or equal to 3 microns, less than or equal to 2 microns, or less than or equal to 1 micron. Combinations of these ranges are also possible (e.g., greater than or equal to 0.001 microns and less than or equal to 100 microns, greater than or equal to 0.01 microns and less than or equal to 50 microns, or greater than or equal to 0.01 microns and less than or equal to 20 microns). Mean flow pore may be measured according to ASTM F-316 (2003).

The filter media may have any suitable maximum pore size. For example, in certain embodiments, the filter media has a maximum pore size of greater than or equal to 0.1 microns, greater than or equal to 0.2 microns, greater than or equal to 0.3 microns, greater than or equal to 0.4 microns, greater than or equal to 0.5 microns, greater than or equal to 0.7 microns, greater than or equal to 1 micron, greater than or equal to 3 microns, greater than or equal to 5 microns, greater than or equal to 10 microns, greater than or equal to 15 microns, greater than or equal to 20 microns, greater than or equal to 30 microns, greater than or equal to 40 microns, greater than or equal to 50 microns, greater than or equal to 60 microns, greater than or equal to 70 microns, greater than or equal to 80 microns, greater than or equal to 90 microns, greater than or equal to 100 microns, greater than or equal to 125 microns, greater than or equal to 150 microns, or greater than or equal to 175 microns. In some embodiments, the filter media has a maximum pore size of less than or equal to 200 microns, less than or equal to 190 microns, less than or equal to 180 microns, less than or equal to 170 microns, less than or equal to 160 microns, less than or equal to 150 microns, less than or equal to 140 microns, less than or equal to 130 microns, less than or equal to 120 microns, less than or equal to 110 microns, less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 20 microns, less than or equal to 10 microns, less than or equal to 5 microns, less than or equal to 3 microns, or less than or equal to 1 micron. Combinations of these ranges are also possible (e.g., greater than or equal to 0.1 microns and less than or equal to 200 microns, greater than or equal to 0.3 microns and less than or equal to 100 microns, or greater than or equal to 0.3 microns and less than or equal to 50 microns). Maximum pore size may be determined according to ASTM F316 (2003).

The filter media may have any suitable total Gurley bending stiffness (e.g., in the machine direction and/or in the cross direction). For example, in some cases, the filter media has a total Gurley bending stiffness (e.g., in the machine direction and/or in the cross direction) of greater than or equal to 1 mg, greater than or equal to 5 mg, greater than or equal to 10 mg, greater than or equal to 15 mg, greater than or equal to 20 mg, greater than or equal to 25 mg, greater than or equal to 50 mg, greater than or equal to 75 mg, greater than or equal to 100 mg, greater than or equal to 150 mg, greater than or equal to 200 mg, greater than or equal to 300 mg, greater than or equal to 400 mg, greater than or equal to 500 mg, greater than or equal to 750 mg, greater than or equal to 1000 mg, greater than or equal to 1500 mg, greater than or equal to 2000 mg, greater than or equal to 2500 mg, or greater than or equal to 3000 mg. In certain embodiments, the filter media has a total Gurley bending stiffness (e.g., in the machine direction and/or in the cross direction) of less than or equal to 3500 mg, less than or equal to 3250 mg, less than or equal to 3000 mg, less than or equal to 2750 mg, less than or equal to 2500 mg, less than or equal to 2250 mg, less than or equal to 2000 mg, less than or equal to 1500 mg, less than or equal to 1000 mg, less than or equal to 750 mg, less than or equal to 500 mg, less than or equal to 400 mg, less than or equal to 300 mg, less than or equal to 200 mg, or less than or equal to 150 mg. Combinations of these ranges are also possible (e.g., greater than or equal to 1 mg and less than or equal to 3500 mg, greater than or equal to 10 mg and less than or equal to 3000 mg, or greater than or equal to 25 mg and less than or equal to 3000 mg). Total Gurley bending stiffness (e.g., in the machine direction and/or in the cross direction) may be measured according to T543 om-94.

The filter media may have any suitable BET surface area. For example, in some cases, the filter media has a BET surface area of greater than or equal to 0.01 m²/g, greater than or equal to 0.05 m²/g, greater than or equal to 0.1 m²/g, greater than or equal to 0.5 m²/g, greater than or equal to 1 m²/g, greater than or equal to 1.5 m²/g, greater than or equal to 2 m²/g, greater than or equal to 2.5 m²/g, greater than or equal to 3 m²/g, greater than or equal to 5 m²/g, greater than or equal to 10 m²/g, greater than or equal to 20 m²/g, greater than or equal to 30 m²/g, greater than or equal to 40 m²/g, greater than or equal to 50 m²/g, greater than or equal to 75 m²/g, greater than or equal to 100 m²/g, greater than or equal to 150 m²/g, greater than or equal to 200 m²/g, greater than or equal to 250 m²/g, or greater than or equal to 300 m²/g. In certain instances, the filter media has a BET surface area of less than or equal to 400 m²/g, less than or equal to 375 m²/g, less than or equal to 350 m²/g, less than or equal to 325 m²/g, less than or equal to 300 m²/g, less than or equal to 275 m²/g, less than or equal to 250 m²/g, less than or equal to 225 m²/g, less than or equal to 200 m²/g, less than or equal to 175 m²/g, less than or equal to 150 m²/g, less than or equal to 125 m²/g, less than or equal to 100 m²/g, less than or equal to 75 m²/g, less than or equal to 50 m²/g, less than or equal to 40 m²/g, less than or equal to 30 m²/g, less than or equal to 20 m²/g, less than or equal to 10 m²/g, less than or equal to 5 m²/g, or less than or equal to 3 m²/g. Combinations of these ranges are also possible (e.g., greater than or equal to 0.01 m²/g and less than or equal to 400 m²/g or greater than or equal to 0.1 m²/g and less than or equal to 3 m²/g). The BET surface area may be measured according to section 10 of Battery Council International Standard BCIS-03A, “Recommended Battery Materials Specifications Valve Regulated Recombinant Batteries”, section 10 being “Standard Test Method for Surface Area of Recombinant Battery Separator Mat”. Following this technique, the BET surface area is measured via adsorption analysis using a BET surface analyzer (e.g., Micromeritics Gemini III 2375 Surface Area Analyzer) with nitrogen gas; the sample amount is between 0.5 and 0.6 grams in a ¾″ tube; and, the sample is allowed to degas at 75 degrees C. for a minimum of 3 hours.

The filter media may have any suitable air permeability. For example, in some embodiments, the filter media has an air permeability of greater than or equal to 0.2 CFM, greater than or equal to 0.5 CFM, greater than or equal to 1 CFM, greater than or equal to 2 CFM, greater than or equal to 5 CFM, greater than or equal to 10 CFM, greater than or equal to 20 CFM, greater than or equal to 30 CFM, greater than or equal to 40 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 250 CFM, greater than or equal to 300 CFM, greater than or equal to 400 CFM, greater than or equal to 500 CFM, greater than or equal to 600 CFM, greater than or equal to 700 CFM, or greater than or equal to 800 CFM. In certain embodiments, the filter media has an air permeability of less than or equal to 1000 CFM, less than or equal to 900 CFM, less than or equal to 800 CFM, less than or equal to 700 CFM, less than or equal to 600 CFM, less than or equal to 500 CFM, less than or equal to 400 CFM, less than or equal to 300 CFM, less than or equal to 250 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 40 CFM, or less than or equal to 30 CFM. Combinations of these ranges are also possible (e.g., greater than or equal to 0.2 CFM and less than or equal to 1000 CFM or greater than or equal to 0.5 CFM and less than or equal to 800 CFM). Air permeability may be measured according to ASTM D737-04 (2016) at a pressure of 125 Pa.

The filter media may have any suitable dust holding capacity. For example, in some cases, the filter media has a dust holding capacity of greater than or equal to 1 gsm, greater than or equal to 2 gsm, greater than or equal to 3 gsm, greater than or equal to 4 gsm, greater than or equal to 5 gsm, greater than or equal to 6 gsm, greater than or equal to 7 gsm, greater than or equal to 8 gsm, greater than or equal to 9 gsm, greater than or equal to 10 gsm, greater than or equal to 15 gsm, greater than or equal to 20 gsm, greater than or equal to 30 gsm, greater than or equal to 40 gsm, greater than or equal to 50 gsm, greater than or equal to 75 gsm, greater than or equal to 100 gsm, greater than or equal to 125 gsm, greater than or equal to 150 gsm, greater than or equal to 200 gsm, greater than or equal to 250 gsm, greater than or equal to 300 gsm, or greater than or equal to 400 gsm. In certain instances, the filter media has a dust holding capacity of less than or equal to 500 gsm, less than or equal to 475 gsm, less than or equal to 450 gsm, less than or equal to 425 gsm, less than or equal to 400 gsm, less than or equal to 375 gsm, less than or equal to 350 gsm, less than or equal to 325 gsm, less than or equal to 300 gsm, less than or equal to 250 gsm, less than or equal to 200 gsm, less than or equal to 150 gsm, less than or equal to 100 gsm, less than or equal to 75 gsm, less than or equal to 50 gsm, less than or equal to 40 gsm, less than or equal to 30 gsm, or less than or equal to 20 gsm. Combinations of these ranges are also possible (e.g., greater than or equal to 1 gsm and less than or equal to 500 gsm or greater than or equal to 10 gsm and less than or equal to 450 gsm). Dust holding capacity may be measured according to ISO 19438 2003) using ISO medium test dust (A3).

The filter media may have any suitable gamma (e.g., at the most penetrating particle size (MPPS) or at 0.09 microns). For example, in some cases, the filter media has a gamma (e.g., at the MPPS or at 0.09 microns) of greater than or equal to 3, greater than or equal to 4, greater than or equal to 5, greater than or equal to 6, greater than or equal to 7, greater than or equal to 8, greater than or equal to 9, greater than or equal to 10, greater than or equal to 12, greater than or equal to 15, greater than or equal to 20, greater than or equal to 25, greater than or equal to 30, greater than or equal to 40, greater than or equal to 50, greater than or equal to 75, greater than or equal to 100, greater than or equal to 125, greater than or equal to 150, greater than or equal to 200, or greater than or equal to 250. In certain instances, the filter media has a gamma (e.g., at the MPPS or at 0.09 microns) of less than or equal to 400, less than or equal to 375, less than or equal to 350, less than or equal to 325, less than or equal to 300, less than or equal to 275, less than or equal to 250, less than or equal to 200, less than or equal to 150, less than or equal to 125, less than or equal to 100, less than or equal to 75, less than or equal to 50, less than or equal to 40, less than or equal to 30, or less than or equal to 25. Combinations of these ranges are also possible (e.g., greater than or equal to 3 and less than or equal to 300 or greater than or equal to 4 and less than or equal to 300).

Gamma is defined by the following formula: Gamma=(−log₁₀(penetration %/100)/(average pressure drop, mm H₂O)×100. Penetration, often expressed as a percentage, is defined as follows: Pen (%)=(C/C₀)*100 where C is the particle concentration after passage through the filter and C₀ is the particle concentration before passage through the filter. Penetration (and gamma) may be measured at any desired particle size (e.g., MPPS or 0.09 microns). MPPS penetration is the penetration of the most penetrating particle size; in other words, when penetration is measured for a range of particle sizes, the MPPS penetration is the value of penetration measured for the particle with the highest penetration. Penetration (e.g., MPPS penetration) and average pressure drop can be measured for any particle size using the EN1822:2009 standard for air filtration, which is described below. Penetration and average pressure drop may be measured by blowing dioctyl phthalate (DOP) particles through a filter media and measuring the percentage of particles that penetrate therethrough and the pressure drop as the particles are blown through the filter media. This may be accomplished by use of a TSI 3160 automated filter testing unit from TSI, Inc. equipped with a dioctyl phthalate generator for DOP aerosol testing based on the EN1822:2009 standard for MPPS DOP particles. The TSI 3160 automated filter testing unit is employed to sequentially blow populations of DOP particles with varying average particle diameters at a 100 cm² face area of the upstream face of the filter media. The populations of particles are blown at the upstream face of the filter media in order of increasing average diameter, where each has a geometric standard deviation of less than 1.3, and they have the following set of average diameters: 0.04 microns, 0.08 microns, 0.12 microns, 0.16 microns, 0.2 microns, 0.26 microns, and 0.3 microns. The penetration and average pressure drop is measured continuously and separately for each population of particles over the period of time during which that population of particles is blown at the upstream face of the filter media. The upstream and downstream particle concentrations are measured by use of condensation particle counters. During the penetration measurement, the 100 cm² face area of the upstream face of the filter media is subjected to a continuous loading of DOP particles at an airflow of 12 L/min, giving a media face velocity of 2 cm/s. Each population of particles is blown at the upstream face of the filter media for 120 s or such that at least 1000 particles are counted downstream of the filter media, whichever is longer.

To determine the MPPS penetration, the instrument measures a penetration value across the filter media (or layer) by determining the DOP particle size at which the highest level of penetration was measured for the test, i.e., the most penetrating particle size (MPPS). The sample is exposed to particles of each size sequentially. The penetration of the particles as a function of particle size is plotted, and the data is fit with a parabolic function. Then, the maximum of the parabolic function is found; the particle size at the maximum is the most penetrating particle size (MPPS) and the penetration at the maximum is the penetration at the MPPS.

The filter media may have any suitable efficiency (e.g., initial efficiency). For example, in certain embodiments, the filter media has an efficiency (e.g., initial efficiency) of greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 85%, greater than or equal to 90%, greater than or equal to 95%, greater than or equal to 97%, greater than or equal to 98%, greater than or equal to 99%, greater than or equal to 99.9%, greater than or equal to 99.99%, greater than or equal to 99.999%, greater than or equal to 99.9999%, or greater than or equal to 99.99999%. In some embodiments, the filter media has an efficiency of less than 100%, less than or equal to 99.99999%, less than or equal to 99.9999%, less than or equal to 99.999%, less than or equal to 99.99%, less than or equal to 99.9%, less than or equal to 99.5%, less than or equal to 99%, less than or equal to 98%, less than or equal to 97%, less than or equal to 95%, less than or equal to 90%, less than or equal to 85%, or less than or equal to 80%. Combinations of these ranges are also possible (e.g., greater than or equal to 10% and less than 100%, greater than or equal to 10% and less than or equal to 99.99999%, or greater than or equal to 20% and less than or equal to 99.99999%). Efficiency may be determined by the following equation: Efficiency (%)=100−penetration (%), wherein penetration is determined at any particle size (e.g., at 0.09 microns) as described above.

The filter media may have any suitable salt (e.g., NaCl) loading capacity. For example, in some instances, the filter media has a salt (e.g., NaCl) loading capacity of greater than or equal to 0.1 g/m², greater than or equal to 0.3 g/m², greater than or equal to 0.5 g/m², greater than or equal to 0.7 g/m², greater than or equal to 1 g/m², greater than or equal to 2 g/m², greater than or equal to 3 g/m², greater than or equal to 4 g/m², greater than or equal to 5 g/m², greater than or equal to 6 g/m², greater than or equal to 7 g/m², greater than or equal to 8 g/m², greater than or equal to 9 g/m², greater than or equal to 10 g/m², greater than or equal to 12 g/m², greater than or equal to 15 g/m², greater than or equal to 20 g/m², greater than or equal to 25 g/m², greater than or equal to 30 g/m², or greater than or equal to 35 g/m². In certain cases, the filter media has a salt (e.g., NaCl) loading capacity of less than or equal to 40 g/m², less than or equal to 38 g/m², less than or equal to 35 g/m², less than or equal to 33 g/m², less than or equal to 30 g/m², less than or equal to 28 g/m², less than or equal to 25 g/m², less than or equal to 20 g/m², less than or equal to 15 g/m², less than or equal to 10 g/m², less than or equal to 5 g/m², less than or equal to 4 g/m², less than or equal to 3 g/m², less than or equal to 2 g/m², or less than or equal to 1 g/m². Combinations of these ranges are also possible (e.g., greater than or equal to 0.1 g/m² and less than or equal to 40 g/m² or greater than or equal to 0.5 g/m² and less than or equal to 30 g/m²). The salt (e.g., NaCl) loading capacity of the filter media may be determined by exposing a filter media with a nominal exposed area of 100 cm² to salt (e.g., NaCl) particles with a median diameter of 0.26 microns at a concentration of 15 mg/m³ and a face velocity of 5.3 cm/second. Salt (e.g., NaCl) loading may be determined using an 8130 CertiTest™ automated filter testing unit from TSI, Inc. equipped with a salt (e.g., NaCl) generator. The average particle size created by the salt particle generator is 0.26 micron mass mean diameter. The 8130 is run in a continuous mode with one pressure drop reading approximately every minute. The test is run using a 100 cm² filter media sample at a flow rate of 32 liters per minute (face velocity of 5.3 cm/sec) containing 15 mg/m³ of salt (e.g., NaCl) until the pressure drop across the filter media increases by 250 Pa. The salt (e.g., NaCl) loading capacity is determined by weighing the filter media both prior to and after the test and dividing the measured increase in mass by the area of the filter media to obtain the salt (e.g., NaCl) loading capacity per unit area of the filter media.

The filter media may have any suitable DOP oil loading capacity. For example, in certain embodiments, the filter media has a DOP oil loading capacity of greater than or equal to 1 g/m², greater than or equal to 2 g/m², greater than or equal to 3 g/m², greater than or equal to 4 g/m², greater than or equal to 5 g/m², greater than or equal to 7 g/m², greater than or equal to 10 g/m², greater than or equal to 12 g/m², greater than or equal to 15 g/m², greater than or equal to 20 g/m², greater than or equal to 30 g/m², greater than or equal to 40 g/m², greater than or equal to 50 g/m², greater than or equal to 60 g/m², or greater than or equal to 70 g/m². In some embodiments, the filter media has a DOP oil loading capacity of less than or equal to 80 g/m², less than or equal to 75 g/m², less than or equal to 70 g/m², less than or equal to 65 g/m², less than or equal to 60 g/m², less than or equal to 55 g/m², less than or equal to 50 g/m², less than or equal to 40 g/m², less than or equal to 30 g/m², less than or equal to 20 g/m², less than or equal to 15 g/m², less than or equal to 12 g/m², less than or equal to 10 g/m², less than or equal to 7 g/m², or less than or equal to 6 g/m². Combinations of these ranges are also possible (e.g., greater than or equal to 1 g/m² and less than or equal to 80 g/m², greater than or equal to 3 g/m² and less than or equal to 70 g/m², or greater than or equal to 4 g/m² and less than or equal to 70 g/m²).

In general, the DOP oil loading process is performed by exposing a 100 cm² test area of a filter media to an aerosol of DOP particles at a concentration of between 80 and 100 mg/m³, a flow rate of 32 L/minute, and a face velocity of 5.32 cm/second. The DOP particles are produced by a TDA 100P aerosol generator available from Air Techniques International and have a 0.18 micron count median diameter, a 0.3 micron mass mean diameter, and a geometric standard deviation of less than 1.6 microns. Different filter media properties may be determined during DOP oil loading either continuously or by pausing the DOP oil loading to make one or more measurements, depending on the particular test. For example, the pressure drop across the filter media as a function of DOP oil loading may be measured continuously. DOP oil loading, or weight of DOP in the filter media per filter media area, may be determined by measuring the pressure drop during DOP oil loading, stopping oil loading once the pressure drop doubles, and then weighing the filter media. Any increase in filter media weight is attributed to DOP oil, and so the DOP oil loading is determined by taking the difference between the measured weight and the initially DOP-free filter media. Other parameters (e.g., penetration at the MPPS, gamma) may also be determined either during or after DOP oil loading by performing measurements as described herein.

In some embodiments, the filter media as a whole (e.g., a filter media that comprises one or more layers having an oleophobic property such as including an oleophobic component, one or more layers having an oil rank of greater than or equal to 1, and/or one or more surface-modified layers) may perform particularly well after undergoing a DOP oil loading process. Such performance characteristics may include the filter media having a relatively low pressure drop after undergoing the DOP oil loading process, having a relatively low change in the pressure drop after undergoing the DOP oil loading process in comparison to the same media prior to the DOP oil loading process, having a relatively low penetration at the MPPS after undergoing the DOP oil loading process, having a relatively low change in the penetration at the MPPS after undergoing the DOP oil loading process in comparison to the same media prior to the DOP oil loading process, having a high value of gamma after undergoing the DOP oil loading process, and/or having a relatively low change in the value of gamma after undergoing the DOP oil loading process in comparison to the same media prior to the DOP oil loading process.

In some embodiments, the filter media may have a pressure drop of less than or equal to 50 mm H₂O at a DOP oil loading of greater than or equal to 4.5 g/m², greater than or equal to 5 g/m², greater than or equal to 6 g/m², greater than or equal to 7 g/m², greater than or equal to 8 g/m², greater than or equal to 9 g/m², greater than or equal to 10 g/m², greater than or equal to 11 g/m², greater than or equal to 20 g/m², greater than or equal to 30 g/m², greater than or equal to 40 g/m², greater than or equal to 50 g/m², greater than or equal to 60 g/m², or greater than or equal to 70 g/m². In some embodiments, the filter media may have a pressure drop of less than or equal to 50 mm H₂O at a DOP oil loading of less than or equal to 80 g/m², less than or equal to 70 g/m², less than or equal to 60 g/m², less than or equal to 50 g/m², less than or equal to 40 g/m², less than or equal to 30 g/m², less than or equal to 20 g/m², less than or equal to 11 g/m², less than or equal to 10 g/m², less than or equal to 9 g/m², less than or equal to 8 g/m², less than or equal to 7 g/m², or less than or equal to 6 g/m². Combinations of the above-referenced ranges are also possible (e.g., a pressure drop of less than or equal to 50 mm H₂O at a DOP oil loading of greater than or equal to 5 g/m² and less than or equal to 80 g/m², or greater than or equal to 5 g/m² and less than or equal to 11 g/m²). Other ranges are also possible.

The filter media described herein may be suitable for filtering a variety of fluids. For instance, the filter media described herein may be liquid filters and/or air filters. The liquid may be water, fuel, or another fluid. For instance, the fluid may comprise diesel fuel, hydraulic fluid, oil and/or other hydrocarbon liquids. Some methods may comprise employing a filter media described herein to filter a fluid, such as to filter a liquid (e.g., water, fuel) or to filter air. The method may comprise passing a fluid (e.g., a fluid to be filtered) through the filter media. When the fluid is passed through the filter media, the components filtered from the fluid may be retained on an upstream side of the filter media and/or within the filter media. The filtrate may be passed through the filter media.

In some embodiments, the filter media is an air filter. For example, in certain cases, the filter media is a high efficiency particulate air (HEPA) or ultra-low penetration air (ULPA) filter. These filters are required to remove particulates at an efficiency level specified by EN1822:2009. In some embodiments, the filter media removes particulates at an efficiency of greater than 99.95% (H 13), greater than 99.995% (H 14), greater than 99.9995% (U 15), greater than 99.99995% (U 16), or greater than 99.999995% (U 17). For example, in some embodiments, an ULPA U15 filter media disclosed herein has an efficiency of greater than 99.9995% at 0.12 micron particle sizes (or 0.09 micron particle sizes). As another example, in certain embodiments, a HEPA H14 filter media disclosed herein has an efficiency of greater than 99.995% at 0.2 micron particle size (e.g., or 0.1 micron particle size or 0.09 micron particle size). In some embodiments, the filter media may be suitable for HVAC applications. For HVAC applications, the efficiency may be measured according to ISO 16890 (2016) at 0.3 microns. That is, the filter media may have a particulate efficiency of greater than or equal to about 10% and less than or equal to about 90% or greater than or equal to about 35% and less than or equal to about 90%. In certain embodiments, the filter media is a cabin filter. According to some embodiments, the filter media is a gas turbine filter.

In some embodiments, the filter media is post-processed. For example, in certain embodiments, the filter media is corrugated (e.g., to increase surface area). In some embodiments, the filter media is embossed. In certain cases, the filter media is waved. Examples of waved filter media are disclosed in International Patent Application Number PCT/US2008/055088, filed Feb. 27, 2008, which published as WO 2008/106490, and in International Patent Application Number PCT/US2018/023518, filed Mar. 21, 2018, which published as WO 2018/175550, and which are hereby incorporated by reference in their entireties.

In some embodiments, the filter media may be a component of a filter element. That is, the filter media may be incorporated into an article suitable for use by an end user. Non-limiting examples of suitable filter elements include flat panel filters, pocket filters, V-bank filters (comprising, e.g., between 1 and 24 Vs), cartridge filters, cylindrical filters, conical filters, and curvilinear filters. Filter elements may have any suitable height (e.g., between 2 inches and 124 inches for flat panel filters, between 4 inches and 124 inches for V-bank filters, between 1 inch and 124 inches for cartridge and cylindrical filter media). Filter elements may also have any suitable width (between 2 inches and 124 inches for flat panel filters, between 4 inches and 124 inches for V-bank filters). Some filter media (e.g., cartridge filter media, cylindrical filter media) may be characterized by a diameter instead of a width; these filter media may have a diameter of any suitable value (e.g., between 1 inch and 124 inches). Filter elements typically comprise a frame, which may be made of one or more materials such as cardboard, aluminum, steel, alloys, wood, and polymers.

In some embodiments, the filter media (e.g., in a filter element) may be pleated (e.g., rotary pleated and/or blade pleated). In some embodiments, the pleat height may be greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height may be less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, or less than or equal to 15 mm. Combinations of the above-referenced ranges are also possible (e.g., greater than or equal to 10 mm and less than or equal to 510 mm, or greater than or equal to 10 mm and less than or equal to 100 mm). Other ranges are also possible.

In some embodiments, the filter media (e.g., in a filter element) may have a pleat density (number of pleats per unit length of the media) of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media may have a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 100 pleats per 100 mm, greater than or equal to 6 pleats per 100 mm and less than or equal to 100 pleats per 100 mm, greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between ¼ inch and 24 inches, and/or pleat densities between 1 and 50 pleats/inch. As another example, filter media within cartridge filters or conical filters may have pleat heights between ¼ inch and 24 inches and/or pleat densities between ½ and 100 pleats/inch. In some embodiments, pleats may be separated by a pleat separator made of, e.g., polymer, glass, aluminum, and/or cotton. In other embodiments, the filter element may lack a pleat separator. The filter media may be wire-backed, or it may be self-supporting.

In some embodiments, the filter media and/or filter element (e.g., after pleating) is substantially free of cracks (e.g., cracks are less than or equal to 1%, less than or equal to 0.5%, less than or equal to 0.1%, or less than or equal to 0.01% of the area of the filter media and/or filter media) or free of cracks. In some embodiments, the filter media and/or filter element (e.g., after pleating) is substantially free of pinholes (e.g., pinholes are less than or equal to 1%, less than or equal to 0.5%, less than or equal to 0.1%, or less than or equal to 0.01% of the area of the filter media and/or filter media) or free of pinholes.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

In one set of embodiments, the filter media described herein is incorporated into a filter element having a cylindrical configuration, which may be suitable for hydraulic and other applications. The cylindrical filter element may include a steel support mesh that can provide pleat support and spacing, and which protects against media damage during handling and/or installation. The steel support mesh may be positioned as an upstream and/or downstream layer. The filter element can also include upstream and/or downstream support layers that can protect the filter media during pressure surges. These layers can be combined with filter media 10, which may include two or more layers as noted above.

In one set of embodiments, a filter media described herein is incorporated into a fuel filter element (e.g., a cylindrical fuel filter element). Fuel filter elements can be of varying types, e.g., fuel filter elements to remove particulates, fuel-water separators to remove water from diesel fuel, and fuel filter elements that perform both particulate separation and water separation. The fuel filter element may be a single stage element or multiple stage element. In some cases, the media can be pleated or wrapped, supported or unsupported, cowrapped/copleated with multiple media. In some designs, the media is pleated with a wrapped core in the center.

In some embodiments, a filter media described herein is incorporated into a fuel-water separator. A fuel-water separator may have a bowl-like design which collects water at the bottom. Depending on the water collection, the water may be collected upstream, downstream, or on both sides of the collection bowl. The water can then be drained off by opening a valve at the bottom of the bowl and letting the water run out, until the bowl contains only fuel/diesel. In some embodiments, the fuel-water separator may include a water sensor to signal the engine control unit, or to signal the driver directly, if the water reaches a warning level. The fuel-water separator may also include a sensor, which can alert the operator when the filter needs to be drained. In some cases, a heater may be positioned near the filter to help avoid the forming of paraffin wax (in case of low temperatures) inside the filter which can stop fuel flow to the engine.

The filter element may also have any suitable dimensions. For example, the filter element may have a length of at least 15 inches, at least 20 inches, at least 25 inches, at least 30 inches, at least 40 inches, or at least 45 inches. The surface area of the filter media may be, for example, at least 220 square inches, at least 230 square inches, at least 250 square inches, at least 270 square inches, at least 290 square inches, at least 310 square inches, at least 330 square inches, at least 350 square inches, or at least 370 square inches.

The filter elements may have the same property values as those noted above in connection with the filter media.

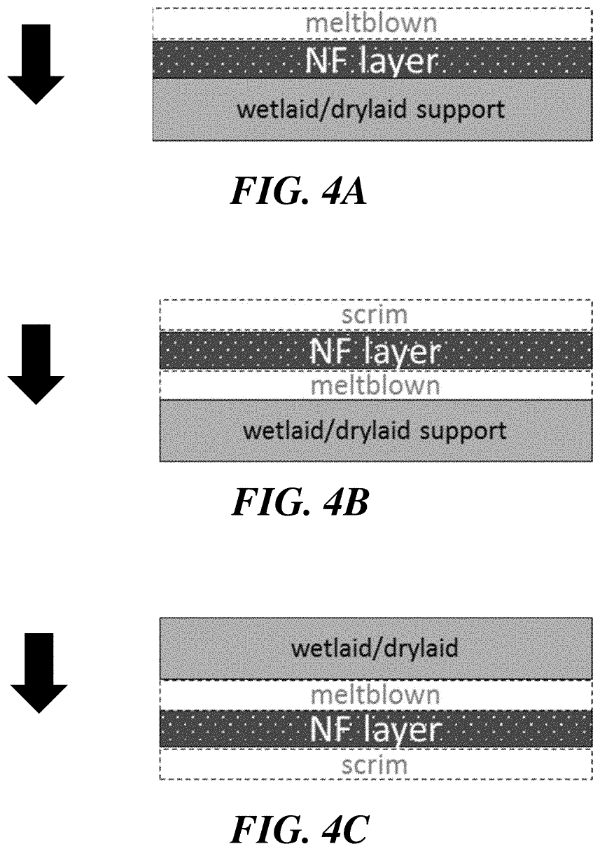

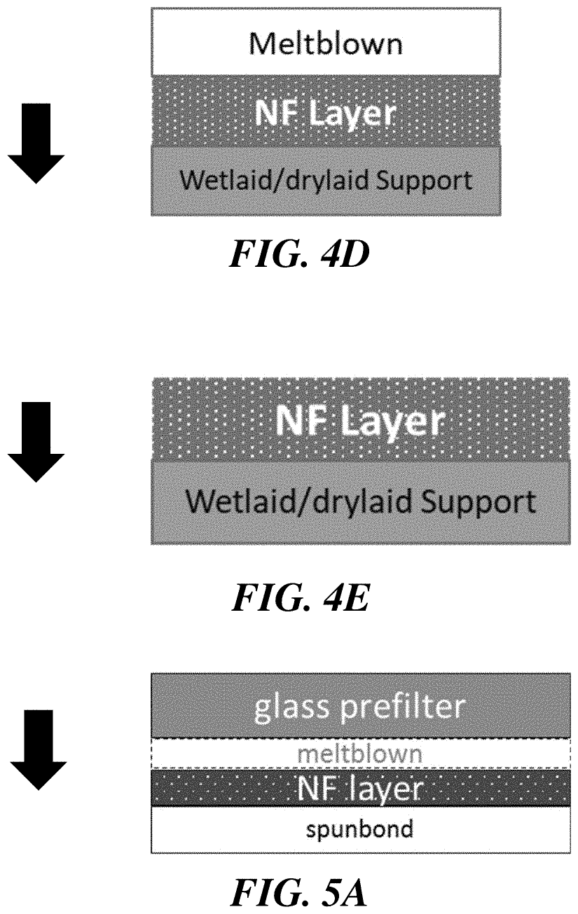

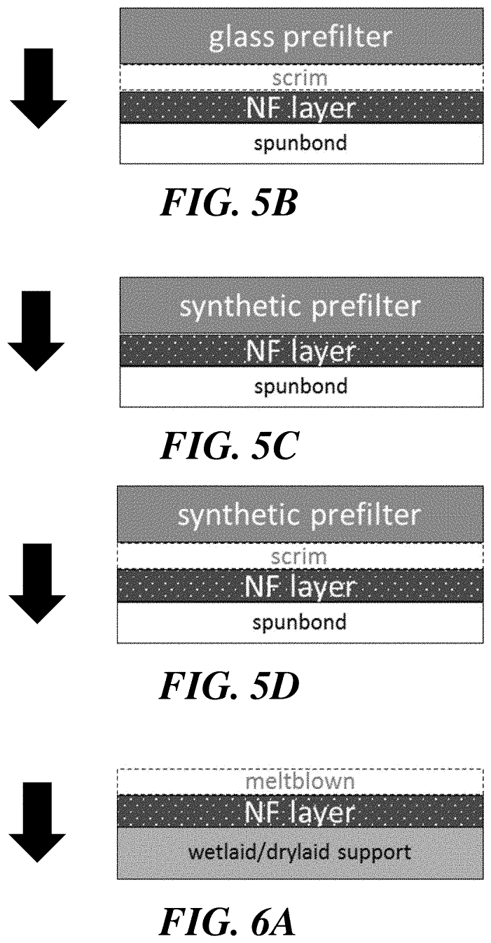

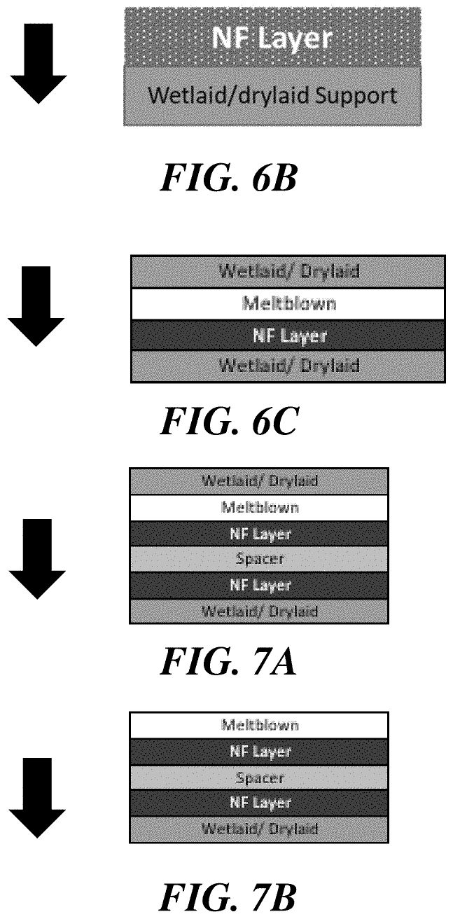

The filter media described herein may have a variety of suitable designs and a variety of suitable arrangements of the layers therein. Non-limiting examples of designs suitable for fuel filters are shown in FIGS. 4A-4E, non-limiting examples of designs suitable for hydraulic fluid filters are shown in FIGS. 5A-5D, non-limiting examples of designs suitable for HEPA filters are shown in FIGS. 6A-6C, and non-limiting examples of designs suitable for ULPA filters are shown in FIGS. 7A-7B. It should be noted that these designs may also be suitable for other purposes. For example, in some cases, any design in FIGS. 4A-7B may be suitable as a fuel filter, hydraulic fluid filter, HEPA filter, and/or ULPA filter. The arrows shown in FIGS. 4A-4E, 5A-5D, 6A-6C, and 7A-7B indicate the direction in which the fluid would flow through the filter media. Other configurations are also possible.

For example, in some cases, the filter media comprises a synthetic layer (e.g., a synthetic backer), a fine fiber layer, and a meltblown layer (e.g., a charged meltblown layer). As another example, in certain embodiments, the filter media comprises a meltblown layer (e.g., a charged meltblown layer), a fine fiber layer, a synthetic layer (e.g., a synthetic backer), and a fine fiber layer. As yet another example, in some embodiments, the filter media comprises a synthetic layer (e.g., a synthetic backer), a meltblown layer (e.g., a charged meltblown layer), a fine fiber layer, a synthetic layer (e.g., a synthetic backer), and a fine fiber layer.

In some embodiments, two or more of the supplemental layers are each independently wetlaid or drylaid. For example, in certain cases, the first and last (e.g., the first and sixth layers or the first and fourth layers) supplemental layers are each independently wetlaid or drylaid. In some instances, one or more of the supplemental layers (e.g., the second layer) comprises meltblown fibers. According to certain embodiments, one or more of the supplemental layers (e.g., the fourth layer) is a spacer. In accordance with some embodiments, one or more of the supplemental layers (e.g., the third layer and/or the fifth layer (comprises fine fibers. In some cases, one or more of the supplemental layers is a fine fiber layer (e.g., having any properties disclosed herein for fine fiber layers). In some instances, the filter media comprises one or more fine fiber layers. In certain embodiments, the one or more fine fiber layers are each separated by a spacer layer. In certain cases, the fine fiber layers are the same.

In certain embodiments, the first layer and sixth layer are each independently wetlaid or drylaid, the second layer comprises meltblown fibers, the third layer is a fine fiber layer (e.g., a fine fiber layer disclosed herein), the fourth layer is a spacer, the fifth layer is the same as the fine fiber third layer, and the second layer is in between the first and third layers, the third layer is in between the second and fourth layers, the fourth layer is in between the third and fifth layers, and the fifth layer is in between the fourth and sixth layers.

In some embodiments, the first layer and the fourth layer are each independently wetlaid or drylaid, the second layer comprises meltblown fibers, the third layer is a fine fiber layer (e.g., a fine fiber layer disclosed herein), the second layer is in between the first layer and the third layer, and the third layer is in between the second layer and the fourth layer.

Properties of some exemplary layers that may be included in filter media are described below in Table 4, and further properties of some exemplary filter media including these layers are described below in Tables 5-8. The properties in Tables 5-8 may generally be measured as described elsewhere herein.

The initial efficiency at 1.5 microns may be determined in accordance with ISO 19438 (2003) using ISO fine test dust (A2), where the initial efficiency at 1.5 microns is the efficiency at 1.5 microns measured when the pressure drop reaches 5 kPa (5% of the terminal value of 100 kPa).

The average fuel-water separation efficiency may be measured in accordance with the SAEJ1488 (2010) test. The test involves sending a sample of fuel (ultra-low sulfur diesel fuel) with controlled water content (2500 ppm) through a pump across the media at a face velocity of 0.069 cm/sec. The water is emulsified into fine droplets by a centrifugal pump operating at 3500 rpm, after which it is sent to challenge the media. The water is coalesced, shed, or both coalesced and shed, and collects at the bottom of the housing. The water content of the sample is measured via Karl Fischer titration both upstream and downstream of the media. The fuel-water separation efficiency is the amount of water removed from the fuel-water mixture and is equivalent to (1−C/2500)*100%, where C is the downstream concentration of water. The average efficiency is the average of the efficiencies measured during a 150 minute test. The first measurement of the sample upstream and downstream of the media is taken at 10 minutes from the start of the test. Then, measurement of the sample downstream of the media is taken every 20 minutes until 150 minutes have elapsed from the beginning of the test. The pressure of the sample upstream and downstream of the filter media is also measured at these points in time.

The micron rating for a beta 200 efficiency may be determined by performing a Multipass Filter Test following the ISO 16889 (2008) procedure (modified by testing a flat sheet sample) on a Multipass Filter Test Stand manufactured by FTI. The measurement may be made by flowing a test fluid comprising ISO A3 Medium test dust manufactured by PTI, Inc. at an upstream gravimetric dust level of 10 mg/liter in Aviation Hydraulic Fluid AERO HFA MIL H-5606A manufactured by Mobil through the filter media at a flow rate of 1.7 L/min until a terminal pressure drop of 172 kPa is reached.

TABLE 4
Exemplary layers

| | | | Mean | | Average | |
|---|---|---|---|---|---|---|
| | | | flow pore | Basis | fiber | |
| Type of | Fiber | Air perm. | size | weight | diameter | Elongation |
| layer | composition | (CFM) | (microns) | (gsm) | (microns) | at break |
| Fine fiber | Matrix | Any air | Any mean | Any basis | Any average | Any |
| layer | Polymer and | perm, | flow pore | weight | fiber | elongation |
| | Impact | disclosed | size | disclosed | diameter | at break |
| | Modifier | herein | disclosed | herein | disclosed | disclosed |
| | | (e.g., 0-100, | herein | (e.g., | herein | herein |
| | | 0.1-50, | (e.g., 0-50) | 0.001-20, | (e.g., | (e.g., |
| | | or −.5-30) | | 0.01-10, | 0.01-6, | 5-300%) |
| | | | | or 0.1-5) | 0.01-1, | |
| | | | | | 0.01-0.5, | |
| | | | | | 0.025-1, | |
| | | | | | or 0.05-0.3) | |
| Meltblown | Nylon, | 0.5-10 or | 0.1-15 or | 5-100 or | 0.5-10 | 1%-50% |
| (may be | polypropylene, | 5-100 | 3-25 | 10-100 | | |
| calendered) | and/or | | | | | |
| (properties | poly(butylene | | | | | |
| may be for | terephthalate) | | | | | |
| each | | | | | | |
| individual | | | | | | |
| meltblown | | | | | | |
| layer or a | | | | | | |
| combination | | | | | | |
| of multiple | | | | | | |
| meltblown | | | | | | |
| layers) | | | | | | |
| Wetlaid/ | Synthetic, | 20-200 | 15-100 | 50-200 | 1-30 | 1%-20% |
| drylaid | glass, and/ | | | | | |
| layer/ | or cellulose | | | | | |
| support | | | | | | |
| (may be | | | | | | |
| spunbond, | | | | | | |
| meltblown, | | | | | | |
| or carded) | | | | | | |
| Scrim (may | Poly(ester), | 50-8000 | 30-200 | 5-50 | 1-30 | 1%-50% |
| be spunbond | Nylon, and/ | | | | | |
| or meltblown) | or other | | | | | |
| | polymers | | | | | |
| Synthetic | Poly(ester), | 5-100 | 3-25 | 5-100 | 0.5-30 | 1%-50% |
| prefilter | Nylon, and/ | | | | | |
| (may be | or other | | | | | |
| wetlaid or | polymers; | | | | | |
| meltblown) | may be a | | | | | |
| | combination | | | | | |
| | of coarser and | | | | | |
| | finer fibers | | | | | |
| Glass | Glass | 5-100 | 3-25 | 5-100 | 0.5-30 | 1%-50% |
| prefilter | | | | | | |
| Spunbond | | 5-8000 | 30-200 | 5-50 | 1-30 | 1%-50% |
| Spacer | Nylon, | 0.5-10, | 0.1-15, | 5-100, | 0.5-10 | 1%-50% |
| | polypropylene, | 5-100, | 3-25, or | 10-100, | or 1-30 | |
| | poly(butylene | 5-8000, or | 30-200 | or 5-50 | | |
| | terephthalate), | 50-8000 | | | | |
| | poly(ester), | | | | | |
| | and/or other | | | | | |
| | polymers | | | | | |

TABLE 5
Exemplary Fuel Filter Media

| | Arrangement | | | | | |
|---|---|---|---|---|---|---|
| | of layers | | | | | |
| | (from upstream | | Initial | Dust | Fuel- | Mean |
| | surface to | Air | efficiency | holding | water | flow pore |
| Design | downstream | permeability | at 1.5 | capacity | separation | size |
| no. | surface) | (CFM) | microns | (gsm) | efficiency | (microns) |
| 1 | 1-7 | 0.5-15 | 90%-99.99% | 50-300 | 80%-100% | 0.1-15 |
| (shown | meltblown | | | | | |
| in FIG. | layers | | | | | |
| 4A) | Fine fiber | | | | | |
| | layer (e.g., | | | | | |
| | any fine fiber | | | | | |
| | layer disclosed | | | | | |
| | herein) | | | | | |
| | Wetlaid or | | | | | |
| | drylaid layer | | | | | |
| 2 | Scrim | 0.5-15 | 90%-99.99% | 50-300 | 80%-100% | 0.1-15 |
| (shown | Fine fiber | | | | | |
| in FIG. | layer (e.g., | | | | | |
| 4B) | any fine fiber | | | | | |
| | layer disclosed | | | | | |
| | herein) | | | | | |
| | 1-7 | | | | | |
| | meltblown | | | | | |
| | layers | | | | | |
| | Wetlaid or | | | | | |
| | drylaid layer | | | | | |
| 3 | Wetlaid or | 0.5-15 | 90%-99.99% | 50-300 | 80%-100% | 0.1-15 |
| (shown | drylaid layer | | | | | |
| in FIG. | 1-7 | | | | | |
| 4C) | meltblown | | | | | |
| | layers | | | | | |
| | Fine fiber | | | | | |
| | layer (e.g., | | | | | |
| | any fine fiber | | | | | |
| | layer disclosed | | | | | |
| | herein) | | | | | |
| | Scrim | | | | | |
| 4 | 1-7 | 0.5-15 | 90%-99.99% | 50-300 | 80%-100% | 0.1-15 |
| (shown | meltblown | | | | | |
| in FIG. | layers | | | | | |
| 4D) | Fine fiber | | | | | |
| | layer (e.g., | | | | | |
| | any fine fiber | | | | | |
| | layer disclosed | | | | | |
| | herein) | | | | | |
| | Wetlaid or | | | | | |
| | drylaid layer | | | | | |
| 5 | Fine fiber | 0.5-15 | 90%-99.99% | 50-300 | 80%-100% | 0.1-15 |
| (shown | layer (e.g., | | | | | |
| in FIG. | any fine fiber | | | | | |
| 4E) | layer disclosed | | | | | |
| | herein) | | | | | |
| | Wetlaid or | | | | | |
| | drylaid layer | | | | | |

TABLE 6
Exemplary Hydraulic Filter Media

| | | | | | | Able to withstand |
|---|---|---|---|---|---|---|
| | Arrangement | | | | | Multipass Filter |
| | of layers | | | | | Test following |
| | (from | | Micron | | | the ISO 16889 |
| | upstream | | rating for | Dust | Mean | (2008) procedure |
| | surface to | Air | beta 200 | holding | flow pore | (modified by |
| Design | downstream | permeability | efficiency | capacity | size | testing a flat |
| no. | surface) | (CFM) | (microns) | (gsm) | (microns) | sheet sample) |
| 6 | Glass | 10-50 | 2-12 | 100-300 | 0.5-15 | Yes |
| (shown | prefilter | | | | | |
| in FIG. | (single phase | | | | | |
| 5A) | or dual phase) | | | | | |
| | 1-7 | | | | | |
| | meltblown | | | | | |
| | layers | | | | | |
| | Fine fiber | | | | | |
| | layer (e.g., | | | | | |
| | any fine fiber | | | | | |
| | layer disclosed | | | | | |
| | herein) | | | | | |
| | Spunbond | | | | | |
| | layer | | | | | |
| 7 | Glass | 10-50 | 2-12 | 100-300 | 0.5-15 | Yes |
| (shown | prefilter | | | | | |
| in FIG. | (single phase | | | | | |
| 5B) | or dual phase) | | | | | |
| | Scrim | | | | | |
| | Fine fiber | | | | | |
| | layer (e.g., | | | | | |
| | any fine fiber | | | | | |
| | layer disclosed | | | | | |
| | herein) | | | | | |
| | Spunbond | | | | | |
| | layer | | | | | |
| 8 | 1-7 synthetic | 10-50 | 2-15 | 100-300 | 0.5-15 | Yes |
| (shown | prefilters | | | | | |
| in FIG. | Fine fiber | | | | | |
| 5C) | layer (e.g., | | | | | |
| | any fine fiber | | | | | |
| | layer disclosed | | | | | |
| | herein) | | | | | |
| | Spunbond | | | | | |
| 9 | 1-7 synthetic | 10-50 | 2-12 | 100-300 | 0.5-15 | Yes |
| (shown | prefilters | | | | | |
| in FIG. | Scrim | | | | | |
| 5D) | Fine fiber | | | | | |
| | layer (e.g., | | | | | |
| | any fine fiber | | | | | |
| | layer disclosed | | | | | |
| | herein) | | | | | |
| | Spunbond | | | | | |
| | layer | | | | | |

TABLE 7
Exemplary HEPA Filter Media

| | Arrangement | | | | |
|---|---|---|---|---|---|
| | of layers | | | | |
| | (from | | | | |
| | upstream | Air | | | |
| | surface to | perme- | | | Mean flow |
| Design | downstream | ability | MPPS | MPPS | pore size |
| no. | surface) | (CFM) | penetration | gamma | (microns) |
| 10 | Meltblown layer | 0.5-15 | 0.000001%-1% | 30-120 | 0.1-15 |
| (shown | Fine fiber layer | | | | |
| in FIG. | (e.g., any fine fiber | | | | |
| 6A) | layer disclosed | | | | |
| | herein) | | | | |
| | Wetlaid or drylaid | | | | |
| | layer | | | | |
| 11 | Fine fiber layer | 0.5-15 | 0.000001%-1% | 30-120 | 0.1-15 |
| (shown | (e.g., any fine fiber | | | | |
| in FIG. | layer disclosed | | | | |
| 6B) | herein) | | | | |
| | Wetlaid or drylaid | | | | |
| | layer | | | | |
| 12 | Wetlaid or drylaid | 0.5-15 | 0.000001%-1% | 30-120 | 0.1-15 |
| (shown | layer | | | | |
| in FIG. | Meltblown layer | | | | |
| 6C) | Fine fiber layer | | | | |
| | (e.g., any fine fiber | | | | |
| | layer disclosed | | | | |
| | herein) | | | | |
| | Wetlaid or drylaid | | | | |
| | layer | | | | |

TABLE 8
Exemplary ULPA Filter Media

| | Arrangement | | | | |
|---|---|---|---|---|---|
| | of layers | | | | |
| | (from | | | | |
| | upstream | Air | | | |
| | surface to | perme- | | | Mean flow |
| Design | downstream | ability | MPPS | MPPS | pore size |
| no. | surface) | (CFM) | penetration | gamma | (microns) |
| 13 (as | Wetlaid or | 0.05-12 | 0.000001%-1% | 20-110 | 0.01-10 |
| shown in | drylaid layer | | | | |
| FIG. 7A) | Meltblown | | | | |
| | layer | | | | |
| | Fine fiber | | | | |
| | layer (e.g., | | | | |
| | any fine | | | | |
| | fiber layer | | | | |
| | disclosed | | | | |
| | herein) | | | | |
| | Spacer | | | | |
| | Fine fiber | | | | |
| | layer (e.g., | | | | |
| | any fine | | | | |
| | fiber layer | | | | |
| | disclosed | | | | |
| | herein) | | | | |
| | Wetlaid or | | | | |
| | drylaid layer | | | | |
| 14 (as | Meltblown | 0.05-12 | 0.000001%-1% | 20-110 | 0.01-10 |
| shown in | layer | | | | |
| FIG. 7B) | Fine fiber | | | | |
| | layer (e.g., | | | | |
| | any fine | | | | |
| | fiber layer | | | | |
| | disclosed | | | | |
| | herein) | | | | |
| | Spacer | | | | |
| | Fine fiber | | | | |
| | layer (e.g., | | | | |
| | any fine | | | | |
| | fiber layer | | | | |
| | disclosed | | | | |
| | herein) | | | | |
| | Wetlaid or | | | | |
| | drylaid layer | | | | |

The following examples are intended to illustrate certain embodiments of the present invention, but do not exemplify the full scope of the invention.

### Example 1

This example characterizes the elongation at break, tensile strength, and toughness of fine fiber layers comprising fine fibers with and without an impact modifier.

Five fine fiber layers were characterized:
Sample A comprised fine fibers comprising an impact modifier (which was a block copolymer of Nylon 11 and polyethylene oxide) without a matrix polymer;
Sample B comprised fine fibers comprising a matrix polymer (which was polyamide 6) without an impact modifier;
Sample C comprised fine fibers comprising a matrix polymer (which was polyamide 6) with 10 wt. % of the matrix polymer replaced with impact modifier X (a copolymer of polyamide 6 and polyethylene oxide);
Sample D comprised fine fibers comprising a matrix polymer (which was polyamide 6) with 10 wt. % of the matrix polymer replaced with impact modifier Y (a copolymer of multiple types of polyamides); and
Sample E comprised fine fibers comprising a matrix polymer (which was polyamide 6) with 10 wt. % of the matrix polymer replaced with impact modifier Z (a different copolymer of multiple types of polyamides).

These fine fiber layers were identical other than the absence or presence of the same matrix polymer, and the absence or presence of an impact modifier (which, when present, reduced the amount of matrix polymer present).

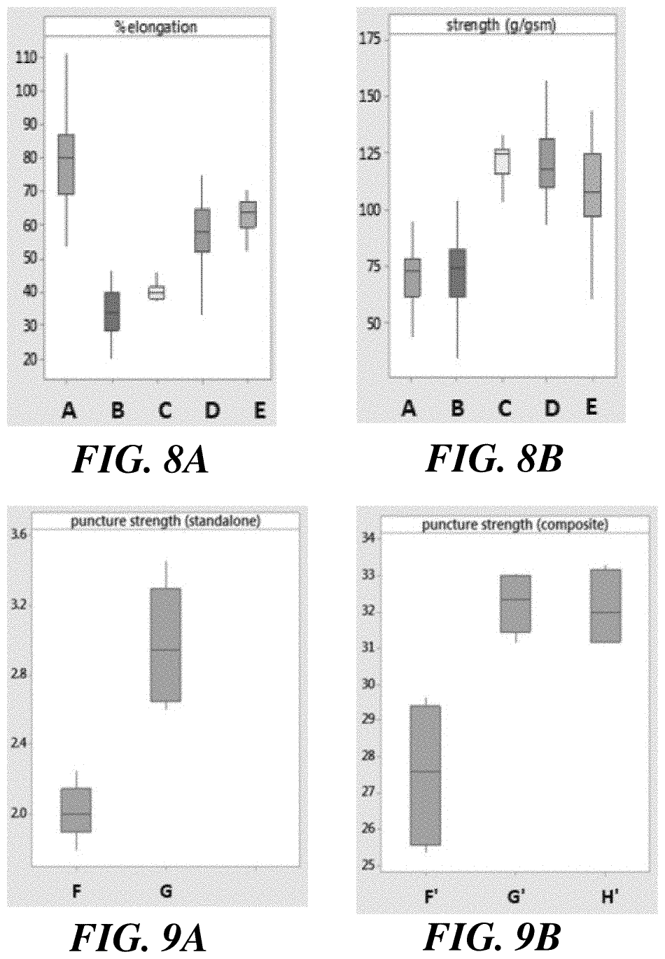

As shown in FIG. 8A, the samples with an impact modifier in addition to the matrix polymer (i.e., Samples C-E) had higher elongation at break than the sample with just the matrix polymer (i.e., Sample B). Further, as shown in FIG. 8B, the samples with an impact modifier in addition to the matrix polymer (i.e., Samples C-E) had higher tensile strength than the sample with just the matrix polymer (i.e., Sample B). While the sample with just the impact modifier (i.e., Sample A) had higher elongation at break than the samples with the combination of an impact modifier and a matrix polymer (i.e., Samples C-E), the samples with the combination of an impact modifier and a matrix polymer (i.e., Samples C-E) had higher tensile strength, demonstrating that the combination of an impact modifier with a matrix polymer has an improved balance of tensile strength and elongation at break than either an impact modifier alone or a matrix polymer alone. The elongation at break and tensile strength were determined as described above in the context of the fine fiber layer.

The toughness of Sample B and Sample D was also characterized according to T494 om-96. The toughness of Sample B (which did not have an impact modifier) was 46 g/gsm while the toughness of Sample D (which did have an impact modifier) was 98 g/gsm. Thus, the addition of the impact modifier improved the toughness by 104%.

Overall, this example unexpectedly demonstrates that the addition of the impact modifier improved the elongation at break, the tensile strength, and the toughness. Without wishing to be bound by any theory, it is believed that the improvement in both elongation at break and tensile strength is unexpected, as an increase in tensile strength frequently results in reduced elongation at break, while an increase in elongation at break frequently results in reduced tensile strength.

### Example 2

This example characterizes the average puncture strength, gamma, and salt loading of filter media comprising fine fiber layers comprising fine fibers with and without an impact modifier.

The following fine fiber layers were manufactured:
Sample F comprised fine fibers comprising a matrix polymer (which was polyamide 6) without an impact modifier;
Sample G comprised fine fibers comprising a matrix polymer (which was polyamide 6) with 10 wt. % of the matrix polymer replaced with impact modifier Y (a copolymer of multiple types of polyamides); and
Sample H comprised fine fibers comprising a matrix polymer (which was polyamide 6) with 20 wt. % of the matrix polymer replaced with impact modifier Y (a copolymer of multiple types of polyamides).

These fine fiber layers were identical other than the absence or presence of the same impact modifier (which, when present, reduced the amount of matrix polymer present). The fiber diameters of Samples F-H were characterized using scanning electron microscopy (SEM). It was determined that the average fiber diameter of Sample F was 74 nanometers, the average fiber diameter of Sample G was 87 nm, and the average fiber diameter of Sample H was 90 nm. Therefore, the average fiber diameter increased as the amount of impact modifier increased, but the addition of the impact modifier did not significantly affect the average fiber diameter at the amounts tested. Without wishing to be bound by any theory, it is believed that the lack of significant change in fiber diameter upon addition of the impact modifier allows filtration performance to be maintained (as discussed below).

Samples with higher amounts of impact modifier were also tested. For example, samples with 30 wt. % impact modifier and higher were tested. It was found that when 30 wt. % or more impact modifier was used in an electrospinning process to form fibers, the impact modifier was no longer sufficiently soluble, such that a gel formed. Attempts to increase solubility of the impact modifier by modifying the amounts of solvents were made, but this was found to negatively affect throughput. Moreover, the resulting fibers had increased fiber diameter (which resulted in poor filtration performance), were not uniform, and had numerous pin holes (which reduced filtration performance and weakened the fine fiber layers, negating the benefits of adding impact modifier). Accordingly, without wishing to be bound by theory, it is believed that, in some embodiments, a fine fiber layer wherein the weight percent of the impact modifier in the fine fibers is greater than or equal to 1 wt. % and less than or equal to 25 wt. % of the combination of the impact modifier and the matrix polymer has higher filtration performance, higher strength, higher throughput, fewer pin holes, and/or lower fiber diameter than fine fiber layers with higher amounts of impact modifier, all other factors being equal, and that a fine fiber layer wherein the weight percent of the impact modifier in the fine fibers is greater than or equal to 1 wt. % and less than or equal to 15 wt. % of the combination of the impact modifier and the matrix polymer is most preferred.

Additionally, the void volumes of Samples F and G were characterized as disclosed elsewhere herein. The results demonstrated that Sample G had 40% higher void volume than Sample F.

Three filter media comprising these fine fibers layers were characterized. Each of these filter media were three-layer structures with a synthetic backer layer, the fine fiber layer (Sample F′—a filter media comprising Sample F as the fine fiber layer, Sample G′—a filter media comprising Sample G as the fine fiber layer, and Sample H′—a filter media comprising Sample H as the fine fiber layer), and a charged meltblown layer. The three filter media were identical other than that their fine fiber layers differed as shown above.

As shown in FIG. 9A, the fine fiber layer with the impact modifier (i.e., Sample G) had a higher average puncture strength (N) than the fine fiber layer without the impact modifier (i.e., Sample F). As shown in FIG. 9B, the filter media with fine fiber layers with the impact modifier (i.e., Samples G′ and H′) had a higher average puncture strength (N) that the filter media with a fine fiber layer without the impact modifier (i.e., Sample F′). Accordingly, this example demonstrates that addition of the impact modifier increased puncture strength. The average puncture strength was measured according to BCIS 03B-35.

Further, the gammas of Samples F′ and G′ were characterized. Gamma was tested as disclosed elsewhere herein. Sample F′ had a gamma of 66.2 at U15 efficiency (efficiency of greater than 99.9995% as determined by EN1822:2009), while Sample G′ had an average gamma of 63.2 at U15 efficiency (efficiency of greater than 99.9995% as determined by EN1822:2009). Similarly, the gamma of Sample F′ had a gamma of 73.6 when tested at H14 efficiency (efficiency of greater than 99.995% as determined by EN1822:2009), while Sample G′ had an average gamma of 74.25 when tested at H14 efficiency (efficiency of greater than 99.995% as determined by EN1822:2009). This demonstrates that the addition of the impact modifier did not significantly affect the filtration properties, while increasing mechanical properties (e.g., the average puncture strength, elongation at break, and tensile strength), as shown in Examples 1-2.

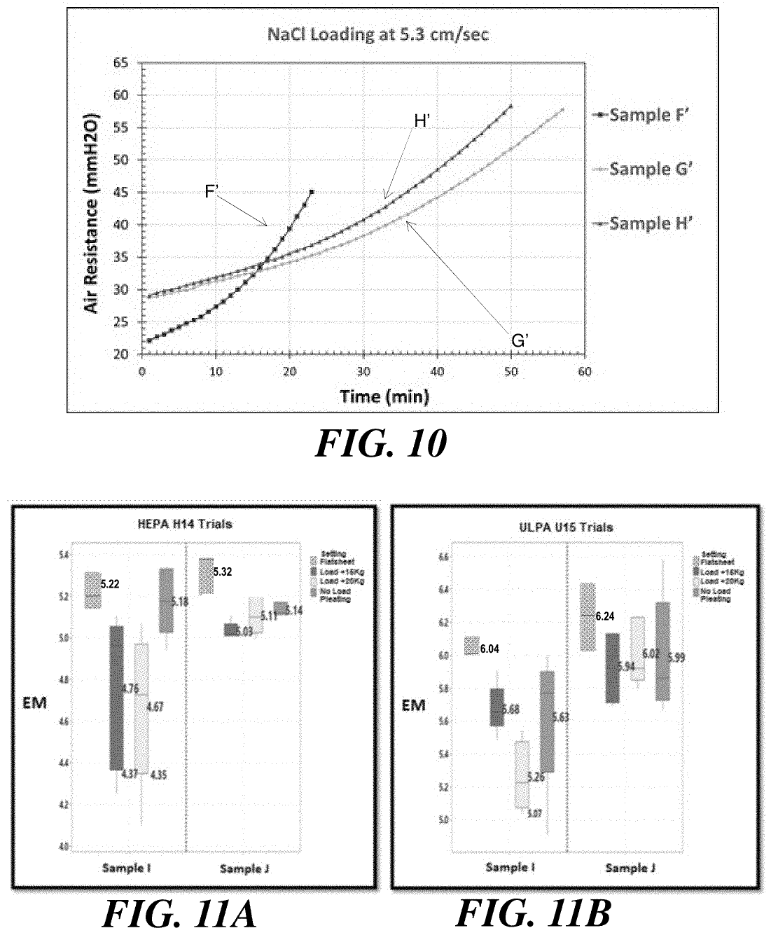

Additionally, the salt (NaCl) loading for Samples F′, G′, and H′ were tested. Salt loading was tested as disclosed elsewhere herein. The salt was added at 5.3 cm/sec and the air resistance was measured. As shown in FIG. 10, the salt loading for Samples G′ and H′ (which included the impact modifier) was about twice as high as that of Sample F′ (which did not include an impact modifier) as it took about twice the time for the air resistance to double for Samples G′ and H′ than for Sample F′. Similarly, the oil loading was tested (as disclosed elsewhere herein). The results demonstrated that Sample G′ had 40% higher oil loading than sample F′. Without wishing to be bound by any theory, it is believed that the higher void volume of the samples with the impact modifier resulted in higher salt (and/or oil) loading. Similarly, without wishing to be bound by any theory, it is believed that higher salt (and/or oil) loading increases the life of the filter media.

### Example 3

This example characterizes the pleating capabilities of filter media comprising fine fiber layers comprising fine fibers with and without an impact modifier.

Three-layer filter media were tested having a first charged meltblown layer, a second fine fiber layer, and a third synthetic backer layer. The filter media differed only in the compositions of the fine fiber layers.
For Sample I, the fine fiber layers comprised fine fibers comprising a matrix polymer (which was polyamide 6) without an impact modifier;
For Sample J, the fine fiber layers comprised fine fibers comprising a matrix polymer (which was polyamide 6) with 10 wt. % of the matrix polymer replaced with impact modifier Y (a copolymer of multiple types of polyamides).

The efficiency metric (EM) (where EM=−log₁₀(penetration %/100)) was measured for Samples I and J under various blade pleating conditions (i.e., flatsheet, load+15 kg, load+20 kg, or no load pleating). As shown in FIGS. 11A and 11B, Sample J (with the impact modifier) maintained efficiency at all different blade pleating conditions, while the efficiency of Sample I (without the impact modifier) dropped at loads of 15 kg and 20 kg. Penetration was measured as disclosed elsewhere herein after the pleated samples were unfolded.

The rotary pleating capabilities of Samples I and J were also characterized. It was found that Sample I (without an impact modifier) failed (i.e., did not meet the EM target) under heavy crease conditions (with no heat), while Sample J maintained sufficient EM at all tested conditions (i.e., heavy crease no heat and max crease no heat).

Similar results were obtained for four-layer filter media having a first synthetic backer layer, a second charged polypropylene meltblown layer, a third fine fiber layer, and a fourth synthetic backer layer, where the filter media differed only in the compositions of the fine fiber layers.
For Sample K, the fine fiber layers comprised fine fibers comprising a matrix polymer (which was polyamide 6) without an impact modifier;
For Sample L, the fine fiber layers comprised fine fibers comprising a matrix polymer (which was polyamide 6) with 10 wt. % of the matrix polymer replaced with impact modifier Y (a copolymer of multiple types of polyamides).

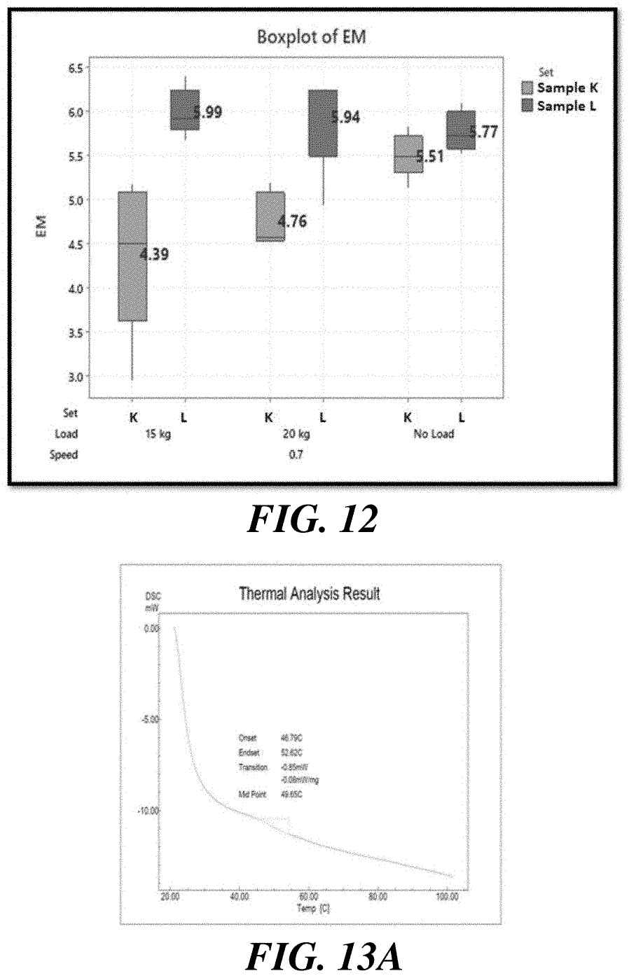

As shown in FIG. 12 (where efficiency metric (EM) is the Y axis, and EM=−log₁₀(penetration %/100), where penetration is measured as disclosed elsewhere herein)), Sample L (with the impact modifier) maintained efficiency at all different blade pleating conditions, while the efficiency of Sample K (without the impact modifier) dropped at loads of 15 kg and 20 kg.

Without wishing to be bound by any theory, it is believed that the increase in both elongation at break and tensile strength improved pleating (e.g., rotary and/or blade pleating).

### Example 4

This example demonstrates that in a fine fiber layer comprising fine fibers comprising an impact modifier and a matrix polymer, the impact modifier and matrix polymer were present as a physical blend.

Sample G (which comprised an impact modifier soluble in alcohol and a matrix polymer that was not soluble in alcohol) was extracted using alcohol for 19 hours. The impact modifier was quantitatively removed (9.5% was removed of the 10% present) and its identity was confirmed by FTIR. This demonstrates that the impact modifier and matrix polymer were present as a physical blend.

Sample G was also analyzed by DSC. As the temperature was increased from −50° C. to 300° C., a peak was observed for the melting of the matrix polymer. As the sample cooled from 300° C. back to 50° C., a peak was observed for the recrystallization of the matrix polymer. The peak observed for the melting of the matrix polymer was again observed as the sample was again heated from 50° C. to 300° C. The fact that these peaks were observed each time the sample was heated or cooled confirmed that they were in fact melting and recrystallization peaks rather than peaks due to a chemical reaction between the matrix polymer and impact modifier, which would inhibit and/or alter subsequent melting and/or recrystallization.

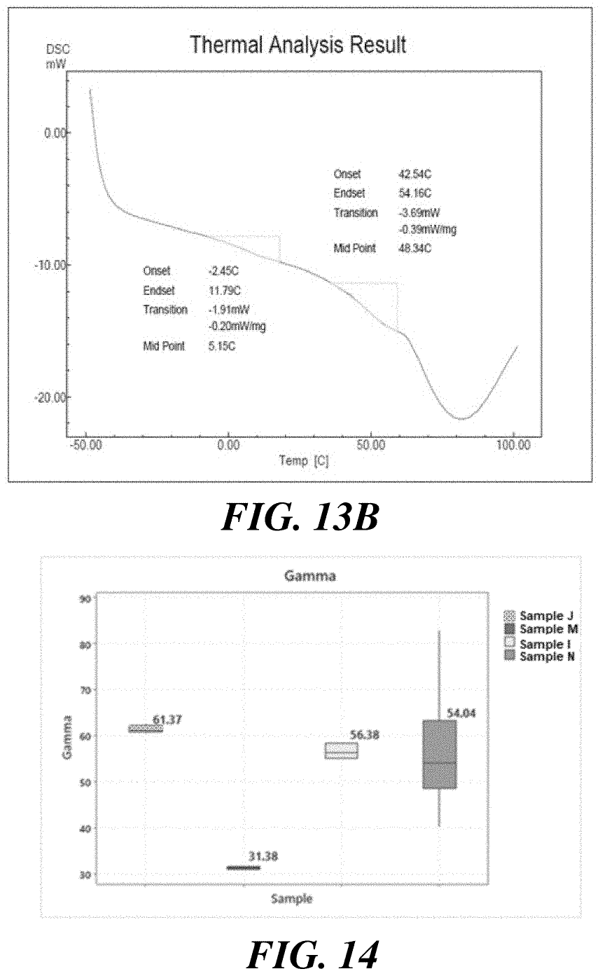

Similarly, as shown in FIG. 13B, when Sample G was analyzed by DSC at lower temperatures, two glass transitions were observed: the glass transition of the impact modifier (at approximately 5.15° C.) and the glass transition of the matrix polymer (at approximately 48.34° C.). When a sample that differed from Sample G only in that it did not have the impact modifier was analyzed by DSC, only one glass transition was observed (see FIG. 13A) at 49.65° C. —the approximate glass transition temperature of the matrix polymer. The fact that the impact modifier and matrix polymer retained their own glass transitions also demonstrated that the impact modifier does not interact chemically with the matrix polymer.

### Example 5

This example compares the gamma of various three-layer filter media.

The tested filter media included a charged meltblown layer, a fine fiber layer (or replacement thereof), and a synthetic backer layer.

Sample I (discussed above, which did not contain glass, and which had a fine fiber layer that did not include an impact modifier), Sample J (discussed above, which did not contain glass, and which had a fine fiber layer comprising an impact modifier), Sample M (wherein the fine fiber layer was replaced with a layer comprising all glass fibers), and Sample N (wherein the fine fiber layer was replaced with a layer comprising all PTFE (polytetrafluoroethylene) fibers) were compared.

As shown in FIG. 14, Sample J had a higher gamma than all of the comparators tested.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A filter media, comprising:
a fine fiber layer comprising a plurality of fine fibers;
wherein the fine fibers comprise an impact modifier dispersed in a matrix polymer;
wherein the weight percent of the impact modifier in the fine fibers is greater than or equal to 1 wt. % and less than or equal to 25 wt. % of the combination of the impact modifier and the matrix polymer; and
wherein the matrix polymer comprises only polymers with a molecular weight of greater than 3 kDa.

2. A filter media, comprising:
a fine fiber layer comprising a plurality of fine fibers;
wherein the fine fibers comprise an impact modifier dispersed in a matrix polymer; and
wherein the weight percent of the impact modifier in the fine fibers is greater than or equal to 1 wt. % and less than or equal to 15 wt. % of the combination of the impact modifier and the matrix polymer.

3. A filter media, comprising:
a fine fiber layer comprising a plurality of fine fibers;
wherein the fine fibers comprise an impact modifier dispersed in a matrix polymer;
wherein the weight percent of the impact modifier in the fine fibers is greater than or equal to 1 wt. % and less than or equal to 25 wt. % of the combination of the impact modifier and the matrix polymer; and
wherein the matrix polymer comprises greater than or equal to 50 wt. % and less than or equal to 100 wt. % of a thermoplastic polymer.

4-7. (canceled)

8. The filter media of claim 1, wherein the weight percent of the impact modifier in the fine fibers is greater than or equal to 1 wt. % and less than or equal to 15 wt. % of the combination of the impact modifier and the matrix polymer.

9. The filter media of claim 1, wherein the impact modifier comprises a copolymer comprising at least two different monomers, wherein at least one monomer has an affinity to the matrix polymer and wherein at least one monomer does not have affinity to the matrix polymer.

10. The filter media of claim 1, wherein the matrix polymer comprises greater than or equal to 50 wt. % and less than or equal to 100 wt. % of a homopolymer and/or wherein the matrix polymer comprises greater than or equal to 50 wt. % and less than or equal to 100 wt. % of a linear polymer.

11. The filter media of claim 1, wherein the matrix polymer comprises greater than or equal to 50 wt. % and less than or equal to 100 wt. % of a thermoplastic polymer.

12-14. (canceled)

15. The filter media of claim 1, wherein the fine fibers have an average fiber diameter of less than or equal to 1 micron.

16. The filter media of claim 1, wherein the fine fibers have an average diameter of less than or equal to 500 nm.

17-18. (canceled)

19. The filter media of claim 1, wherein the matrix polymer comprises a polyamide.

20-23. (canceled)

24. The filter media of claim 1, wherein the impact modifier comprises a polyamide.

25-33. (canceled)

34. The filter media of claim 1, wherein the impact modifier comprises a terpolymer.

35. The filter media of claim 1, wherein the impact modifier does not substantially chemically react with the matrix polymer, does not substantially affect thermal transitions of the matrix polymer, and/or exhibits independent thermal transitions from the matrix polymer.

36. The filter media of claim 1, wherein the impact modifier comprises discrete microdomains having an average largest cross-sectional diameter less than or equal to ¾ the average diameter of the fine fibers.

37. The filter media of claim 1, wherein the impact modifier comprises discrete microdomains having an average largest cross-sectional diameter of greater than or equal to 10 nm and less than or equal to 500 nm.

38. The filter media of claim 1, wherein the impact modifier has a glass transition temperature of greater than or equal to 20° C. and less than or equal to 60° C. lower than the intended use temperature.

39. The filter media of claim 1, wherein the impact modifier has a glass transition temperature of greater than or equal to −50° C. and less than or equal to 15° C.

40. The filter media of claim 1, wherein the fine fiber layer comprises a void volume of greater than or equal to 65% and less than or equal to 99%.

41-51. (canceled)

52. The filter media of claim 1, wherein the filter media has a gamma of greater than or equal to 3 and less than or equal to 400.

53-69. (canceled)

70. The filter media of claim 1, wherein the first layer and sixth layer are each independently wetlaid or drylaid, wherein the second layer comprises meltblown fibers, wherein the third layer is the fine fiber layer, wherein the fourth layer is a spacer, wherein the fifth layer is the same as the fine fiber layer, and wherein the second layer is in between the first and third layers, the third layer is in between the second and fourth layers, the fourth layer is in between the third and fifth layers, and the fifth layer is in between the fourth and sixth layers.

71. The filter media of claim 1, wherein the first layer and the fourth layer are each independently wetlaid or drylaid, wherein the second layer comprises meltblown fibers, wherein the third layer is the fine fiber layer, wherein the second layer is in between the first layer and the third layer, and the third layer is in between the second layer and the fourth layer.
